(19) United States
(12) Patent Application Publication
(10) Pub. No.: US 2011/0150961 A1
(43) Pub. Date: Jun. 23, 2011

(54) ANTI-INFECTIVE CATHETERS

(75) Inventors: Joy Erann Perry, Bloomfield, NY (US); Alexandra M. Chamberlain, Rochester, NY (US); Scott F. Rosebrough, Avon, NY (US)

(73) Assignee: Angiotech International AG, Zug (CH)

(21) Appl. No.: 12/867,999

(22) PCT Filed: Feb. 18, 2009
(86) PCT No.: PCT/US09/34420

§ 371 Date: Feb. 7, 2011

Related U.S. Application Data
(60) Provisional application No. 61/030,850, filed on Feb. 22, 2008.
(60) Provisional application No. 61/047,033, filed on Apr. 22, 2008.

(51) Int. Cl. A01N 25/34; A01N 43/54; A01P 1/00

(52) U.S. Cl. 424/411; 514/274; 514/50

(57) ABSTRACT

Anti-infective catheters are provided. Such catheters comprise a composition that comprises a pyrimidine analog, polyurethane, and cellulose or a cellulose-derived polymer, for example, in form of a coating. In addition, anti-infective compositions and methods of making and using anti-infective catheters are provided.

### BACKGROUND

1. Technical Field

The present invention relates generally to anti-infective compositions and devices and methods for making and using such compositions and devices.

2. Description of the Related Art

Infections associated with medical implants represent a major health care problem. For example, 5% of patients admitted to an acute care facility develop a hospital acquired infection. Hospital acquired infections (nosocomial infections) are the 11^{th} leading cause of death in the US and cost over $2 billion annually. Nosocomial infections directly cause 19,000 deaths per year in the US and contribute to over 58,000 others.

The four most common causes of nosocomial infections are: urinary tract infection (28%); surgical site infection (19%); respiratory tract infection (17%); and bloodstream infection (16% and rising). A significant percentage of these infections are related to bacterial colonization of implanted medical implants such as Foley catheters (urinary tract infections), endotracheal and tracheostomy tubes (respiratory tract infections), and vascular infusion catheters (bloodstream infections). Although any infectious agent can infect medical implants, Staphylococci (S. aureus, S. epidermidis, S. pyogenes), Enterococci (E. coli), Gram Negative Aerobic Bacilli, and Pseudomonas aeruginosa are common pathogens. Once a medical implant becomes colonized by bacteria, it must frequently be replaced resulting in increased morbidity for the patient and increased cost to the healthcare system. Often the infected device serves as a source for a disseminated infection, which can lead to significant morbidity or even death.

In an attempt to combat this important clinical problem, devices have been coated with antimicrobial drugs. Representative examples include those described in U.S. Pat. No. 5,520,664 (“Catheter Having a Long-Lasting Antimicrobial Surface Treatment”), U.S. Pat. No. 5,709,672 (“Silastic and Polymer-Based Catheters with Improved Antimicrobial/Antifungal Properties”), U.S. Pat. No. 6,361,526 (“Antimicrobial Tympanostomy Tubes”), U.S. Pat. No. 6,261,271 (“Anti-infective and antithrombogenic medical articles and method for their preparation”), U.S. Pat. No. 5,902,283 (“Antimicrobial impregnated catheters and other medical implants”) U.S. Pat. No. 5,624,704 (“Antimicrobial impregnated catheters and other medical implants and method for impregnating catheters and other medical implants with an antimicrobial agent”) and U.S. Pat. No. 5,709,672 (“Silastic and Polymer-Based Catheters with Improved Antimicrobial/Antifungal Properties”).

One complication with these devices, however, is that they can become colonized by bacteria resistant to the antibiotic coating. Such antibiotic-resistant bacteria may also be resistant to commonly used antibiotics and can make infection control more complex.

This can result in at least two distinct clinical problems. First, the device serves as a source of infection in the body with the resulting development of a local or disseminated infection. Secondly, if an infection develops, it cannot be treated with the antibiotic(s) used in the device coating. The development of antibiotic-resistant strains of microbes remains a significant healthcare problem, not just for the infected patient, but also for the healthcare institution in which it develops.

Thus, there is a need in the art for medical devices which have a reduced likelihood of an associated infection. The present invention discloses such devices (as well as compositions and methods for making such devices) which reduce the likelihood of infections associated with medical devices, and further, provides other, related advantages.

### BRIEF SUMMARY

In one aspect, the present invention provides an anti-infective composition having at least one polymer and a pyrimidine analog, wherein the pyrimidine analog is selected from the class consisting of 5-fluorouracil and floxuridine. In certain embodiments, the pyrimidine analog is isolated. In certain embodiments, the pyrimidine analog comprises 2% to 40% by weight of the total anti-infective composition. In certain embodiments, the at least one polymer is a cellulose polymer or cellulose-derived polymer. In certain embodiments, the anti-infective composition further includes a second anti-infective agent. In some such compositions one of the anti-infective agents is 5-fluorouracil and the other anti-infective agent is floxuridine.

In one aspect, the present invention provides an anti-infective device comprising: (i) a catheter; and (ii) a composition on the catheter, the composition comprising (a) a polyurethane, (b) a cellulose or cellulose-derived polymer, and (c) a pyrimidine analog, wherein the weight ratio of the polyurethane to the cellulose or cellulose-derived polymer in the composition ranges from 1:10 to 2:1, and the pyrimidine analog is in an amount effective in reducing or inhibiting infection associated with the catheter.

In certain embodiments, the composition is on the catheter in form of a coating.

In certain embodiments, the weight ratio of the polyurethane to the cellulose or cellulose-derived polymer in the composition (e.g., a composition in form of a coating) ranges from 1:2 to 1:4 (e.g., about 1:3).

In certain embodiments, the pyrimidine analog is released from the composition (e.g., a composition in form of a coating) at an amount effective in reducing or inhibiting infection associated with the catheter for at least 1 week, 2 weeks, 3 weeks, 4 weeks, 2 months, 3 months, 4 months, 5 months, 6 months, 7 months, 8 months, 9 months, 10 months, 11 months or 12 months.

In certain embodiments, the weight ratio of the pyrimidine analog to the sum of the polyurethane and the cellulose or cellulose-derived polymer in the composition (e.g., a composition in form of a coating) ranges from 2% to 40% (e.g., 5% to 25% or about 15% to about 20%)

In certain embodiments, the pyrimidine analog is present at 0.1 μg to 1 mg per cm² (e.g., 10 μg to 100 μg per cm²) of the catheter surface area to which the composition is applied or incorporated.

In certain embodiments, the pyrimidine analog is present at 0.1 μg to 1 mg per cm (e.g., 10 μg to 100 μg per cm or about 50 μg) of the catheter length to which the composition is applied or incorporated.

In certain embodiments, the pyrimidine analog is present at about 1 to 1.1 mg per cm (e.g., 100 μg to 110 μg per cm) of the catheter length to which the composition is applied or incorporated.

In certain embodiments, the anti-infective device comprises 1 μg to 250 mg (e.g., 100 μg to 10 mg or 1 mg) of the pyrimidine analog.

In certain embodiments, the anti-infective device comprises about 2 mg to 4 mg of the pyrimidine analog.

In certain embodiments, the pyrimidine analog is a fluoropyrimidine, such as 5-fluorouracil and floxuridine.

In certain embodiments, the cellulose-derived polymer is nitrocellulose, cellulose acetate butyrate, or cellulose acetate propionate.

In certain embodiments, the polyurethane is a poly(carbonate urethane), poly(ester urethane), or poly(ether urethane).

In certain embodiments, the composition (e.g., a composition in form of a coating) is only present on the non-luminal surface or a portion thereof.

In certain embodiments, the average thickness of the coating ranges from 1 μm to 10 μm (e.g., about 5 μm).

In certain embodiments, the average thickness of the coating ranges from 10 μm to 20 μm (e.g., about 15 μm).

In certain embodiments, the catheter is a vascular catheter, chronic dwelling gastrointestinal catheter, dialysis catheter, or chronic dwelling genitourinary catheter.

In certain embodiments, the catheter is a vascular catheter, such as a 3 lumen central venous catheter.

In certain embodiments, the catheter is a dialysis catheter, such as a hemodialysis catheter.

In certain embodiments, the composition (e.g., a composition in form of a coating) on the catheter further comprises a second anti-infective agent. In some embodiments, the second anti-infective agent may be an antibiotic. In some embodiments, the second anti-infective agent may include least one of chlorhexidine, silver compounds, silver ions, silver particles, or other metallic compounds, ions or particles (such as gold).

In certain embodiments, the composition (e.g., a composition in form of a coating) on the catheter further comprises an antithrombotic agent.

In certain embodiments, the composition (e.g., a composition in form of a coating) on the catheter further comprises an antiplatelet agent, an anti-inflammatory agent, an immunomodulatory agent, or an anti-fibrotic agent.

In certain embodiments, the catheter is composed at least partially (e.g., completely or partially) of a polyurethane. The polyurethane may be the same as or different from the polyurethane in the composition (e.g., a composition in form of a coating) on the catheter.

In certain embodiments where the catheter is composed of at least partially of a polyurethane, the pyrimidine analog is also incorporated into the polyurethane of which the catheter is composed of. The incorporation may occur during the process of applying or incorporating a composition that comprises a polyurethane, a cellulose or cellulose-derived polymer, and a pyrimidine analog onto a catheter or a portion thereof, such as during the process of coating a catheter or a portion thereof with the composition.

In another aspect, the present invention provides a composition for coating a catheter comprising: (a) a polyurethane, (b) a cellulose or cellulose-derived polymer, and (c) a pyrimidine analog, wherein the weight ratio of the polyurethane to the cellulose or cellulose-derived polymer in the coating ranges from 1:10 to 2:1, and the pyrimidine analog is at a concentration effective in reducing or inhibiting infection associated with the catheter.

In certain embodiments, the weight ratio of the polyurethane to the cellulose or cellulose-derived polymer in the composition is from 1:2 to 1:4, such as about 1:3.

In certain embodiments, the weight ratio of the pyrimidine analog to the sum of the polyurethane and the cellulose or cellulose-derived polymer in the composition ranges from 2% to 40%, such as from 5% to 25% or from about 15% to about 20%.

In certain embodiments, in the composition, the polyurethane is poly(carbonate urethane), the cellulose-derived polymer is nitrocellulose, and the pyrimidine analog is at least one of 5-fluorouracil or floxuridine.

In certain embodiments, in the composition, the weight ratio of the polyurethane to the cellulose-derived polymer ranges from 1:2 to 1:4, and the weight ratio of pyrimidine analog to the sum of the polyurethane and the cellulose-derived polymer ranges from 5% to 25%.

In certain embodiments, in the composition, the pyrimidine analog is a fluoropyrimidine, such as 5-fluorouracil or floxuridine.

In certain embodiments, in the composition, the polyurethane is poly(carbonate urethane), the cellulose-derived polymer is nitrocellulose, and the pyrimidine analog is at least one of 5-fluorouracil or floxuridine.

In certain embodiments, in the composition, the weight ratio of the polyurethane to the cellulose-derived polymer ranges from 1:2 to 1:4, and the weight ratio of pyrimidine analog to the sum of the polyurethane and the cellulose-derived polymer ranges from 5% to 25%.

In certain embodiments, the composition further comprises a first solvent for the cellulose or cellulose-derived polymer, a second solvent for the polyurethane, and a swelling agent.

In certain embodiments, in the composition, the first solvent for the cellulose or cellulose-derived polymer is MEK, the second solvent for the polyurethane is DMAC, and the swelling agent is THF.

In certain embodiments, the composition when forming a coating on a catheter, releases the pyrimidine analog in an amount effective in reducing or inhibiting infection associated with the catheter for at least 1 week, 2 weeks, 3 weeks, 4 weeks, 2 months, 3 months, 4 months, 5 months, 6 months, 7 months, 8 months, 9 months, 10 months, 11 months, or 12 months.

In another aspect, the present application provides a kit that comprises the anti-infective device provided herein and a skin anti-infective agent.

In certain embodiments, the kit further comprises a local anesthetic.

In another aspect, the present application provides a method for making the anti-infective device provided herein that comprises applying or incorporating onto a catheter or a portion thereof a composition that comprises (a) a polyurethane, (b) a cellulose or cellulose-derived polymer, and (c) a pyrimidine analog, wherein the weight ratio of the second polyurethane to the cellulose or cellulose-derived polymer in the coating ranges from 1:10 to 2:1, and the pyrimidine analog is in an amount effective in reducing or inhibiting infection associated with the catheter.

In another aspect, the present invention provides an anti-infective catheter produced by coating a catheter or a portion thereof with a composition that comprises a polyurethane, cellulose or a cellulose-derived polymer, and a pyrimidine analog provided herein.

In another aspect, the present invention provides a method for reducing or inhibiting infection associated with a catheter, comprising introducing into a patient the anti-infective device provided herein.

In certain embodiments, the infection associated with the catheter is bacterial colonization, local infection associated with the catheter, or bloodstream infection associated with the catheter.

### BRIEF DESCRIPTION OF THE DRAWINGS

FIG. 1A is a top view of an exemplary triple lumen central venous catheter that may be coated with an anti-infective coating composition provided herein. It consists of a TECOFLEX® EG-60D-B20 body with a TECOFLEX® EG-85A-B20 turquoise tip. The catheter body is a 20 cm long, 7-French, triple-lumen [16/18/18 gauge inner diameter (ID)], 0.092±0.002″ outer diameter (OD), with printed ink markings every two centimeters from 10 to 20 cm from the distal tip. The three extensions are connected to the CVC triple lumen body by a turquoise PELLETHANE® hub assembly. Each extension is connected to an individually colored (yellow, clear, blue) female Luer fitting. Each female Luer fitting is closed with an injection cap. Each individual extension has a blue slide clamp. The entire 20 cm length of the catheter body is covered with a protective catheter sheath.

FIG. 1B is a cross section view of the shaft portion of the triple lumen central venous catheter the side view of which is shown in FIG. 1A.

FIG. 2A is a microscopic picture of an uncoated CVC.

FIG. 2B is a microscopic picture of a CVC coated with a composition comprising 5-FU according to the method of Example 2.

FIG. 3 is a graph showing 5-FU in vitro release profiles of 6 different lots of 5-FU CVC's.

FIG. 4 is a graph showing sustained antimicrobial activity of the 5-FU CVC and the CVC coated with a lower dose of 5-FU versus the Arrow CVC.

FIG. 5 is a graph showing the in vitro release of 5-FU in PBS graphed against the retained amount of 5-FU from the goat CVC explants.

### DETAILED DESCRIPTION

As used herein, the term “about” or “consists essentially of” refers to ±15% of any indicated structure, value, or range. Any numerical ranges recited herein are to be understood to include any integer within the range and, where applicable (e.g., concentrations), fractions thereof, such as one tenth and one hundredth of an integer (unless otherwise indicated).

Anti-infective catheters that comprise a pyrimidine analog are provided. The pyrimidine analog is present in a composition on the catheters (e.g., in form of a coating), which further comprises a polyurethane and a cellulose or cellulose-derived polymer. The composition may be referred to herein as “pyrimidine analog-containing polymeric composition.” The combination of polyurethane and cellulose or cellulose-derived polymer at proper weight ratios allows for the pyrimidine analog to be released in an amount effective in reducing or inhibiting infection associated with the catheters after the catheters are implanted into a patient for a sustained period of time. In addition, compositions for making the anti-infective catheters (e.g., coating compositions for the catheters) and methods for making and using the anti-infective catheters are also provided.

The polymeric composition (e.g., in form of a coating) on the anti-infective catheters provided herein can release pyrimidine analogs (e.g., fluoropyrimidines such as 5-fluorouracil (5-FU) and floxuridine) slowly, providing a local environment of high drug concentration with greatly reduced systemic exposure compared to common clinical applications. Entrapment of pyrimidine analogs (e.g., 5-FU, floxuridine) in the polymeric composition extends the length of time during which efficacious drug concentrations can be sustained on the catheter surface.

Pyrimidine analogs, such as 5-FU and floxuridine, on the anti-infective catheters provided herein have anti-infective activities against a broad spectrum of pathogens, including both gram positive and gram negative bacteria. In addition, pyrimidine analogs have no clinical application to date as either systemic antibiotics or hospital antiseptics; therefore, there is little risk of creating infective microorganisms that are resistant to this class of anti-infective agent, making infection control less complex than would be the cases using traditional antibiotics. Results from clinical trials using 5-FU coated central venous catheters further suggest no acquired resistance of at least certain gram positive pathogens to 5-FU.

The pyrimidine analog-containing polymeric composition (e.g., in form of a coating) may be present on the exterior (non-luminal) surface, the interior (luminal) surface, or both surfaces of a catheter. The presence of the anti-infective coating on the exterior surface inhibits the colonization of the catheter by microorganisms that typically gain entrance via the local skin penetration of the implanted catheters. This reduction in colonization by bacteria may further have a net effect of reducing biofilm burden on the implanted catheters, making them less likely to serve as reservoirs for additional infection. The presence of the pyrimidine analog on the luminal surface or released into the lumen of the catheter can offer the additional benefits. Typically, intraluminal bacterial growth (e.g., on the interior walls of the catheter or at the outlet ports) results from contamination of the hub during manipulation of the catheter in the days following implantation (e.g., 7 days). Release of a pyrimidine analog into the lumen of the catheter can inhibit bacterial growth within the catheter and/or at the outlet ports.

It has been found by the present inventors that in certain embodiments (e.g., when an anti-infective catheter is composed (i.e., made from) at least partially (i.e., completely or partially) of a polyurethane), even though the anti-infective composition (e.g., in form of a coating) is present only on the exterior surface of a catheter, a pyrimidine analog (e.g., 5-FU) in the coating is able to elute into the lumen of the catheter. In such embodiments, because the pyrimidine analog-containing polymeric composition (e.g., in form of a coating) is only required on the non-luminal surface, the production of the described catheters provides technical advantages over catheters having an anti-infection composition (e.g., coated) on luminal surfaces or on both non-luminal and luminal surfaces. First, since catheters (e.g., central venous catheters) frequently have more than one lumen (e.g., 2-5 lumens), applying or incorporating (i.e., coating) the inside of multiple intraluminal surfaces with the anti-infective composition is technically challenging. Second, the lumens with the anti-infective composition applied or incorporated (e.g., coated) may alter physical properties of the catheter. For example, the presence of the interior coating may alter the dimensions of the lumen itself, may alter flow, and/or may compromise the flexibility of the catheter. Third, the components of the anti-infective composition may interact with the infusates dispensed through the interior of the catheter.

In certain embodiments, the present invention provides catheters with an anti-infective composition (e.g., in form of a coating) on a non-luminal (exterior) surface that yield bidirectional elution of a pyrimidine analog (i.e., elution in an outward direction away from the exterior surface of the catheter, as well elution into the catheter lumen). Because the polymeric composition on the non-luminal surface of such catheters allows pyrimidine analogs (e.g., 5-FU, floxuridine) to elute into the vessel lumen, intralumen and outlet port antimicrobial protection is provided.

### Therapeutic Agents

The primary anti-infective agent used to provide anti-infective catheters is a pyrimidine analog. In addition, the anti-infective catheters may comprise additional anti-infective agents (e.g., a chemotherapeutic agent with anti-infective activity, or another anti-bacterial or anti-fungal agent) and/or other active agents (e.g., an antithromobotic agent or an anti-fibrotic agent).

Pyrimidine Analogs

The primary anti-infective agent used to provide anti-infective catheters is a pyrimidine analog. A “pyrimidine analog” refers to a compound with a pyrimidine ring structure (1,3-diazine) substituted with one or more atoms or chemical groups or oxidized at one or more carbons in the pyrimidine ring structure.

In certain embodiments, the pyrimidine analog contains a halogen substituent, such as F, Cl, Br, or I, at a carbon in the pyrimidine ring structure. In certain embodiments, the pyrimidine analog contains at least one F substituent at a carbon of its pyrimidine ring structure and is referred to as a “fluoropyrimidine.” Exemplary fluoropyrimidines include, but are not limited to, 5-FU, 5-FUdR (5-fluoro-deoxyuridine; floxuridine), fluorouridine triphosphate (5-FUTP), fluorodeoxyuridine monophosphate (5-dFUMP), 5-fluorocytosine, 5-fluorothymidine, capecitabine, trifluridine, and trifluorothymidine. Other halogenated pyrimidine analogs include, but are not limited to, 5-bromodeoxyuridine (5-BudR), 5-bromouracil, 5-chlorodeoxyuridine, 5-chlorouracil, 5-iododeoxyuridine (5-IudR), 5-iodouracil, 5-bromocytosine, 5-chlorocytosine, and 5-iodocytosine.

In certain embodiments, the pyrimidine analog is a uracil analog. A “uracil analog” refers to a compound that contains a uracil ring structure substituted with one or more atoms or chemical groups. In certain embodiments, the uracil analog contains a halogen substituent, such as F, Cl, Br, or I. In certain embodiments, the uracil analog contains an F substituent, and is referred to as a “fluorouracil analog.” Exemplary fluorouracil analogs include, but are not limited to, 5-FU, carmofur, doxifluridine, emitefur, tegafur, and floxuridine. These exemplary compounds have the structures:

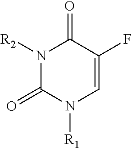

| | R₁ | R₂ |
|---|---|---|
| 5-Fluorouracil | H | H |
| Carmofur | C(O)NH(CH₂)₅CH₃ | H |
| Doxifluridine | A₁ | H |
| Floxuridine | A₂ | H |
| Emitefur | CH₂OCH₂CH₃ | B |
| Tegafur | C | H |

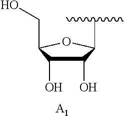

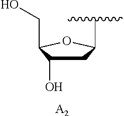

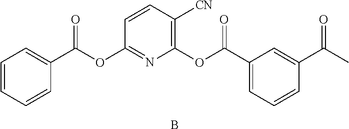

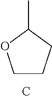

Other exemplary pyrimidine analogs have the structures:

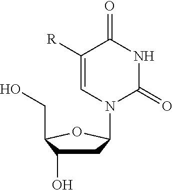

5-Fluoro-2′-deoxyuridine: R═F
5-Bromo-2′-deoxyuridine: R═Br
5-Iodo-2′-deoxyuridine: R═I

Other representative examples of pyrimidine analogs include N3-alkylated analogues of 5-fluorouracil (Kozai et al., J. Chem. Soc., Perkin Trans. 1(19):3145-3146, 1998), 5-fluorouracil derivatives with 1,4-oxaheteroepane moieties (Gomez et al., Tetrahedron 54(43):13295-13312, 1998), 5-fluorouracil and nucleoside analogues (Li, Anticancer Res. 17(1A):21-27, 1997), cis- and trans-5-fluoro-5,6-dihydro-6-alkoxyuracil (Van der Wilt et al., Br. J. Cancer 68(4):702-7, 1993), cyclopentane 5-fluorouracil analogues (Hronowski & Szarek, Can. J. Chem. 70(4):1162-9, 1992), A-OT-fluorouracil (Zhang et al., Zongguo Yiyao Gongye Zazhi 20(11):513-15, 1989), N4-trimethoxybenzoyl-5′-deoxy-5-fluorocytidine and 5′-deoxy-5-fluorouridine (Miwa et al., Chem. Pharm. Bull. 38(4):998-1003, 1990), 1-hexylcarbamoyl-5-fluorouracil (Hoshi et al., J. Pharmacobio-Dun. 3(9):478-81, 1980; Maehara et al., Chemotherapy (Basel) 34(6):484-9, 1988), B-3839 (Prajda et al., In Vivo 2(2):151-4, 1988), uracil-1-(2-tetrahydrofuryl)-5-fluorouracil (Anai et al., Oncology 45(3):144-7, 1988), 1-(2′-deoxy-2′-fluoro-(3-D-arabinofuranosyl)-5-fluorouracil (Suzuko et al., Mol. Pharmacol. 31(3):301-6, 1987), doxifluridine (Matuura et al., Oyo Yakuri 29(5):803-31, 1985), 5′-deoxy-5-fluorouridine (Bollag & Hartmann, Eur. J. Cancer 16(4):427-32, 1980), 1-acetyl-3-O-toluoyl-5-fluorouracil (Okada, Hiroshima J. Med. Sci. 28(1):49-66, 1979), 5-fluorouracil-m-formylbenzene-sulfonate (JP 55059173), N′-(2-furanidyl)-5-fluorouracil (JP 53149985) and 1-(2-tetrahydrofuryl)-5-fluorouracil (JP 52089680).

Further representative pyrimidine analogs include, but are not limited to, cytarabine (i.e., cytosine arabinoside); gemcitabine; 5-azacytidine; 2′-deoxy-5-azacytidine (decitabine); azidodeoxythymidine; 5-diazouracil; 4-amino-2-(2-pyridyl)pyrimidines (U.S. Patent Appl. No. 2003/0092718 and U.S. Pat. No. 7,015,228); 2,4-diamino-5-(substituted)pyrimidines (U.S. Pat. Nos. 4,232,023; 4,415,574; 4,515,948; 4,587,341; 4,587,342; and 4,590,271); stavudine; zidovudine; trimethoprim (Quinlivan et al., FASEB J. 14, 2519-2524, 2000); thiazolo[4,5-d]pyrimidines (Rida et al., Pharmazie 51, 927-931, 1996; Balkan et al., Arzneimittelforshung 51, 839-842, 2001; Ali et al., Phosphorus, Sulfur, and Silicon and Related Elements 180, 1909-1919, 2005; and Habib et al., Arch. Pharm. Res. 30, 1511-1520, 2007); imidazo[1,2-a]pyrimidines; imidazo[1,2-c]pyrimidines; imidazo[1,2-d]pyrimidines; arylimidazo[1,2-a]pyrimidines (Rival et al., Eur. J. Med. Chem. 26, 13, 1191; and Xu et al., Chinese Chem. Lett. 14, 1002-1004, 2003); pyrazolo[3,4-d]pyrimidines (Ali et al., J. Med. Chem. 46, 1824-1830, 2003; Holla et al., Bioorg. Med. Chem. 14, 2040-2047, 2006; U.S. Pat. No. 4,260,758; and U.S. Patent Appl. No. 2007/0004761); imidazopyrazolopyrimidines (Bhuiyan et al., J. Appl. Sci. Res. 1, 218-222, 2005); pyrazolo[1,5-a]pyrimidines; furopyrimidines (Bhuiyan et al., J. Appl. Sci. Res. 1, 218-222, 2005); furo[2,3-d]pyrimidines (Dave and Shah, Molecules 7, 554, 2002; Bhuiyan et al., Croat. Chem. Acta 78, 633, 2005; Janeba et al., J. Med. Chem. 48, 4690, 2005; Amblard et al., Bioorg. Med. Chem. 13, 1239, 2005; and Shaker, Arkivoc xiv, 68-77, 2006); furo[3,2-e]imidazo[1,2-c]pyrimidines; triazolo[1,5-c]pyrimidines; pyrano[2,3-d]pyrimidines (Bedair et al., Farmaco 56, 965-973, 2001; and Eid, et al., Acta Pharm. 54, 13-26, 2004); adamantylpyrimidines (Orzeszko et al., II Farmaco 59, 929-937, 2004); thienopyrimidines (Bhuiyan et al., Acta Pharm. 56, 441-450, 2006; and Hassan et al., Nucleosides, Nucleotides, Nucl. Acids 26, 379-390, 2007); pyrazolylpyrimidines; benzylidenehydrazonopyrimidines; triazolopyrimidines; pyrimidine sulfonamides (e.g., sulfadimidine); pyrimidine thiones (Abd El-Ghaffar et al., Rev. Roum. Chim. 46, 535-542, 2001); substituted 2,4-bis(alkylamino)pyrimidines (Intl. Patent Appl. Publ. No. WO 2005/011758 and U.S. Patent Appl. No. 2006/0188453); aryl pyrimidines (U.S. Pat. No. 5,002,951); pyrrolo[2,3-d]pyrimidines, triazolino[4,3-a]pyrimidines; pyrido[2,3-d]pyrimidines; chromenylmethyl pyrimidinediamines (U.S. Patent Appl. No. 2003/0144246 and U.S. Pat. No. 6,818,649); pyrimidinyl methyl indoles (U.S. Patent Appl. No. 2003/0119857 and U.S. Pat. No. 6,703,397); fludarabine; cladarabine; 5-chloroorotic acid (this and the following compounds are from Stone and Potter, Cancer Research 16, 1033-1037, 1956); 5-bromoorotic acid; 5-diazoorotic acid; 2-benzylmercapto-4-amino-5-carbethoxypyrimidine; 2-ethylmercapto-4-amino-5-chloromethylpyrimidine; 2-benzylmercapto-4-amino-5-hydroxymethylpyrimidine; 2-ethoxy-4-amino-5-carbethoxypyrimidine; and 2-ethylmercapto-4-amino-5-carbethoxypyrimidine. Further information concerning preparation and use of certain pyrimidine analogs may be found in Ungureanu et al., Ann. Pharm. Francaises 64, 287-288, 2006; in U.S. Pat. Nos. 4,092,472; 4,237,289; 4,315,932; 5,213,972; 5,959,100; 6,670,368; and 6,969,714; in Franklin and Snow, Biochemistry and Molecular Biology of Antimicrobial Drug Action, Springer, 2005; and in Padhy et al., Heterocyclic Compounds: Synthesis and Antimicrobial Activity of Some Pyrimidine Derivatives, ChemInform 34, 28 Jul. 2003. In certain embodiments, pyrimidine analogs may be made and used as antiviral agents (U.S. Patent Appl. No. 2004/0068111; U.S. Pat. Nos. 4,859,680; 4,868,187; 4,956,346; 5,215,971; 5,318,972, 5,356,882; 5,461,060; 5,521,163; 5,736,531; 5,747,500; 5,959,100; 6,342,501; 6,352,991; 6,410,726; 6,599,911; 6,653,318; 6,958,345; 6,987,114; 7,019,135; and 7,276,501). In other embodiments, pyrimidine analogs may be made and used as antifungal agents (U.S. Pat. Nos. 4,649,198; 5,807,854; and 6,653,475). Furanose-containing pyrimidine derivatives may be monophosphorylated, diphosphorylated, or triphosphorylated.

Pyrimidine analogs, such as fluoropyrimidines, are believed to function as therapeutic agents by serving as antimetabolites of pyrimidine.

In certain embodiment, the pyrimidine analog is 5-fluorouracil, a compound approved for the treatment of carcinoma and actinic or solar keratoses of the face. It is currently approved for use as an intravenous injection, a topical solution, and a topical cream. 5-FU is metabolized intracellularly to its active form, fluorodeoxyuridine monophosphate (FdUMP). The active form inhibits fungal and bacterial DNA synthesis by inhibiting the normal production of thymidine. The mode of action of 5-FU is to create a thymine deficiency that influences reproduction of bacterial cells and ultimately leads to bacterial cell death.

The effects are most marked on those bacteria that replicate more rapidly and take up 5-FU at a more rapid rate. 5-FU is cell cycle phase-specific, affecting cells in S-phase.

As indicated in the examples below, 5-FU was shown to have antimicrobial activity against bacterial strains commonly found associated with catheter infections using the minimum inhibitory concentration (MIC) test.

In certain embodiments, the pyrimidine analog is floxuridine, a pyrimidine analog that is approved for the treatment of carcinoma, particularly colorectal carcinoma. It is currently approved for use as an intervenous injection. Floxuridine is catabolized to 5-fluorouracil and has the same mode of action as 5-fluorouracil.

In certain embodiments, a pyrimidine analog has an MIC of less than or equal to any one of 10⁻⁴ M, 10⁻⁶M, 10⁻⁶M, or, 10⁻⁷M against at least one of the following common infecting organisms associated with catheters: Staphylococci (S. aureus, S. epidermidis, and S. pyogenes), Enterococci (E. coli), gram negative aerobic Bacilli and Pseudomonas aeruginosa as measured by, for example, the microtiter broth assay described herein. Furthermore, the pyrimidine analog is suitable for use when coated on or otherwise associated with a catheter at a daily dosage less than that 10%, 5%, 1%, 0.5% or 0.1% of a daily dosage typically used in chemotherapeutic applications (Goodman and Gilman's The Pharmacological Basis of Therapeutics. Editors J. G. Hardman, L. L. Limbird. Consulting editor A. Goodman Gilman Tenth Edition. McGraw-Hill Medical publishing division. 10th edition, 2001, 2148 pp.).

In certain embodiments, the pyrimidine analog is sparingly soluble in water. In certain other embodiments, the pyrimidine analog is soluble, slightly soluble, or very slightly soluble in water. Water solubility is expressed in terms of the volume of solvent (e.g., water) required to dissolve 1 gram of a drug (e.g., a pyrimidine analog) at a specified temperature (e.g., at 25° C.) and is classified according to the following table from Remington's Pharmaceutical Sciences, Mack Publishing Co., Easton, Pa., 21^{st} edition, 2006.

| | Parts of solvent needed |
|---|---|
| Descriptive terms | for 1 part solute |
| Very soluble | <1 |
| Freely soluble | 1-10 |
| Soluble | 10-30 |
| Sparingly soluble | 30-100 |
| Slightly soluble | 100-1000 |
| Very slightly soluble | 1000-10,000 |
| Practically insoluble or insoluble | >10,000 |

Secondary Agents

In certain embodiments, the anti-infective catheter provided herein may comprise more than one pyrimidine analog. For example, it may contain 5-fluorouracil and/or another pyrimidine analog, such as floxuridine. In certain embodiments, the anti-infective catheter may comprise, in addition to a pyrimidine analog (e.g., 5-fluorouracil), one or more other chemotherapeutic agents that have anti-infective activities when used at concentrations lower than those for chemotherapy. In certain embodiments, the anti-infective catheter may comprise, in addition to a pyrimidine analog, one or more anti-infective agents (e.g., antibiotics) that are not chemotherapeutic agents. In certain embodiments, the anti-infective catheter may comprise, in addition to a pyrimidine analog, one or more active agents other than anti-infective agents (e.g., anti-thromobotic agents and anti-platelet agents) to help minimize additional complications (e.g., venous thrombosis) associated with catheter implants.

Chemotherapeutics as Secondary Anti-Infective Agents

Chemotherapeutic agents other than pyrimidine analogs may be used as anti-infective agents in combination with pyrimidine analogs to provide anti-infective catheters. Exemplary classes of chemotherapeutics useful in combination with pyrimidine analogs are uracil analogs, anthracyclins, folic acid antagonists, podophyllotoxins, camptothecins, hydroxyureas, and platinum complexes.

1. Anthracyclines

Anthracyclines have the following general structure, where the R groups may be a variety of organic groups:

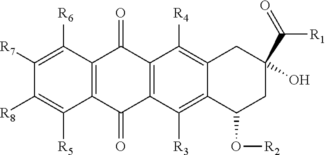

According to U.S. Pat. No. 5,594,158, suitable R groups are as follows: R₁ is CH₃ or CH₂OH; R₂ is daunosamine or H; R₃ and R₄ are independently one of OH, NO₂, NH₂, F, Cl, Br, I, CN, H or groups derived from these; R₅ is hydrogen, hydroxy, or methoxy; and R₆₋₈ are all hydrogen. Alternatively, R₅ and R₆ are hydrogen and R₇ and R₈ are alkyl or halogen, or vice versa.

According to U.S. Pat. No. 5,843,903, R₁ may be a conjugated peptide. According to U.S. Pat. No. 4,296,105, R₅ may be an ether linked alkyl group. According to U.S. Pat. No. 4,215,062, R₅ may be OH or an ether linked alkyl group. R₁ may also be linked to the anthracycline ring by a group other than C(O), such as an alkyl or branched alkyl group having the C(O) linking moiety at its end, such as —CH₂CH(CH₂—X)C(O)—R₁, wherein X is H or an alkyl group (see, e.g., U.S. Pat. No. 4,215,062). R₂ may alternately be a group linked by the functional group ═N—NHC(O)—Y, where Y is a group such as a phenyl or substituted phenyl ring. Alternately R₃ may have the following structure:

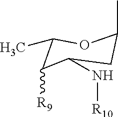

in which R₉ is OH either in or out of the plane of the ring, or is a second sugar moiety such as R₃. R₁₀ may be H or form a secondary amine with a group such as an aromatic group, saturated or partially saturated 5 or 6 membered heterocyclic having at least one ring nitrogen (see U.S. Pat. No. 5,843,903).

Alternately, R₁₀ may be derived from an amino acid, having the structure —C(O)CH(NHR₁₁)(R₁₂), in which R₁₁ is H, or forms a C₃₋₄ membered alkylene with R₁₂. R₁₂ may be H, alkyl, aminoalkyl, amino, hydroxy, mercapto, phenyl, benzyl or methylthio (see U.S. Pat. No. 4,296,105).

Exemplary anthracyclines are doxorubicin, daunorubicin, idarubicin, epirubicin, pirarubicin, zorubicin, and carubicin. Suitable compounds have the structures:

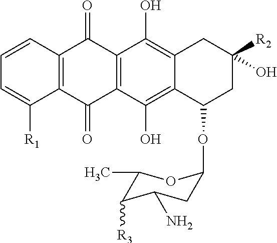

| | R₁ | R₂ | R₃ |
|---|---|---|---|
| Doxo- | OCH₃ | C(O)CH₂OH | OH out of ring plane |
| rubicin: | | | |
| Epirubicin: | OCH₃ | C(O)CH₂OH | OH in ring plane |
| (4′ epimer | | | |
| of doxo- | | | |
| rubicin) | | | |
| Dauno- | OCH₃ | C(O)CH₃ | OH out of ring plane |
| rubicin: | | | |
| Idarubicin: | H | C(O)CH₃ | OH out of ring plane |
| Pirarubicin: | OCH₃ | C(O)CH₂OH | 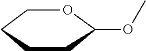 |
| Zorubicin: | OCH₃ | C(CH₃)(═N)NHC(O)C₆H₅ | OH |
| Carubicin: | OH | C(O)CH₃ | OH out of ring plane |

Other suitable anthracyclines are anthramycin, mitoxantrone, menogaril, nogalamycin, aclacinomycin A, olivomycin A, chromomycin A₃, and plicamycin having the structures:

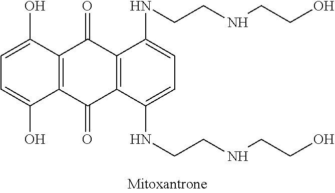

| | R₁ | R₂ | R₃ |
|---|---|---|---|
| Menogaril | H | OCH₃ | H |
| Nogalamycin | O-sugar | H | COOCH₃ |

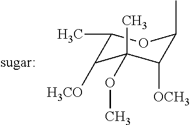

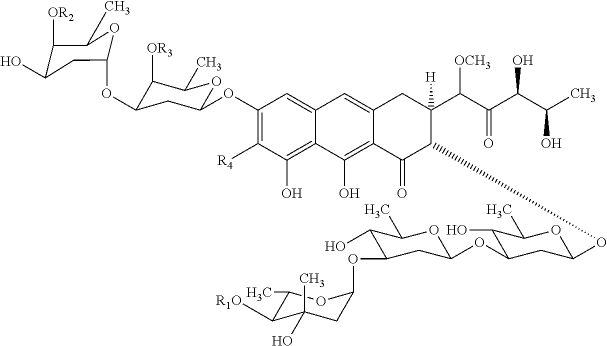

| | R₁ | R₂ | R₃ | R₄ |
|---|---|---|---|---|
| Olivomycin A | COCH(CH₃)₂ | CH₃ | COCH₃ | H |
| Chromomycin A₃ | COCH₃ | CH₃ | COCH₃ | CH₃ |
| Plicamycin | H | H | H | CH₃ |

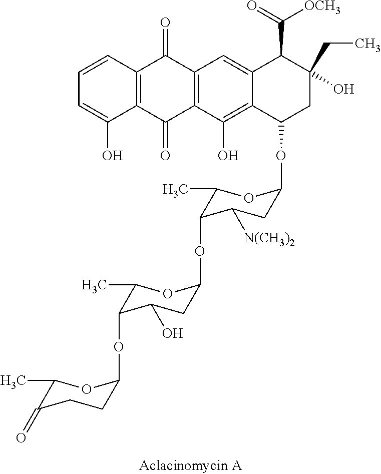

Other representative anthracyclines include FCE 23762 doxorubicin derivative (Quaglia et al., J. Liq. Chromatogr. 17(18):3911-3923, 1994), annamycin (Zou et al., J. Pharm. Sci. 82(11):1151-1154, 1993), ruboxyl (Rapoport et al., J. Controlled Release 58(2):153-162, 1999), anthracycline disaccharide doxorubicin analogue (Pratesi et al., Clin. Cancer Res. 4(11):2833-2839, 1998), N-(trifluoroacetyl)doxorubicin and 4′-O-acetyl-N-(trifluoroacetyl)doxorubicin (Berube & Lepage, Synth. Commun. 28(6):1109-1116, 1998), 2-pyrrolinodoxorubicin (Nagy et al., Proc. Nat'l Acad. Sci. U.S.A. 95(4):1794-1799, 1998), disaccharide doxorubicin analogues (Arcamone et al., J. Nat'l Cancer Inst. 89(16):1217-1223, 1997), 4-demethoxy-7-O-[2,6-dideoxy-4-O-(2,3,6-trideoxy-3-amino-α-L-lyxo-hexopyranosyl)-α-L-lyxo-hexopyranosyl]-adriamicinone doxorubicin disaccharide analog (Monteagudo et al., Carbohydr. Res. 300(1):11-16, 1997), 2-pyrrolinodoxorubicin (Nagy et al., Proc. Nat'l Acad. Sci. U.S.A. 94(2):652-656, 1997), morpholinyl doxorubicin analogues (Duran et al., Cancer Chemother. Pharmacol. 38(3):210-216, 1996), enaminomalonyl-β-alanine doxorubicin derivatives (Seitz et al., Tetrahedron Lett. 36(9):1413-16, 1995), cephalosporin doxorubicin derivatives (Vrudhula et al., J. Med. Chem. 38(8):1380-5, 1995), hydroxyrubicin (Solary et al., Int. J. Cancer 58(1):85-94, 1994), methoxymorpholino doxorubicin derivative (Kuhl et al., Cancer Chemother. Pharmacol. 33(1):10-16, 1993), (6-maleimidocaproyl)hydrazone doxorubicin derivative (Willner et al., Bioconjugate Chem. 4(6):521-7, 1993), N-(5,5-diacetoxypent-1-yl) doxorubicin (Cherif & Farquhar, J. Med. Chem. 35(17):3208-14, 1992), FCE 23762 methoxymorpholinyl doxorubicin derivative (Ripamonti et al., Br. J. Cancer 65(5):703-7, 1992), N-hydroxysuccinimide ester doxorubicin derivatives (Demant et al., Biochim. Biophys. Acta 1118(1):83-90, 1991), polydeoxynucleotide doxorubicin derivatives (Ruggiero et al., Biochim. Biophys. Acta 1129(3):294-302, 1991), morpholinyl doxorubicin derivatives (EPA 434960), mitoxantrone doxorubicin analogue (Krapcho et al., J. Med. Chem. 34(8):2373-80. 1991), AD198 doxorubicin analogue (Traganos et al., Cancer Res. 51(14):3682-9, 1991), 4-demethoxy-3′-N-trifluoroacetyldoxorubicin (Horton et al., Drug Des. Delivery 6(2):123-9, 1990), 4′-epidoxorubicin (Drzewoski et al., Pol. J. Pharmacol. Pharm. 40(2):159-65, 1988; Weenen et al., Eur. J. Cancer Clin. Oncol. 20(7):919-26, 1984), alkylating cyanomorpholino doxorubicin derivative (Scudder et al., J. Nat'l Cancer Inst. 80(16):1294-8, 1988), deoxydihydroiodooxorubicin (EPA 275966), adriblastin (Kalishevskaya et al., Vestn. Mosk. Univ., 16(Biol. 1):21-7, 1988), 4′-deoxydoxorubicin (Schoelzel et al., Leuk. Res. 10(12):1455-9, 1986), 4-demethyoxy-4′-o-methyldoxorubicin (Giuliani et al., Proc. Int. Congr. Chemother. 16:285-70-285-77, 1983), 3′-deamino-3′-hydroxydoxorubicin (Horton et al., J. Antibiot. 37(8):853-8, 1984), 4-demethyoxy doxorubicin analogues (Barbieri et al., Drugs Exp. Clin. Res. 10(2):85-90, 1984), N-L-leucyl doxorubicin derivatives (Trouet et al., Anthracyclines (Proc. Int. Symp. Tumor Pharmacother.), 179-81, 1983), 3′-deamino-3′-(4-methoxy-1-piperidinyl) doxorubicin derivatives (U.S. Pat. No. 4,314,054), 3′-deamino-3′-(4-mortholinyl) doxorubicin derivatives (U.S. Pat. No. 4,301,277), 4′-deoxydoxorubicin and 4′-o-methyldoxorubicin (Giuliani et al., Int. J. Cancer 27(1):5-13, 1981), aglycone doxorubicin derivatives (Chan & Watson, J. Pharm. Sci. 67(12):1748-52, 1978), SM 5887 (Pharma Japan 1468:20, 1995), MX-2 (Pharma Japan 1420:19, 1994), 4′-deoxy-13(S)-dihydro-4′-iododoxorubicin (EP 275966), morpholinyl doxorubicin derivatives (EPA 434960), 3′-deamino-3′-(4-methoxy-1-piperidinyl) doxorubicin derivatives (U.S. Pat. No. 4,314,054), doxorubicin-14-valerate, morpholinodoxorubicin (U.S. Pat. No. 5,004,606), 3′-deamino-3′-(3″-cyano-4″-morpholinyl doxorubicin; 3′-deamino-3′-(3″-cyano-4″-morpholinyl)-13-dihydroxorubicin; (3′-deamino-3′-(3″-cyano-4″-morpholinyl) daunorubicin; 3′-deamino-3′-(3″-cyano-4″-morpholinyl)-3-dihydrodaunorubicin; and 3′-deamino-3′-(4″-morpholinyl-5-iminodoxorubicin and derivatives (U.S. Pat. No. 4,585,859), 3′-deamino-3′-(4-methoxy-1-piperidinyl) doxorubicin derivatives (U.S. Pat. No. 4,314,054) and 3-deamino-3-(4-morpholinyl) doxorubicin derivatives (U.S. Pat. No. 4,301,277).

2. Folic Acid Antagonists

In certain embodiments, a folic acid antagonist may be used in combination with a pyrimidine analog to provide anti-infective catheters. Exemplary folic acid antagonists include Methotrexate or derivatives or analogs thereof, such as edatrexate, trimetrexate, raltitrexed, piritrexim, denopterin, tomudex, and pteropterin. Methotrexate analogs have the following general structure:

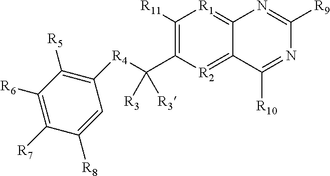

The identity of the R group may be selected from organic groups, particularly those groups set forth in U.S. Pat. Nos. 5,166,149 and 5,382,582. For example, R₁ may be N, R₂ may be N or C(CH₃), R₃ and R₃′ may H or alkyl, e.g., CH₃, R₄ may be a single bond or NR, where R is H or alkyl group. R_{5,6,8} may be H, OCH₃, or alternately they can be halogens or hydro groups. R₇ is a side chain of the general structure:

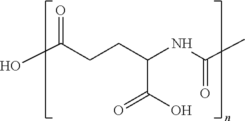

wherein n=1 for methotrexate, n=3 for pteropterin. The carboxyl groups in the side chain may be esterified or form a salt such as a Zn²⁺ salt. R₉ and R₁₀ can be NH₂ or may be alkyl substituted.

Certain folic acid antagonist compounds have the structures:

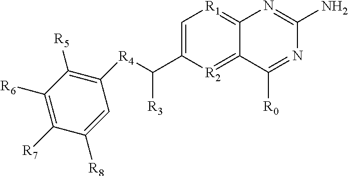

| | R₀ | R₁ | R₂ | R₃ | R₄ | R₅ | R₆ | R₇ | R₈ |
|---|---|---|---|---|---|---|---|---|---|
| Methotrexate | NH₂ | N | N | H | N(CH₃) | H | H | A (n = 1) | H |
| Edatrexate | NH₂ | N | N | H | CH(CH₂CH₃) | H | H | A (n = 1) | H |
| Trimetrexate | NH₂ | CH | C(CH₃) | H | NH | H | OCH₃ | OCH₃ | OCH₃ |
| Pteropterin | OH | N | N | H | NH | H | H | A (n = 3) | H |
| Denopterin | OH | N | N | CH₃ | N(CH₃) | H | H | A (n = 1) | H |
| Peritrexim | NH₂ | N | C(CH₃) | H | single bond | OCH₃ | H | H | OCH₃ |

A:

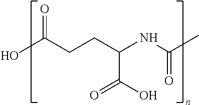

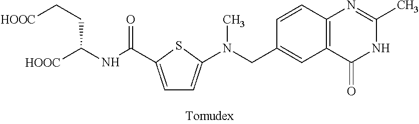

Other representative examples include 6-S-aminoacyloxymethyl mercaptopurine derivatives (Harada et al., Chem. Pharm. Bull. 43(10):793-6, 1995), 6-mercaptopurine (6-MP) (Kashida et al., Biol. Pharm. Bull. 18(11):1492-7, 1995), 7,8-polymethyleneimidazo-1,3,2-diazaphosphorines (Nilov et al., Mendeleev Commun. 2:67, 1995), azathioprine (Chifotides et al., J. Inorg. Biochem. 56(4):249-64, 1994), methyl-D-glucopyranoside mercaptopurine derivatives (Da Silva et al., Eur. J. Med. Chem. 29(2):149-52, 1994) and s-alkynyl mercaptopurine derivatives (Ratsino et al., Khim.-Farm. Zh. 15(8):65-7, 1981); indoline ring and a modified ornithine or glutamic acid-bearing methotrexate derivatives (Matsuoka et al., Chem. Pharm. Bull. 45(7):1146-1150, 1997), alkyl-substituted benzene ring C bearing methotrexate derivatives (Matsuoka et al., Chem. Pharm. Bull. 44(12):2287-2293, 1996), benzoxazine or benzothiazine moiety-bearing methotrexate derivatives (Matsuoka et al., J. Med. Chem. 40(1):105-111, 1997), 10-deazaminopterin analogues (DeGraw et al., J. Med. Chem. 40(3):370-376, 1997), 5-deazaminopterin and 5,10-dideazaminopterin methotrexate analogues (Piper et al., J. Med. Chem. 40(3):377-384, 1997), indoline moiety-bearing methotrexate derivatives (Matsuoka et al., Chem. Pharm. Bull. 44(7):1332-1337, 1996), lipophilic amide methotrexate derivatives (Pignatello et al., World Meet. Pharm. Biopharm. Pharm. Technol., 563-4, 1995), L-threo-(2S,4S)-4-fluoroglutamic acid and DL-3,3-difluoroglutamic acid-containing methotrexate analogues (Hart et al., J. Med. Chem. 39(1):56-65, 1996), methotrexate tetrahydroquinazoline analogue (Gangjee, et al., J. Heterocycl. Chem. 32(1):243-8, 1995), N-(α-aminoacyl)methotrexate derivatives (Cheung et al., Pteridines 3(1-2):101-2, 1992), biotin methotrexate derivatives (Fan et al., Pteridines 3(1-2):131-2, 1992), D-glutamic acid or D-erythrou, threo-4-fluoroglutamic acid methotrexate analogues (McGuire et al., Biochem. Pharmacol. 42(12):2400-3, 1991), β,γ-methano methotrexate analogues (Rosowsky et al., Pteridines 2(3):133-9, 1991), 10-deazaminopterin (10-EDAM) analogue (Braakhuis et al., Chem. Biol. Pteridines, Proc. Int. Symp. Pteridines Folic Acid Deriv, 1027-30, 1989), γ-tetrazole methotrexate analogue (Kalman et al., Chem. Biol. Pteridines, Proc. Int. Symp. Pteridines Folic Acid Deriv, 1154-7, 1989), N-(L-α-aminoacyl) methotrexate derivatives (Cheung et al., Heterocycles 28(2):751-8, 1989), meta and ortho isomers of aminopterin (Rosowsky et al., J. Med. Chem. 32(12):2582, 1989), hydroxymethylmethotrexate (DE 267495), γ-fluoromethotrexate (McGuire et al., Cancer Res. 49(16):4517-25, 1989), polyglutamyl methotrexate derivatives (Kumar et al., Cancer Res. 46(10):5020-3, 1986), gem-diphosphonate methotrexate analogues (WO 88/06158), α- and γ-substituted methotrexate analogues (Tsushima et al., Tetrahedron 44(17):5375-87, 1988), 5-methyl-5-deaza methotrexate analogues (U.S. Pat. No. 4,725,687), Nδ-acyl-Nα-(4-amino-4-deoxypteroyl)-L-ornithine derivatives (Rosowsky et al., J. Med. Chem. 31(7):1332-7, 1988), 8-deaza methotrexate analogues (Kuehl et al., Cancer Res. 48(6):1481-8, 1988), acivicin methotrexate analogue (Rosowsky et al., J. Med. Chem. 30(8):1463-9, 1987), polymeric platinol methotrexate derivative (Carraher et al., Polym. Sci. Technol. (Plenum), 35(Adv. Biomed. Polym.):311-24, 1987), methotrexate-γ-dimyristoylphophatidylethanolamine (Kinsky et al., Biochim. Biophys. Acta 917(2):211-18, 1987), methotrexate polyglutamate analogues (Rosowsky et al., Chem. Biol. Pteridines, Pteridines Folid Acid Deriv., Proc. Int. Symp. Pteridines Folid Acid Deriv.: Chem., Biol. Clin. Aspects: 985-8, 1986), poly-γ-glutamyl methotrexate derivatives (Kisliuk et al., Chem. Biol. Pteridines, Pteridines Folid Acid Deriv., Proc. Int. Symp. Pteridines Folid Acid Deriv.: Chem., Biol. Clin. Aspects: 989-92, 1986), deoxyuridylate methotrexate derivatives (Webber et al., Chem. Biol. Pteridines, Pteridines Folid Acid Deriv., Proc. Int. Symp. Pteridines Folid Acid Deriv.: Chem., Biol. Clin. Aspects: 659-62, 1986), iodoacetyl lysine methotrexate analogue (Delcamp et al., Chem. Biol. Pteridines, Pteridines Folid Acid Deriv., Proc. Int. Symp. Pteridines Folid Acid Deriv.: Chem., Biol. Clin. Aspects: 807-9, 1986), 2, omega-diaminoalkanoid acid-containing methotrexate analogues (McGuire et al., Biochem. Pharmacol. 35(15):2607-13, 1986), polyglutamate methotrexate derivatives (Kamen & Winick, Methods Enzymol. 122(Vitam. Coenzymes, Pt. G):339-46, 1986), 5-methyl-5-deaza analogues (Piper et al., J. Med. Chem. 29(6):1080-7, 1986), quinazoline methotrexate analogue (Mastropaolo et al., J. Med. Chem. 29(1):155-8, 1986), pyrazine methotrexate analogue (Lever & Vestal, J. Heterocycl. Chem. 22(1):5-6, 1985), cysteic acid and homocysteic acid methotrexate analogues (U.S. Pat. No. 4,490,529), γ-tert-butyl methotrexate esters (Rosowsky et al., J. Med. Chem. 28(5):660-7, 1985), fluorinated methotrexate analogues (Tsushima et al., Heterocycles 23(1):45-9, 1985), folate methotrexate analogue (Trombe, J. Bacteriol. 160(3):849-53, 1984), phosphonoglutamic acid analogues (Sturtz & Guillamot, Eur. J. Med. Chem.—Chim. Ther. 19(3):267-73, 1984), poly (L-lysine) methotrexate conjugates (Rosowsky et al., J. Med. Chem. 27(7):888-93, 1984), dilysine and trilysine methotrexate derivates (Forsch & Rosowsky, J. Org. Chem. 49(7):1305-9, 1984), 7-hydroxymethotrexate (Fabre et al., Cancer Res. 43(10):4648-52, 1983), poly-γ-glutamyl methotrexate analogues (Piper & Montgomery, Adv. Exp. Med. Biol., 163(Folyl Antifolyl Polyglutamates):95-100, 1983), 3′,5′-dichloromethotrexate (Rosowsky & Yu, J. Med. Chem. 26(10):1448-52, 1983), diazoketone and chloromethylketone methotrexate analogues (Gangjee et al., J. Pharm. Sci. 71(6):717-19, 1982), 10-propargylaminopterin and alkyl methotrexate homologs (Piper et al., J. Med. Chem. 25(7):877-80, 1982), lectin derivatives of methotrexate (Lin et al., JNCI 66(3):523-8, 1981), polyglutamate methotrexate derivatives (Galivan, Mol. Pharmacol. 17(1):105-10, 1980), halogenated methotrexate derivatives (Fox, JNCI 58(4):J955-8, 1977), 8-alkyl-7,8-dihydro analogues (Chaykovsky et al., J. Med. Chem. 20(10):J1323-7, 1977), 7-methyl methotrexate derivatives and dichloromethotrexate (Rosowsky & Chen, J. Med. Chem. 17(12):J1308-11, 1974), lipophilic methotrexate derivatives and 3′,5′-dichloromethotrexate (Rosowsky, J. Med. Chem. 16(10):J1190-3, 1973), deaza amethopterin analogues (Montgomery et al., Ann. N.Y. Acad. Sci. 186:J227-34, 1971), MX068 (Pharma Japan, 1658:18, 1999) and cysteic acid and homocysteic acid methotrexate analogues (EPA 0142220);

These compounds are believed to act as antimetabolites of folic acid.

3. Podophyllotoxins

In certain embodiments, a podophyllotoxin may be used in combination of a pyrimidine analog to provide anti-infective catheters. Exemplary compounds of this type include etoposide or teniposide, which have the following structures:

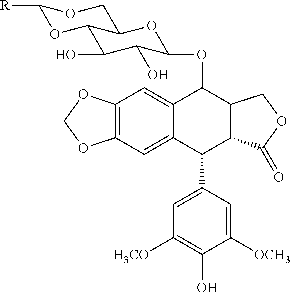

| | R |
|---|---|
| Etoposide | CH₃ |
| Teniposide | 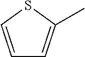 |

Other representative examples of podophyllotoxins include Cu(II)-VP-16 (etoposide) complex (Tawa et al., Bioorg. Med. Chem. 6(7):1003-1008, 1998), pyrrolecarboxamidino-bearing etoposide analogues (Ji et al., Bioorg. Med. Chem. Lett. 7(5):607-612, 1997), 4β-amino etoposide analogues (Hu, University of North Carolina Dissertation, 1992), γ-lactone ring-modified arylamino etoposide analogues (Zhou et al., J. Med. Chem. 37(2):287-92, 1994), N-glucosyl etoposide analogue (Allevi et al., Tetrahedron Lett. 34(45):7313-16, 1993), etoposide A-ring analogues (Kadow et al., Bioorg. Med. Chem. Lett. 2(1):17-22, 1992), 4′-deshydroxy-4′-methyl etoposide (Saulnier et al., Bioorg. Med. Chem. Lett. 2(10):1213-18, 1992), pendulum ring etoposide analogues (Sinha et al., Eur. J. Cancer 26(5):590-3, 1990) and E-ring desoxy etoposide analogues (Saulnier et al., J. Med. Chem. 32(7):1418-20, 1989).

These compounds are believed to act as Topoisomerase II Inhibitors and/or DNA cleaving agents.

4. Camptothecins

In certain embodiments, camptothecin or an analog or derivative thereof may be used in combination of a pyrimidine to provide anti-infective catheters. Camptothecins have the following general structure.

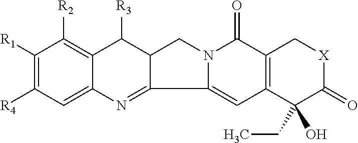

In this structure, X is typically O, but can be other groups, e.g., NH in the case of 21-lactam derivatives. R₁ is typically H or OH, but may be other groups, e.g., a terminally hydroxylated C₁₋₃ alkane. R₂ is typically H or an amino containing group such as (CH₃)₂NHCH₂, but may be other groups e.g., NO₂, NH₂, halogen (as disclosed in, e.g., U.S. Pat. No. 5,552,156) or a short alkane containing these groups. R₃ is typically H or a short alkyl such as C₂H₅. R₄ is typically H but may be other groups, e.g., a methylenedioxy group with R₁.

Exemplary camptothecin compounds include topotecan, irinotecan (CPT-11), 9-aminocamptothecin, 21-lactam-20(S)-camptothecin, 10,11-methylenedioxycamptothecin, SN-38, 9-nitrocamptothecin, 10-hydroxycamptothecin. Exemplary compounds have the structures:

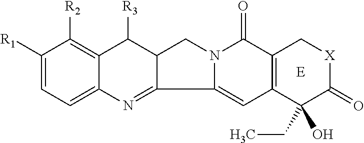

| | R₁ | R₂ | R₃ |
|---|---|---|---|
| Camptothecin: | H | H | H |
| Topotecan: | OH | (CH₃)₂NHCH₂ | H |
| SN-38: | OH | H | C₂H₅ |

X: O for most analogs, NH for 21-lactam analogs

Camptothecins have the five rings shown here. The ring labeled E must be intact (the lactone rather than carboxylate form) for maximum activity and minimum toxicity.

Camptothecins are believed to function as Topoisomerase I Inhibitors and/or DNA cleavage agents.

5. Hydroxyureas

In certain embodiments, a hydroxyurea may be used in combination with a pyrimidine analog to provide anti-infective catheters. Hydroxyureas have the following general structure:

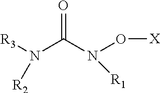

Suitable hydroxyureas are disclosed in, for example, U.S. Pat. No. 6,080,874, wherein R₁ is:

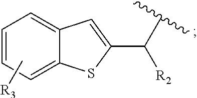

and R₂ is an alkyl group having 1-4 carbons and R₃ is one of H, acyl, methyl, ethyl, and mixtures thereof, such as a methylether.

Other suitable hydroxyureas are disclosed in, e.g., U.S. Pat. No. 5,665,768, wherein R₁ is a cycloalkenyl group, for example N-[3-[5-(4-fluorophenylthio)-furyl]-2-cyclopenten-1-yl]N-hydroxyurea; R₂ is H or an alkyl group having 1 to 4 carbons and R₃ is H; X is H or a cation. Other suitable hydroxyureas are disclosed in, e.g., U.S. Pat. No. 4,299,778, wherein R₁ is a phenyl group substituted with one or more fluorine atoms; R₂ is a cyclopropyl group; and R₃ and X is H.

Other suitable hydroxyureas are disclosed in, e.g., U.S. Pat. No. 5,066,658, wherein R₂ and R₃ together with the adjacent nitrogen form:

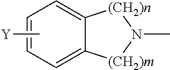

wherein m is 1 or 2, n is 0-2 and Y is an alkyl group.

In one aspect, the hydroxyurea has the structure:

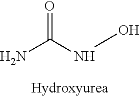

These compounds are thought to function by inhibiting DNA synthesis.

6. Platinum Complexes

In certain embodiments, a platinum compound may be used in combination with a pyrimidine analog to provide anti-infective catheter. In general, suitable platinum complexes may be of Pt(II) or Pt(IV) and have this basic structure:

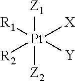

wherein X and Y are anionic leaving groups such as sulfate, phosphate, carboxylate, and halogen; R₁ and R₂ are alkyl, amine, amino alkyl any may be further substituted, and are basically inert or bridging groups. For Pt(II) complexes Z₁ and Z₂ are non-existent. For Pt(IV) Z₁ and Z₂ may be anionic groups such as halogen, hydroxy, carboxylate, ester, sulfate or phosphate. See, e.g., U.S. Pat. Nos. 4,588,831 and 4,250,189.

Suitable platinum complexes may contain multiple Pt atoms. See, e.g., U.S. Pat. Nos. 5,409,915 and 5,380,897. For example bisplatinum and triplatinum complexes of the type:

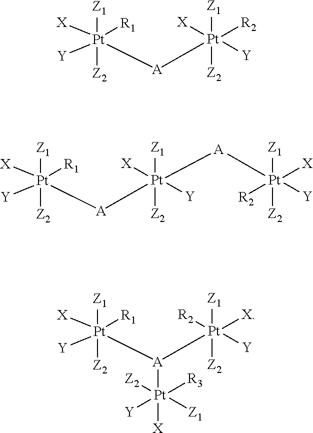

Exemplary platinum compounds are cisplatin, carboplatin, oxaliplatin, and miboplatin having the structures:

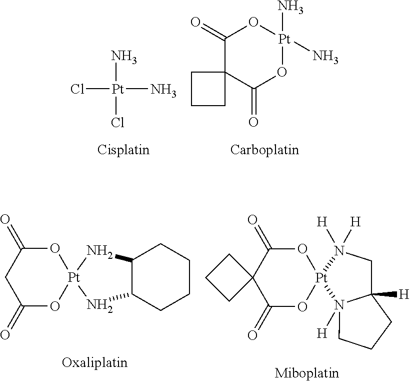

Other representative platinum compounds include (CPA)₂Pt[DOLYM] and (DACH)Pt[DOLYM] cisplatin (Choi et al., Arch. Pharmacal Res. 22(2):151-156, 1999), Cis-[PtCl₂(4,7-H-5-methyl-7-oxo]1,2,4[triazolo[1,5-a]pyrimidine)₂] (Navarro et al., J. Med. Chem. 41(3):332-338, 1998), [Pt(cis-1,4-DACH)(trans-Cl₂)(CBDCA)].½MeOH cisplatin (Shamsuddin et al., Inorg. Chem. 36(25):5969-5971, 1997), 4-pyridoxate diammine hydroxy platinum (Tokunaga et al., Pharm. Sci. 3(7):353-356, 1997), Pt(II) . . . Pt(II) (Pt₂[NHCHN(C(CH₂)(CH₃))]₄) (Navarro et al., Inorg. Chem. 35(26):7829-7835, 1996), 254-S cisplatin analogue (Koga et al., Neurol. Res. 18(3):244-247, 1996), o-phenylenediamine ligand bearing cisplatin analogues (Koeckerbauer & Bednarski, J. Inorg. Biochem. 62(4):281-298, 1996), trans, cis-[Pt(OAc)₂I₂(en)] (Kratochwil et al., J. Med. Chem. 39(13):2499-2507, 1996), estrogenic 1,2-diarylethylenediamine ligand (with sulfur-containing amino acids and glutathione) bearing cisplatin analogues (Bednarski, J. Inorg. Biochem. 62(1):75, 1996), cis-1,4-diaminocyclohexane cisplatin analogues (Shamsuddin et al., J. Inorg. Biochem. 61(4):291-301, 1996), 5′ orientational isomer of cis-[Pt(NH₃)(4-aminoTEMP-O){d(GpG)}] (Dunham & Lippard, J. Am. Chem. Soc. 117(43):10702-12, 1995), chelating diamine-bearing cisplatin analogues (Koeckerbauer & Bednarski, J. Pharm. Sci. 84(7):819-23, 1995), 1,2-diarylethyleneamine ligand-bearing cisplatin analogues (Otto et al., J. Cancer Res. Clin. Oncol. 121(1):31-8, 1995), (ethylenediamine)platinum(II) complexes (Pasini et al., J. Chem. Soc., Dalton Trans. 4:579-85, 1995), CI-973 cisplatin analogue (Yang et al., Int. J. Oncol. 5(3):597-602, 1994), cis-diaminedichloroplatinum(II) and its analogues cis-1,1-cyclobutanedicarbosylato(2R)-2-methyl-1,4-butanediamineplatinum(II) and cis-diamine(glycolato)platinum (Claycamp & Zimbrick, J. Inorg. Biochem. 26(4):257-67, 1986; Fan et al., Cancer Res. 48(11):3135-9, 1988; Heiger-Bernays et al., Biochemistry 29(36):8461-6, 1990; Kikkawa et al., J. Exp. Clin. Cancer Res. 12(4):233-40, 1993; Murray et al., Biochemistry 31(47):11812-17, 1992; Takahashi et al., Cancer Chemother. Pharmacol. 33(1):31-5, 1993), cis-amine-cyclohexylamine-dichloroplatinum(II) (Yoshida et al., Biochem. Pharmacol. 48(4):793-9, 1994), gem-diphosphonate cisplatin analogues (FR 2683529), (meso-1,2-bis(2,6-dichloro-4-hydroxyplenyl)ethylenediamine) dichloroplatinum(II) (Bednarski et al., J. Med. Chem. 35(23):4479-85, 1992), cisplatin analogues containing a tethered dansyl group (Hartwig et al., J. Am. Chem. Soc. 114(21):8292-3, 1992), platinum(II) polyamines (Siegmann et al., Inorg. Met.-Containing Polym. Mater., (Proc. Am. Chem. Soc. Int. Symp.), 335-61, 1990), cis-(3H)dichloro(ethylenediamine)platinum(II) (Eastman, Anal. Biochem. 197(2):311-15, 1991), trans-diamminedichloroplatinum(II) and cis-(Pt(NH₃)₂(N₃-cytosine)Cl) (Belton & Lippard, Biophys. Chem. 35(2-3):179-88, 1990), 3H-cis-1,2-diaminocyclohexanedichloroplatinum(II) and 3H-cis-1,2-diaminocyclohexanemalonatoplatinum (II) (Oswald et al., Res. Commun. Chem. Pathol. Pharmacol. 64(1):41-58, 1989), diaminocarboxylatoplatinum (EPA 296321), trans-(D,1)-1,2-diaminocyclohexane carrier ligand-bearing platinum analogues (Wyrick & Chaney, J. Labelled Compd. Radiopharm. 25(4):349-57, 1988), aminoalkylaminoanthraquinone-derived cisplatin analogues (Kitov et al., Eur. J. Med. Chem. 23(4):381-3, 1988), spiroplatin, carboplatin, iproplatin and JM40 platinum analogues (Schroyen et al., Eur. J. Cancer Clin. Oncol. 24(8):1309-12, 1988), bidentate tertiary diamine-containing cisplatinum derivatives (Orbell et al., Inorg. Chim. Acta 152(2):125-34, 1988), platinum(II), platinum(IV) (Liu & Wang, Shandong Yike Daxue Xuebao 24(1):35-41, 1986), cis-diamine(1,1-cyclobutanedicarboxylato-)platinum(II) (carboplatin, JM8) and ethylenediammine-malonatoplatinum(II) (JM40) (Begg et al., Radiother. Oncol. 9(2):157-65, 1987), JM8 and JM9 cisplatin analogues (Harstrick et al., Int. J. Androl. 10(1); 139-45, 1987), (NPr4)2((PtCL4).cis-(PtCl2-(NH2Me)2)) (Brammer et al., J. Chem. Soc., Chem. Commun. 6:443-5, 1987), aliphatic tricarboxylic acid platinum complexes (EPA 185225), and cis-dichloro(amino acid) (tert-butylamine)platinum(II) complexes (Pasini & Bersanetti, Inorg. Chim. Acta 107(4):259-67, 1985). These compounds are thought to function by binding to DNA, i.e., acting as alkylating agents of DNA.

### Other Secondary Anti-Infective Agents

In addition to the above-described chemotherapeutics as secondary anti-infective agents, other anti-infective agents may also be used in combination with a pyrimidine analog to provide anti-infective catheters. Such anti-infective agents may be antibacterial or antifungal agents. Exemplary antibacterial agents include antibiotics (i.e., agents that destroy microorganisms internally), agents effective against gram positive bacteria, and agents effective against gram negative bacteria, disinfectants (i.e., agents that destroy microorganism found on nonliving objects), and antiseptics (i.e., agents that kill or inhibit the growth of microorganisms on the external surfaces of the body). Antiseptics include germicides (i.e., agents capable of destroying microbes) and bacteriostatics (i.e., agents capable of preventing or inhibiting bacterial growth).

Anti-infective agents that may be used in combination with a pyrimidine analog include, but are not limited to, silver compounds (e.g., silver chloride, silver nitrate, silver oxide), silver ions, silver particles, gold compounds (such as gold chloride, auranofin), gold ions, gold particles, iodine, povidone/iodine, chlorhexidine, 2-p-sulfanilyanilinoethanol, 4,4′-sulfinyldianiline, 4-sulfanilamidosalicylic acid, acediasulfone, acetosulfone, amikacin, amoxicillin, amphotericin B, ampicillin, apalcillin, apicycline, apramycin, arbekacin, aspoxicillin, azidamfenicol, azithromycin, aztreonam, bacitracin, bambermycin(s), biapenem, brodimoprim, butirosin, capreomycin, carbenicillin, carbomycin, carumonam, cefadroxil, cefamandole, cefatrizine, cefbuperazone, cefclidin, cefdinir, cefditoren, cefepime, cefetamet, cefixime, cefinenoxime, cefminox, cefodizime, cefonicid, cefoperazone, ceforanide, cefotaxime, cefotetan, cefotiam, cefozopran, cefpimizole, cefpiramide, cefpirome, cefprozil, cefroxadine, ceftazidime, cefteram, ceftibuten, ceftriaxone, cefuzonam, cephalexin, cephaloglycin, cephalosporin C, cephradine, chloramphenicol, chlortetracycline, ciprofloxacin, clarithromycin, clinafloxacin, clindamycin, clomocycline, colistin, cyclacillin, dapsone, demeclocycline, diathymosulfone, dibekacin, dihydrostreptomycin, dirithromycin, doxycycline, enoxacin, enviomycin, epicillin, erythromycin, flomoxef, fortimicin(s), gentamicin(s), glucosulfone solasulfone, gramicidin S, gramicidin(s), grepafloxacin, guamecycline, hetacillin, imipenem, isepamicin, josamycin, kanamycin(s), leucomycin(s), lincomycin, lomefloxacin, lucensomycin, lymecycline, meclocycline, meropenem, methacycline, micronomicin, midecamycin(s), minocycline, moxalactam, mupirocin, nadifloxacin, natamycin, neomycin, netilmicin, norfloxacin, oleandomycin, oxytetracycline, p-sulfanilylbenzylamine, panipenem, paromomycin, pazufloxacin, penicillin N, pipacycline, pipemidic acid, polymyxin, primycin, quinacillin, ribostamycin, rifamide, rifampin, rifamycin SV, rifapentine, rifaximin, ristocetin, ritipenem, rokitamycin, rolitetracycline, rosaramycin, roxithromycin, salazosulfadimidine, sancycline, sisomicin, sparfloxacin, spectinomycin, spiramycin, streptomycin, succisulfone, sulfachrysoidine, sulfaloxic acid, sulfamidochrysoidine, sulfanilic acid, sulfoxone, teicoplanin, temafloxacin, temocillin, tetracycline, tetroxoprim, thiamphenicol, thiazolsulfone, thiostrepton, ticarcillin, tigemonam, tobramycin, tosufloxacin, trimethoprim, trospectomycin, trovafloxacin, tuberactinomycin, vancomycin, azaserine, candicidin(s), chlorphenesin, dermostatin(s), filipin, fungichromin, mepartricin, nystatin, oligomycin(s), ciproflaxacin, norfloxacin, ofloxacin, pefloxacin, enoxacin, rosoxacin, amifloxacin, fleroxacin, temafloaxcin, lomefloxacin, perimycin A or tubercidin, and the like.

The pyrimidine analog may be further combined with one or more of the antibiotics known to combat growth of gram negative bacteria. Antibiotics that are useful against gram negative bacteria include amoxicillin, ampicillin, azithromycin, aztreonam, cefepime, cefixime, ceftriaxone, cephalosporin C, chloramphenicol, ciprofloxacin, clindamycin, doxycycline, erythromycin, imipenem, meropenem, rifampin, spectinomycin, streptomycin, tetracycline, tobramycin, and trimethoprim.

In certain embodiments, the pyrimdine analog may be combined with one or more disinfecting agents, including but are not limited to, AgNO₃ (silver nitrate), BAKCl (benzalkonium chloride), BenthonCl (benzethonium chloride), BenzChlPheno (benzyl-p-chlorophenol), Bronopol (2-bromo-2-nitro-1,3-propanediol), CetPyrCl (cetylpyridinium chloride), Chlorhexidine (1,1′-hexamethylenebiskp-chlorophenyl)biguanideD, Proxel (1,2-Benzisothiazolin-3-one), Triclosan (5-Chloro-2-(2,4-dichlorophenoxy)phenol), and Vantocil (poly(hexamethylene biguanide) hydrochloride).

In certain embodiments, the pyrimidine analog may be combined with one or more antibiotic agents, including but are not limited to, bacitracin, Cephalasporin C, Miconizole Nitrate, Neomycin Sulfate, Norfloxacin, Phosphomycin, Polymyxin B Sufate, and Rifampin.

In certain embodiments, the pyrimidine analog may be combined with a combination of two disinfecting agents, a combination of two antibiotic agents, or a combination of a disinfecting agent and an antibiotic agent. Such a combination includes but is not limited to, the combination of AgNO₃ and Triclosan, Bronopol and BAKCl, Bronopol and HBAK (heparin benzalkonium complex), Bronopol and Triclosan, Bronopol and Vantocil, and Triclosan and Phosphomycin.

In certain embodiments, the pyrimidine analog may be combined with an antiseptic agent. Useful antiseptic agents include but are not limited to alcohols, such as ethanol, 1-propanol, and isopropanol; aldehydes, such as glutaraldehyde, formaldehyde, formaldehyde-releasing agents, o-phthalaldehyde; anilides, such as Triclocarban (TCC; 3,4,4′-triclorocarbanilide); biguanides, such as chlorhexidine, poly(hexamethylene biguanide)hydrochloride; bronopol, such as 2-bromo-2-nitro-1,3-propanediol, diamidines, such as propamidine (4,4-diaminodiphenoxypropane), dibromopropamidine, (2,2-dobromo-4,4-diamidinodiphenoxypropane); halogen-releasing agents, such as Sodium hypochlorite, chlorine dioxide, sodium dichloroisocyanurate; silver compounds, such as silver nitrate, silver sulfadiazine; peroxygens, such as hydrogen peroxide, peracetic acid; phenols, such as phenol, o-phenylphenol, benzyl-p-chlorophenol, chlorocresol; bis-phenols, such as triclosan, hexachlorophene, and quaternary compounds, such as benzalkonium chloride, benzethonium chloride, cetylpyridinium chloride, cetyltrimethylammonium bromide, cetylpyridinium chloride.

In certain embodiments, the pyrimidine analog may be combined with an antifungal agent. Useful antifungal agents include but are not limited to Amphoteracin B, Micafungin, Caspofungin (Cancidas, MK-0991), Miconazole, V-echinocandin, Nystatin, Fluconazole (Diflucan), Posaconazole, Flucytosine (Ancobon), Ravuconazole, Griseofulvin, Terbinafine, Hamycin, Voriconazole (Vfend), Itraconazole (Sporanox), Ketoconazole. Further examples of anti-infective agents that may be used in combination with a pyrimidine analog include quaternary amines and other biocides.

### Other Secondary Agents

The anti-infective catheters may comprise active agents other than anti-infective agents. Depending on the intended use of the catheters, additional active agents may be desirable. For example, thrombosis and thrombophlebitis are common complications associated with implantation of vascular catheters. Therefore, vascular catheters may include, in addition to a pyrimidine analog (with or without a secondary anti-infective agent), an antithrombotic agent, i.e., agents used to treat or prevent thrombosis. Exemplary classes of antithrombotics include antithrombogenics, antiaggregants, thrombolytics, anticoagulants, antiplatelet agents, and other antithrombotics. These agents may be administered alone or in combination.

In exemplary embodiments, the antithrombotic is a thrombolytic, i.e., an agent which dissolves blood clots. Thrombolytics include, for example, enzymes such as brinase; plasminogen activators; e.g., t-PA (alteplase, activase), reteplase (retavase), tenecteplase (TNKase), anistreplase (eminase), plamin, streptokinase (kabikinase, streptase), single chain urokinase, urokinase (abbokinase), and saruplase; and serine endopeptidases, e.g., ancrod, drotrecogin alfa/protein C, and fibrinolysin.

In other exemplary embodiments, the antithrombotic is an anticoagulant, i.e., an agent which prevents coagulation. Anticoagulants include, for example, Vitamin K antagonists, heparin, heparin derivatives, heparin related compounds and direct thrombin inhibitors.

Examples of Vitamin K antagonists include acenocoumarol, clorindione, coumatetralyl, dicumarol (dicoumarol), diphenadione, ethyl biscoumacetate, phenprocoumon, phenindione, tioclomarol and warfarin (coumadin).

Heparin, derivative substances and related compounds of heparin, may be referenced to as the heparin group. Examples of the heparin group agents include antithrombin III, danaparoid, heparin, sulodexide, and low molecular weight heparin (LMWHs), e.g., bemiparin, dalteparin, enoxaparin, nadroparin, parnaparin, reviparin, and tinzaparin. A related agent is fondaparinux, a synthetic sugar composed of the five sugars (pentasaccharide) in heparin that bind to antithrombin.

Other heparin related compounds include heparin reacted with quaternary ammonium compounds, e.g., benzalkonium chloride, tridodecylmethylammonium chloride, cetylpyridinium chloride, benzyldimethylstearylammonium chloride, benzylcetyldimethylammonium chloride. See, for example, U.S. Pat. Nos. 5,525,348 and 5,069,899, issued to Whitbourne, et al., which are hereby incorporated by reference in their entirety.

Examples of direct thrombin inhibitors include argatroban, bivalirudin, dabigatran, desirudin, hirudin, recombinant hirudin, lepirudin, melagatran and ximelagatran (EXANTA®).

In other exemplary embodiments, the antithrombotic is an antiplatelet agent, i.e., an agent which decreases platelet aggregation and inhibit thrombus formation. Examples of antiplatelet agents include cyclooxygenase inhibitors (such as Celecoxib), acetylsalicylic acid (aspirin), adenosine diphosphate (ADP) receptor inhibitors, clopidogrel (Plavix), ticlopidine (Ticlid), phosphodiesterase inhibitors, cilostazol (Pletal), adenosine reuptake inhibitors, prostacyclins such as epoprostenol, and analogues, and dipyridamole (Persantine), dextrans, sulfinpyrazone (Anturane), and glycoprotein IIb/IIIa inhibitors including, monoclonal antibodies and murine-human chimeric antibodies such as abciximab (ReoPro), synthetic peptides such as eptifibatide (Integrilin), and synthetic non-peptides such as tirofiban (Aggrastat). Other examples include aloxiprin, ditazole, carbasalate calcium, cloricromen, indobufen, picotamide, prasugrel, triflusal and prostaglandin analogues, e.g., beraprost, prostacyclin, iloprost, and treprostinil.

Examples of other antithrombotics include defibrotide, dermatan sulfate, rivaroxaban, aminocaproic acid, cilastagel, vapiprost, angiopeptin, thromboxane inhibitors anti-thrombin and synthetic antithrombins.

In certain embodiments, anti-inflammatory agents may be included in anti-infective catheters provided herein. Exemplary anti-inflammatory agents include dexamethasone, cortisone, fludrocortisone, prednisone, prednisolone, 6α-methylprednisolone, triamcinolone, betamethasone, and aspirin.

In certain embodiments, immunomodulatory agents may be included in anti-infective catheters provided herein. Exemplary immunomodulatory agents include rapamycin, everolimus, ABT-578, azathioprine azithromycin, analogues of rapamycin, including tacrolimus and derivatives thereof (e.g., EP 0184162B1 and those described in U.S. Pat. No. 6,258,823) and everolimus and derivatives thereof (e.g., U.S. Pat. No. 5,665,772).

In certain embodiments, ant-fibrotic agents may be included in anti-infective catheters provided herein. Exemplary anti-fibrotic agents include paclitaxel, docetaxol, rapamycin, everorlimus, tacrolimus, epothilone A or B, discodermolide, deuterium oxide (D₂O), hexylene glycol, tubercidin, LY290181, aluminum fluoride, ethylene glycol bis-(succinimidylsuccinate), glycine ethyl ester, campothecin, or combinations thereof. Additional examples of anti-fibrotic agents may be found in U.S. Patent Application Publication No. 20050208095 and PCT Application Publication No. WO 2006/135479. The sections related to anti-fibrotic agents in these publications are incorporated herein by reference.

### Anti-infective Compositions

In another aspect, the present invention provides an anti-infective composition for applying to or incorporated into (e.g., coating) a catheter that comprises a polyurethane, a cellulose or cellulose-derived polymer, and a pyrimidine analog, wherein the pyrimidine analog is present in the coating at a concentration effective in reducing or inhibiting infection associated with the catheter.

The composition (e.g., a coating composition) provided herein allows for an effective amount of a pyrimidine analog, such as 5-FU and/or floxuridine, to be applied to or incorporated onto (e.g., coated on) a catheter. In addition, the polymers in the composition enable release of the pyrimidine analog from the composition (e.g., in form of a coating) on the catheter at effective concentrations over a sustained period of time. Furthermore, the composition (e.g., a coating composition) provided herein may be applied to or incorporated onto, such as form a coating on, a catheter with one or more of the following desirable features: (1) strong adhesion to the catheter when it is in use (e.g., after insertion in patients); (2) good flexibility and elasticity to remain intact following sterilization and implantation of the catheter in the patient; (3) excellent uniformity; (4) not significantly bioerodable, which allows for sustained release of the pyrimidine analog over a period of days, weeks, or months and minimizes patient's response to breakdown products of the coating; and (5) easy control of drug elution rate by using various ratios of the polyurethane to the cellulose or cellulose-derived polymer in the composition, which in turn allows for better control of the concentration and duration of anti-infective activity of the pyrimidine analog.

In certain embodiments, the compositions (e.g., coating compositions) provided herein were developed and optimized for total drug loading, drug elution kinetics and anti-microbial efficacy. They were modified to balance coating thickness, physical properties (e.g., flexibility), coating quality (e.g., adhesion and coating uniformity), and drug release kinetics. Parameters of the coating composition affecting these attributes include the ratios of the coating polymers to each other, the ratio of drug to total polymer, percent solids in the coating, choice and relative amounts of solvents, and the viscosity of the coating solution. In general, changes to the drug/polymer ratio can affect the rate and amount of drug eluted from the catheter. Increasing the drug to polymer ratio in the coating composition typically increases the rate of drug elution. However, if drug loading is too high, release of the drug from the coating can create voids and destroy the coating integrity. In certain embodiments, the total solids (and viscosity and coating thickness) were increased to achieve a higher dose of drug (e.g., 5-FU) while keeping the drug to polymer ratio below a certain level (e.g., about 40%, 30%, 25%, 20%, 15% or 10%).

“Polyurethane” refers to a linear polymer that has a molecular backbone containing carbamate groups (—NHCO₂). These groups are produced through a chemical reaction between a diisocyanate (a compound that comprises two —NCO groups) or polyisocyanate (a compound that comprises more than two —NCO groups) and a diol (a compound with two —OH groups) or polyol (a compound that comprises more than two —OH groups).

Diisocyanates and polyisocyanates that may be used to form polyurethanes useful in the present application can be aromatic, such as diphenylmethane diisocyaanate (MDI) or toluene diisocyanate (TDI), or aliphatic, such as hexamethylene diisocyanate (HDI) or isophorone diisocyanate (IPDI). Polyurethanes made of aromatic diisocyanates or aromatic polyisocyanates are referred to as “aromatic polyurethanes.” Similarly, polyurethanes made of aliphatic diisocynates or aliphatic polyisocyanates are referred to as “aliphatic polyurethanes.”

Additional exemplary diisocyanates and polyisocyanates that may be used to make polyurethanes useful in the present application include, but are not limited to, polymeric isocyanate (PMDI), 1,5-naphthalene diisocyanate, biotolylene diisocyanate, 2,4-tolylene diisocyanate and position isomers thereof, 4,4′-diphenylmethane diisocyanate and position isomer thereof, polymethylenepolyphenyl isocyanate, 1,5-naphylene diisocyanate, olymeric diphenylmethane diisocyanate, which is a blend of molecules with two-, three-, and four or more isocyanate groups. Further examples of polyisocyanates may be found in Encyclopedia of Polymer Science and Technology, Mark et al., 1969, incorporated herein by reference.

Polyols that may be used to make polyurethanes in the coating compositions provided herein may be polyester polyols. They are formed by polyesterification of a di-acid, such as adipic acid, with glycols, such as ethylene glycol or dipropylenen glycol. Polyurethane formed with polyester polyols are referred to as “poly(ester urethanes).”

Polyether polyols may also be used to make polyurethanes in the coating compositions provided herein. Polyether polyols are formed by free radical additions of propylene oxide or ethylene oxide onto a hydroxyl or amine containing initiator. Exemplary polyether polyols that may be used to form polyurethanes include polyethylene glycol, polypropylene glycol, and polytetramethylene glycol. Polyurethanes formed with polyether polyols are referred to as “poly(ether urethanes).”

Polyols that may be used to make polyurethanes in the coating compositions provided herein may also be a polycarbonate terminated with hydroxyl groups. The resulting polyurethanes are referred to as “poly(carbonate urethanes).” Exemplary poly(carbonate urethanes) that may be included in the coating compositions provided herein include CHRONOFLEX® AL (aliphatic), CHRONOFLEX® AR (aromatic), CHRONOFLEX® C (aromatic), and BIONATE® (aromatic) 80A, 90A, 55D, and 75D.

Polyols that may be used to make polyurethanes in the coating compositions provided herein may also include di-amines and isocyanates. The resulting polyurethanes include UREA linkages.

Polyurethanes present in the compositions (e.g., coating compositions) provide flexibility and adhesion to catheter. In addition, polyurethanes may be more or less hydrophilic depending on the number of hydrophilic groups contained in the polymer structures. The polyurethanes included in the coating compositions provided herein are water-insoluble, flexible, and compatible with cellulose or cellulose-derived polymers and pyrimidine analogs also present in the coating compositions.

As indicated above, the compositions (e.g., coating compositions) provided herein also comprise cellulose or cellulose-derived polymers. “Cellulose” refers to a carbohydrate, (C₆H₁₀O₅)ₙ, that is composed of glucose units. “Cellulose-derived polymers” refers to chemically altered forms of cellulose, such as cellulose esters, that are water insoluble. Various types of cellulose esters, such as cellulose acetate, cellulose acetate propionate, cellulose acetate butyrate, cellulose acetate phthalate, cellulose xanthate, and cellulose nitrate (also referred to as “nitrocellulose”) may be used in the coating compositions provided herein.

Certain cellulose esters (e.g., cellulose nitrates) are particularly compatible with pyrimidine analogs (e.g., 5-FU). Cellulose esters can impart non-tackiness and cohesiveness to the coatings, and as hydrophobic, water-insoluble polymers, cellulose esters can be highly water resistant. Furthermore, the structure contributes to high degree of stabilization provided to active agents entrapped in cellulose esters. The structure of nitrocellulose is given below:

In certain embodiments, the cellulose ester may be a nitrocellulose. The amount of nitrogen content in cellulose nitrates can vary. Cellulose nitrate (nitrogen content=11.8-12.2%) preferably is used in this invention, although grades of the polymer having lower nitrate concentrations (e.g., 11.3-11.8% or 10.8-11.3%) could be used. Cellulose nitrates are available in viscosities ranging from high viscosity (e.g., 600-1000″; 60-80″; 15-20″; 5-6″), medium viscosity (e.g., ½″; ⅜″; ¼″; 30-35 cps), to low viscosity (e.g., 18-25 cps or 10-15 cps). Lower viscosity grades, such as 3.5, 0.5 or 0.25 seconds, can be used in order to provide favorable rheological properties when combined with the coating solids used in these compositions. Alternatively, higher or lower viscosity grades could be used. At the solids concentrations preferred for use in the practice of the invention, higher viscosity grades can produce coating solutions of such high viscosity, which may cause coating of catheters to become technically challenging. Physical properties such as tensile strength, elongation, flexibility, and softening point are related to viscosity. Viscosity, in turn, depends on the molecular weight of the polymer and can decrease with the lower molecular weight species, especially below the 0.25 second grades.

Representative examples of nitrocellulose polymers include grades A, AM and E nitrocellulose from Dow Wolff Cellulosics, NCC-H130, NCC-H60, NCC-H3040, NCC-H1520, NCC-H0506, NCC-HM005, NCC-H0025, NCC-M0025, and NCC-H0062L nitrocellulose from Darwin Chemical, the ester-soluble types, such as H4, H7, H9, H12, H15, H22.5, H24, H27, H28, H30, and H33 and alcohol soluble types, such as AH15, AH22, AH25, AH27, and AH 28 from Hagedorn, L, H, and M types of nitrocellulose from Shandong Zhiqiang Group Co., and various types of nitrocellulose from Sherman Chemicals Ltd. Nitrocellulose polymers are also available from many other manufacturers and providers.

Additional examples of cellulose esters that may be combined with a pyrimidine analog include cellulose acetate, cellulose acetate propionate, cellulose acetate butyrate, cellulose acetate phthalate, and cellulose xanthate.

As described above, the composition (e.g., a coating composition) comprises, in addition to cellulose or a cellulose-derived polymer, a polyurethane. The presence of both a polyurethane and a cellulose or cellulose-derived polymer facilitates the loading or elution control of a pyrimidine analog in the composition. Cellulose or cellulose-derived polymers in the compositions provided herein are typically hydrophobic, whereas as discussed above, polyurethane in the compositions may be more or less hydrophilic depending on its structure. The ratio of hydrophilic to hydrophobic components in the coating compositions is an important parameter that affects the final properties and release characteristics of the composition (e.g., in form of a coating) on catheters.

For instance, to deliver a sparingly water soluble pyrimidine analog, such as 5-FU, a higher percentage of hydrophobic cellulose or cellulose-derived polymer (i.e., a lower ratio of polyurethane to cellulose or cellulose-derived polymer) may be needed comparing with delivering a water insoluble drug. The higher percentage of hydrophobic cellulose or cellulose-derived polymer prevents the sparingly water soluble pyrimidine analog (i.e., 5-FU) from being released from the composition (e.g., in form of a coating) too quickly if the catheter with such coating is intended to maintain its anti-infective activity for a sustained period of time. Thus, the weight ratio of polyurethane to cellulose or cellulose-derived polymer may be optimized by taking into consideration various factors such as the hydrophobicity of the polyurethane, the hydrophilicity of the pyrimidine analog, the amount of the pyrimidine analog present in the coating composition (e.g., the ratio of the pyrimidine to total polymers), and the period during which a catheter that comprises the composition intended to have its anti-infective activity.

In certain embodiments, the weight ratio of the polyurethane (e.g., a poly(carbonate urethane)) to the cellulose or cellulose-derived polymer (e.g., nitrocellulose) in the composition (e.g., a coating composition) ranges from about 1:10 to about 2:1, such as from 1:9 to 1:1, 1:8 to 1:1, 1:7 to 1:1, 1:6 to 1:1, 1:5 to 1:1, 1:4 to 1:1, 1; 3 to 1:1, 1:2 to 1:1, 1:9 to 1:2, 1:8 to 1:2, 1:7 to 1:2, 1:6 to 1:2, 1:5 to 1:2, 1:4 to 1:2, 1:3 to 1:2, 1:9 to 1:3, 1:8 to 1:3, 1:7 to 1:3, 1:6 to 1:3, 1:5 to 1:3, 1:4 to 1:3, 1:9 to 1:4, 1:8 to 1:4, 1:7 to 1:4, 1:6 to 1:4, 1:5 to 1:4, 1:9 to 1:5, 1:8 to 1:5, 1:7 to 1:5, 1:6 to 1:5, 1:9 to 1:6, 1:8 to 1:6, 1:7 to 1:6, 1:9 to 1:7, 1:8 to 1:7, or 1:9 to 1:8. In certain embodiments, the weight ratio of the polyurethane (e.g., a poly(carbonate urethane)) to the cellulose or cellulose-derived polymer (e.g., nitrocellulose) in the composition (e.g., a coating composition) is about 2:1, 1:1, 1:2, 1:3, 1:4, 1:5, 1:6, 1:7, 1:8, 1:9, or 1:10.

In certain embodiments, the compositions (e.g., coating compositions) may include other polymers to impart certain desirable physical properties, such as to modify hydrophobicity, control elution, and improve flexibility. Exemplary additional polymers include, but are not limited to, hydroxyethyl methacrylate, acrylic HEMA (polyhydroxyethyl methacylate/methylmethacrylate) copolymers, polyvinyl pyrrolidone, polyethylene glycols, and polyethylene oxides.

The composition (e.g., a coating composition) provided herein comprises pyrimidine analogs at a concentration effective in reducing or inhibiting infection associated with the catheter that comprises the composition. Any pyrimidine analog with an anti-infective activity may be used in the coating composition, including those (e.g., 5-FU) described above.

A “concentration effective in reducing or inhibiting infection” refers to a concentration of a pyrimidine analog in a coating composition at which when the composition is applied or incorporated (e.g., coated) onto a catheter, the pyrimidine analog is present on or released at an amount sufficient to statistically significantly reduce or inhibit infection associated with the catheter when inserted into a patient compared with infection associated with the same catheter but without the pyrimidine analog in its coating. Effective concentrations can be maintained from the time of insertion of the catheter to up to a month or more. Whereas change intervals for uncoated catheters (e.g., CVC's) are typically about 3-5 days to minimize the occurrence of catheter-associated infection, in certain embodiments, the present catheters can offer a concentration effective in reducing or inhibiting infection for at least 30 days, thus significantly extending or even eliminating the change interval for the catheter.

“Infection associated with a catheter” or “catheter-related infection” (CRI) refers to infection directly or indirectly caused by the insertion of a catheter into a patient. It includes local infection on the catheter (e.g., bacterial colonization of the outer surface of the catheter, within a surface of the catheter lumen, or the catheter hub due to contamination) and systemic infection resulted from the infection on the catheter. Reduction in colonization by bacteria also may reduce biofilm formation on the implanted catheter, making them less likely to serve as reservoirs for additional infection.

The amount of a pyrimidine analog to be included in the composition (e.g., a coating composition) provided herein may depend on various factors such as the anti-infective activity of the analog, the polymer components in the composition (e.g., a particular polyurethane and cellulose or a particular cellulose-derived polymer), the weight ratio of the polyurethane to the cellulose or cellulose-derived polymer, and the intended use of a catheter that comprises (e.g., coated with) the composition. The amount should be sufficient for the pyrimidine analog to be released from the catheter at concentrations effective in reducing or inhibiting catheter-related infections for the intended period of time, such as for at least 1, 2, 3, 4, 5, 6, 7, 8, 9, 10 days or at least 2, 3, 4, 5, 6, 7, 8, 9, or 10 weeks.

In certain embodiments, the weight ratio of the pyrimidine analog (e.g., 5-FU) to the sum of the polyurethane (e.g., poly(carbonate urethane)) and the cellulose or cellulose-derived polymer (e.g., nitrocellulose) in the composition (e.g., a coating composition) ranges from 2% to 40%, such as 3% to 30%, 4% to 20%, 5% to 25%, 10% to 20%, 15% to 19%, or 10% to 19%, or about 10%, 15%, or 20%. In certain embodiments, the weight ratio of the pyrimidine analog (e.g., 5-FU) to the sum of the polyurethane and the cellulose or cellulose-derived polymer in the coating is below 20%.

In certain embodiments, the composition (e.g., a coating composition) comprises poly(carbonate urethane), nitrocellulose, and 5-FU in which the weight ratio of the poly(carbonate urethane) to the nitrocellulose ranges from 1:2 to 1:4 (e.g., about 1:3), and the weight ratio of 5-FU to the sum of poly(carbonate urethane) and nitrocellulose is below 20% (e.g., about 15%).

In certain embodiments, the composition (e.g., a coating composition) further comprises one or more of the following components: a solvent for the cellulose or cellulose-derived polymer, a solvent for the polyurethane, and a swelling agent. Exemplary solvents for cellulose or cellulose-derived polymers are known in the art, including ketones such as methyl ethyl ketone (MEK). Exemplary solvents for polyurethanes are also known in the art, including amides, such as dimethylacetamide (DMAC), N-methylpyrrolidone (NMP), dimethylsulfoxide (DMSO), tetrahydrofuran (THF), toluene, cyclohexanone, and 2-methyl pentanone (MIEK). Small amounts of a cosolvent, such as isopropyl alcohol, ethanol, n-butyl alcohol also may be used to improve handling of the nitrocellulose and improve solubility of the pyrimidine analog in the coating solution.

A “swelling agent” is an agent having the ability to swell the substrate of a catheter, thereby enabling some of the composition (e.g., a coating composition) to penetrate superficially into the substrate surface and improve adhesion. The choice of swelling agent depends on the composition of the substrate and should generally be chosen to avoid dissolution of the catheter substrate. Such agents are well known in the art and include, for example, ethers such as tetrahydrofuran (THF), DMAC, NMP, toluene, and alcohols. Swelling of polyurethane substrates may be achieved using any of these solvents.

In certain embodiments, the composition (e.g., a coating composition) comprises poly(carbonate urethane), nitrocellulose, 5-FU, and a solvent or mixture of solvents (e.g., DMAC, MEK, and THF). The solvent or solvent mixture is capable of dissolving both the pyrimidine analog and the polymeric components of the formulation and yields a coating that has adequate adhesion to the substrate. In certain exemplary compositions of such embodiments, the weight ratio of the poly(carbonate urethane) to the nitrocellulose ranges from 1:2 to 1:4 (e.g., about 1:3), and the weight ratio of 5-FU to the sum of poly(carbonate urethane) and nitrocellulose ranges from 5% to 25% (e.g., about 15% to about 20%). In the same or different exemplary compositions of the above-noted embodiments, the total weight percentage of the poly(carbonate urethane), the nitrocellulose, and 5-FU in the coating compositions may be from 2% to 20%, such as from 2% to 4%, or from 4% to 10%, about 5%, about 6%, about 7%, or about 8%.

In certain embodiments, the composition (e.g., a coating composition) provided herein may further comprise one or more additional anti-infective agents or other active agents. The anti-infective agents include additional pyrimidine analogs, other chemotherapeutics with anti-infective activities, antibiotics, and anti-fungal agents. Other active agents include antithrombotic agents such as antiplatelet agents, anti-inflammatory agents, immunomodulatory agents and anti-fibrotic agents. Examples of additional anti-infective agents and other active agents are described above.

In certain embodiments, the compositions (e.g., coating compositions) provided herein may further comprise various agents that can impart certain desirable attributes, such as plasticizers (e.g., glycerol and triethyl citrate) to increase the flexibility, colorants such as dyes, hyaluronic acid or PVP to improve lubricity, heparin to enhance biocompatibility or hemocompatability of the coating.

Exemplary compositions (e.g., exemplary coating compositions) are provided below, in which the percentages are weight percentages and an appropriate amount of a solvent or solvent mixture is included in each composition so that the total weight percentage of 5-FU, polyurethane (e.g., poly (carbonate urethane) and cellulose ester (e.g., nitrocellulose), and the solvent or solvent mixture is 100%. Such compositions include: 5-FU—about 0.5%, polyurethane—about 3%, cellulose ester—about 2%; 5-FU—about 0.5%, polyurethane—about 2.5%, cellulose ester—about 2.5%; 5-FU—about 0.5%, polyurethane—about 2%, cellulose ester—about 3%; 5-FU—about 0.5%, polyurethane—about 1.5%, cellulose ester—about 3.5%; 5-FU—about 0.5%, polyurethane—about 1%, cellulose ester—about 4%; and 5-FU—about 0.5%, polyurethane—about 0.5%, cellulose ester—about 4.5%.

Additional exemplary coating compositions include: 5-FU—about 1%, polyurethane—about 3%, cellulose ester—about 1.5%; 5-FU—about 1%, polyurethane—about 2.5%, cellulose ester—about 2%; 5-FU—about 1%, polyurethane—about 2%, cellulose ester—about 2.5%; 5-FU—about 1%, polyurethane—about 1.5%, cellulose ester—about 3%; 5-FU—about 1%, polyurethane—about 1%, cellulose ester—about 3.5%; and 5-FU—about 1%, polyurethane—about 0.5%, cellulose ester—about 4%.

Additional exemplary coating compositions include: 5-FU—about 1.5%, polyurethane—about 2.5%, cellulose ester—about 1.5%; 5-FU—about 1.5%, polyurethane—about 2%, cellulose ester—about 2%; 5-FU—about 1.5%, polyurethane—about 1.5%, cellulose ester—about 2.5%; 5-FU—about 2.5%, polyurethane—about 1%, cellulose ester—about 3%; and 5-FU—about 1.5%, polyurethane—about 0.5%, cellulose ester—about 3.5%.

Additional exemplary coating compositions include: 5-FU—about 0.5%, polyurethane—about 5%, cellulose ester—about 2.5%; 5-FU—about 0.5%, polyurethane—about 4.5%, cellulose ester—about 3%; 5-FU—about 0.5%, polyurethane—about 4%, cellulose ester—about 3.5%; 5-FU—about 0.5%, polyurethane—about 3.5%, cellulose ester—about 4%; 5-FU—about 0.5%, polyurethane—about 3%, cellulose ester—about 4.5%; 5-FU—about 0.5%, polyurethane—about 2.5%, cellulose ester—about 5%; 5-FU—about 0.5%, polyurethane—about 2%, cellulose ester—about 5.5%; 5-FU—about 0.5%, polyurethane—about 1.5%, cellulose ester—about 6%; and 5-FU—about 0.5%, polyurethane—about 1%, cellulose ester—about 6.5%.

Additional exemplary coating compositions include: 5-FU—about 1%, polyurethane—about 4.5%, cellulose ester—about 2.5%; 5-FU—about 1%, polyurethane—about 4%, cellulose ester—about 3%; 5-FU—about 1%, polyurethane—about 3.5%, cellulose ester—about 3.5%; 5-FU—about 1%, polyurethane—about 3%, cellulose ester—about 4%; 5-FU—about 1%, polyurethane—about 2.5%, cellulose ester—about 4.5%; 5-FU—about 1%, polyurethane—about 2%, cellulose ester—about 5%; 5-FU—about 1%, polyurethane—about 1.5%, cellulose ester—about 5.5%; and 5-FU—about 1%, polyurethane—about 1%, cellulose ester—about 6%.

Additional exemplary coating compositions include: 5-FU—about 1.5%, polyurethane—about 4%, cellulose ester—about 2.5%; 5-FU—about 1.5%, polyurethane—about 3.5%, cellulose ester—about 3%; 5-FU—about 1.5%, polyurethane—about 3%, cellulose ester—about 3.5%; 5-FU—about 1.5%, polyurethane—about 2.5%, cellulose ester—about 4%; 5-FU—about 1.5%, polyurethane—about 2%, cellulose ester—about 4.5%; 5-FU—about 1.5%, polyurethane—about 1.5%, cellulose ester—about 5%; and 5-FU—about 1.5%, polyurethane—about 1%, cellulose ester—about 5.5%.

Additional exemplary coating compositions include: 5-FU—about 2%, polyurethane—about 4%, cellulose ester—about 2%; 5-FU—about 2%, polyurethane—about 3.5%, cellulose ester—about 2.5%; 5-FU—about 2%, polyurethane—about 3%, cellulose ester—about 3%; 5-FU—about 2%, polyurethane—about 2.5%, cellulose ester—about 3.5%; 5-FU—about 1.5%, polyurethane—about 2%, cellulose ester—about 4%; 5-FU—about 2%, polyurethane—about 1.5%, cellulose ester—about 4.5%; and 5-FU—about 2%, polyurethane—about 1%, cellulose ester—about 5%.

Additional exemplary coating compositions include: 5-FU—about 0.5%, polyurethane—about 6.5%, cellulose ester—about 3%; 5-FU—about 0.5%, polyurethane—about 6%, cellulose ester—about 3.5%; 5-FU—about 0.5%, polyurethane—about 5.5%, cellulose ester—about 4%; 5-FU—about 0.5%, polyurethane—about 5%, cellulose ester—about 4.5%; 5-FU—about 0.5%, polyurethane—about 4.5%, cellulose ester—about 5%; 5-FU—about 0.5%, polyurethane—about 4%, cellulose ester—about 5.5%; 5-FU—about 0.5%, polyurethane—about 3.5%, cellulose ester—about 6%; 5-FU—about 0.5%, polyurethane—about 3%, cellulose ester—about 6.5%; 5-FU—about 0.5%, polyurethane—about 2.5%, cellulose ester—about 7%; 5-FU—about 0.5%, polyurethane—about 2%, cellulose ester—about 7.5%; and 5-FU—about 0.5%, polyurethane—about 1.5%, cellulose ester—about 8%.

Additional exemplary coating compositions include: 5-FU—about 1%, polyurethane—about 6%, cellulose ester—about 3%; 5-FU—about 1%, polyurethane—about 5.5%, cellulose ester—about 3.5%; 5-FU—about 1%, polyurethane—about 5%, cellulose ester—about 4%; 5-FU—about 1%, polyurethane—about 4.5%, cellulose ester—about 4.5%; 5-FU—about 1%, polyurethane—about 4%, cellulose ester—about 5%; 5-FU—about 1%, polyurethane—about 3.5%, cellulose ester—about 5.5%; 5-FU—about 1%, polyurethane—about 3%, cellulose ester—about 6%; 5-FU—about 1%, polyurethane—about 2.5%, cellulose ester—about 6.5%; 5-FU—about 1%, polyurethane—about 2%, cellulose ester—about 7%; 5-FU—about 1%, polyurethane—about 1.5%, cellulose ester—about 7.5%; and 5-FU—about 1%, polyurethane—about 1%, cellulose ester—about 8%.

Additional exemplary coating compositions include: 5-FU—about 1.5%, polyurethane—about 5.5%, cellulose ester—about 3%; 5-FU—about 1.5%, polyurethane—about 5%, cellulose ester—about 3.5%; 5-FU—about 1.5%, polyurethane—about 4.5%, cellulose ester—about 4%; 5-FU—about 1.5%, polyurethane—about 4%, cellulose ester—about 4.5%; 5-FU—about 1.5%, polyurethane—about 3.5%, cellulose ester—about 5%; 5-FU—about 1.5%, polyurethane—about 3%, cellulose ester—about 5.5%; 5-FU—about 1.5%, polyurethane—about 2.5%, cellulose ester—about 6%; 5-FU—about 1.5%, polyurethane—about 2%, cellulose ester—about 6.5%; 5-FU—about 1.5%, polyurethane—about 1.5%, cellulose ester—about 7%; and 5-FU—about 1.5%, polyurethane—about 1%, cellulose ester—about 7.5%.

Additional exemplary coating compositions include: 5-FU—about 2%, polyurethane—about 5%, cellulose ester—about 3%; 5-FU—about 2%, polyurethane—about 4.5%, cellulose ester—about 3.5%; 5-FU—about 2%, polyurethane—about 4%, cellulose ester—about 4%; 5-FU—about 2%, polyurethane—about 3.5%, cellulose ester—about 4.5%; 5-FU—about 1.5%, polyurethane—about 3%, cellulose ester—about 5%; 5-FU—about 2%, polyurethane—about 2.5%, cellulose ester—about 5.5%; 5-FU—about 2%, polyurethane—about 2%, cellulose ester—about 6%; 5-FU—about 2%, polyurethane—about 1.5%, cellulose ester—about 6.5%; and 5-FU—about 2%, polyurethane—about 1%, cellulose ester—about 7%.

Additional exemplary coating compositions include: 5-FU—about 0.55% to about 0.8%, poly(carbonate urethane)—about 0.9% to about 1.3%, nitrocellulose—about 1.8% to about 2.5%.

Provided below are exemplary solvent mixtures that may be used in the coating compositions provided herein, especially the exemplary coating composition provided in the above 11 paragraphs. The percentage of a particular solvent (e.g., DMAC) provided for each exemplary solvent mixture below is the weight percentage of the particular component in the solvent mixture so that the total weight percentage of all the solvents (e.g., DMAC, MEK and THF) in the mixture is 100%.

Exemplary solvent mixtures include: DMAC—about 2%, MEK—about 58%, THF—about 40%; DMAC—about 4%, MEK—about 56%, THF—about 40%; DMAC—about 6%, MEK—about 54%, THF—about 40%; DMAC—about 8%, MEK—about 52%, THF—about 40%; DMAC—about 10%, MEK—about 50%, THF—about 40%; DMAC—about 12%, MEK—about 48%, THF—about 40%; DMAC—about 14%, MEK—about 46%, THF—about 40%; DMAC—about 16%, MEK—about 44%, THF—about 40%; DMAC—about 18%, MEK—about 42%, THF—about 40%; DMAC—about 20%, MEK—about 40%, THF—about 40%; DMAC—about 21%, MEK—about 39%, THF—about 40%; DMAC—about 23%, MEK—about 37%, THF—about 40%; and DMAC—about 25%, MEK—about 35%, THF—about 40%.

Additional exemplary solvent mixtures include: DMAC—about 2%, MEK—about 53%, THF—about 45%; DMAC—about 4%, MEK—about 51%, THF—about 45%; DMAC—about 6%, MEK—about 49%, THF—about 45%; DMAC—about 8%, MEK—about 47%, THF—about 45%; DMAC—about 10%, MEK—about 45%, THF—about 45%; DMAC—about 12%, MEK—about 43%, THF—about 45%; DMAC—about 14%, MEK—about 41%, THF—about 45%; DMAC—about 16%, MEK—about 39%, THF—about 45%; DMAC—about 18%, MEK—about 37%, THF—about 45%; DMAC—about 20%, MEK—about 35%, THF—about 45%; DMAC—about 21%, MEK—about 34%, THF—about 45%; DMAC—about 23%, MEK—about 32%, THF—about 45%; and DMAC—about 25%, MEK—about 30%, THF—about 45%.

Additional exemplary solvent mixtures include: DMAC—about 2%, MEK—about 48%, THF—about 50%; DMAC—about 4%, MEK—about 46%, THF—about 50%; DMAC—about 6%, MEK—about 44%, THF—about 40%; DMAC—about 8%, MEK—about 42%, THF—about 50%; DMAC—about 10%, MEK—about 40%, THF—about 50%; DMAC—about 12%, MEK—about 38%, THF—about 50%; DMAC—about 14%, MEK—about 36%, THF—about 50%; DMAC—about 16%, MEK—about 34%, THF—about 50%; DMAC—about 18%, MEK—about 32%, THF—about 50%; DMAC—about 20%, MEK—about 30%, THF—about 50%; DMAC—about 21%, MEK—about 29%, THF—about 50%; DMAC—about 23%, MEK—about 27%, THF—about 50%; and DMAC—about 25%, MEK—about 25%, THF—about 50%.

Additional exemplary solvent mixtures include: DMAC—about 2%, MEK—about 43%, THF—about 55%; DMAC—about 4%, MEK—about 41%, THF—about 55%; DMAC—about 6%, MEK—about 39%, THF—about 55%; DMAC—about 8%, MEK—about 37%, THF—about 55%; DMAC—about 10%, MEK—about 35%, THF—about 55%; DMAC—about 12%, MEK—about 33%, THF—about 55%; DMAC—about 14%, MEK—about 31%, THF—about 55%; DMAC—about 16%, MEK—about 29%, THF—about 55%; DMAC—about 18%, MEK—about 27%, THF—about 55%; DMAC—about 20%, MEK—about 25%, THF—about 55%; DMAC—about 21%, MEK—about 24%, THF—about 55%; DMAC—about 23%, MEK—about 22%, THF—about 55%; and DMAC—about 25%, MEK—about 20%, THF—about 55%.

Additional exemplary solvent mixtures include: DMAC—about 2%, MEK—about 38%, THF—about 60%; DMAC—about 4%, MEK—about 36%, THF—about 60%; DMAC—about 6%, MEK—about 34%, THF—about 60%; DMAC—about 8%, MEK—about 32%, THF—about 60%; DMAC—about 10%, MEK—about 30%, THF—about 60%; DMAC—about 12%, MEK—about 28%, THF—about 60%; DMAC—about 14%, MEK—about 26%, THF—about 60%; DMAC—about 16%, MEK—about 24%, THF—about 60%; DMAC—about 18%, MEK—about 22%, THF—about 60%; DMAC—about 20%, MEK—about 20%, THF—about 60%; DMAC—about 21%, MEK—about 19%, THF—about 60%; DMAC—about 23%, MEK—about 17%, THF—about 60%; and DMAC—about 25%, MEK—about 15%, THF—about 60%.

Each of the above exemplary solvent mixtures may be used in any one of the coating compositions that comprise 5-FU, polyurethane, and cellulose ester (e.g., nitrocellulose) provided above. For example, a coating composition that comprises about 1.5% 5-FU, about 2% polyurethane, and 2% of cellulose ester (e.g., nitrocellulose) may comprise 94.5% of any one of the following solvent mixtures: DMAC—about 2%, MEK—about 58%, THF—about 40%; DMAC—about 4%, MEK—about 56%, THF—about 40%; DMAC—about 6%, MEK—about 54%, THF—about 40%; DMAC—about 8%, MEK—about 52%, THF—about 40%; DMAC—about 10%, MEK—about 50%, THF—about 40%; DMAC—about 12%, MEK—about 48%, THF—about 40%; DMAC—about 14%, MEK—about 46%, THF—about 40%; DMAC—about 16%, MEK—about 44%, THF—about 40%; DMAC—about 18%, MEK—about 42%, THF—about 40%; DMAC—about 20%, MEK—about 40%, THF—about 40%; DMAC—about 21%, MEK—about 39%, THF—about 40%; DMAC—about 23%, MEK—about 37%, THF—about 40%; and DMAC—about 25%, MEK—about 35%, THF—about 40%.

As an additional example, a coating composition that comprises about 0.5% 5-FU, about 2% polyurethane, and 5.5% of cellulose ester (e.g., nitrocellulose) may comprise 92% of any one of the following solvent mixtures: DMAC—about 2%, MEK—about 53%, THF—about 45%; DMAC—about 4%, MEK—about 51%, THF—about 45%; DMAC—about 6%, MEK—about 49%, THF—about 45%; DMAC—about 8%, MEK—about 47%, THF—about 45%; DMAC—about 10%, MEK—about 45%, THF—about 45%; DMAC—about 12%, MEK—about 43%, THF—about 45%; DMAC—about 14%, MEK—about 41%, THF—about 45%; DMAC—about 16%, MEK—about 39%, THF—about 45%; DMAC—about 18%, MEK—about 37%, THF—about 45%; DMAC—about 20%, MEK—about 35%, THF—about 45%; DMAC—about 21%, MEK—about 34%, THF—about 45%; DMAC—about 23%, MEK—about 32%, THF—about 45%; and DMAC—about 25%, MEK—about 30%, THF—about 45%.

As another example, a coating composition that comprises about 1% 5-FU, about 2% polyurethane, and 5% of cellulose ester (e.g., nitrocellulose) may comprise 92% of any one of the following solvent mixtures: DMAC—about 2%, MEK—about 48%, THF—about 50%; DMAC—about 4%, MEK—about 46%, THF—about 50%; DMAC—about 6%, MEK—about 44%, THF—about 40%; DMAC—about 8%, MEK—about 42%, THF—about 50%; DMAC—about 10%, MEK—about 40%, THF—about 50%; DMAC—about 12%, MEK—about 38%, THF—about 50%; DMAC—about 14%, MEK—about 36%, THF—about 50%; DMAC—about 16%, MEK—about 34%, THF—about 50%; DMAC—about 18%, MEK—about 32%, THF—about 50%; DMAC—about 20%, MEK—about 30%, THF—about 50%; DMAC—about 21%, MEK—about 29%, THF—about 50%; DMAC—about 23%, MEK—about 27%, THF—about 50%; and DMAC—about 25%, MEK—about 25%, THF—about 50%.

As another example, a coating composition that comprises about 0.5% 5-FU, about 3% polyurethane, and 6.5% of cellulose ester (e.g., nitrocellulose) may comprise 90% of any one of the following solvent mixtures: DMAC—about 2%, MEK—about 43%, THF—about 55%; DMAC—about 4%, MEK—about 41%, THF—about 55%; DMAC—about 6%, MEK—about 39%, THF—about 55%; DMAC—about 8%, MEK—about 37%, THF—about 55%; DMAC—about 10%, MEK—about 35%, THF—about 55%; DMAC—about 12%, MEK—about 33%, THF—about 55%; DMAC—about 14%, MEK—about 31%, THF—about 55%; DMAC—about 16%, MEK—about 29%, THF—about 55%; DMAC—about 18%, MEK—about 27%, THF—about 55%; DMAC—about 20%, MEK—about 25%, THF—about 55%; DMAC—about 21%, MEK—about 24%, THF—about 55%; DMAC—about 23%, MEK—about 22%, THF—about 55%; and DMAC—about 25%, MEK—about 20%, THF—about 55%.

As a further example, a coating composition that comprises about 1% 5-FU, about 2.5% polyurethane, and 6.5% of cellulose ester (e.g., nitrocellulose) may comprise 90% of any one of the following solvent mixtures: DMAC—about 2%, MEK—about 38%, THF—about 60%; DMAC—about 4%, MEK—about 36%, THF—about 60%; DMAC—about 6%, MEK—about 34%, THF—about 60%; DMAC—about 8%, MEK—about 32%, THF—about 60%; DMAC—about 10%, MEK—about 30%, THF—about 60%; DMAC—about 12%, MEK—about 28%, THF—about 60%; DMAC—about 14%, MEK—about 26%, THF—about 60%; DMAC—about 16%, MEK—about 24%, THF—about 60%; DMAC—about 18%, MEK—about 22%, THF—about 60%; DMAC—about 20%, MEK—about 20%, THF—about 60%; DMAC—about 21%, MEK—about 19%, THF—about 60%; DMAC—about 23%, MEK—about 17%, THF—about 60%; and DMAC—about 25%, MEK—about 15%, THF—about 60%.

### Methods for Preparing Anti-Infective Compositions

The anti-infective composition (e.g., anti-infective coating compositions) may be prepared by combining appropriate amounts of individual components (e.g., a polyurethane, cellulose or a cellulose-derived polymer, and a pyrimidine) together.

In certain embodiments, the compositions (e.g., coating compositions) are coating solutions. Such solutions may be prepared by dissolving the polymer components (e.g., polyurethanes and cellulose or cellulose-derived polymers) and pyrimidine analogs in solvent mixtures. Alternatively, they may be prepared by dissolving the polymer components in solvent mixtures followed by adding pyrimidine analogs. In certain embodiments, pyrimidine analogs may be added to solvent mixtures before the polymer components. It is also possible to dissolve individual polymer components separately in solutions and combine separate solutions of the individual polymers. Pyrimidine analogs may be subsequently added to the combined solutions. In certain other embodiments, one polymer component (e.g., a polyurethane) and a pyrimidine analog may be dissolved in a solvent or solvent mixture and then combined with a solution or solid of the other polymer component(s).

In certain embodiments wherein one or more active agents other than pyrimidine analogs are included in the compositions (e.g., coating compositions), they may be dissolved separately and then combined with a solution or solutions containing the other components. Alternatively, they may be dissolved in a solvent or solvent mixture comprising one or more other components and combining with a solution that comprises the remaining component(s) of the composition. It is also possible to dissolve the additional active agent(s) in a solvent or solvent mixture that comprise all the other component(s) of the composition.

### Anti-Infective Devices

In one aspect, an anti-infective device is provided. Such a device comprises a catheter and a composition (e.g., in form of a coating) on the catheter, wherein the composition comprises a polyurethane, a cellulose or cellulose-derived polymer, and a pyrimidine analog; the weight ratio of the polyurethane to the cellulose or cellulose-derived polymer in the composition ranges from 1:10 to 1:2; and the pyrimidine analog is in an amount effective in reducing or inhibiting infection associated with the catheter.

An “anti-infective device” refers to a device that comprises an anti-infective agent (e.g., a pyrimidine analog) at an amount effective in reducing or inhibiting infection associated with the device when inserted or implanted into a patient so that infection is statistically significantly reduced compared with the same device but without the anti-infective agent.

A “catheter” refers to a device comprising a hollow flexible tube (i.e., “catheter shaft”) for insertion into a body cavity, duct or vessel (e.g., blood vessel) to allow passage of any type of fluid (e.g., water saline, blood, therapeutic compositions, nourishment, water products including bile and urine) from or into the body cavity, duct or vessel, to distend a passageway, or to conduct impulses for monitoring equipment. Catheters may be indwelling devices that can reside within a patient for days, weeks, or months. Exemplary uses of catheters include vascular access (e.g., insertion through a blood vessel into the heart for diagnostic purposes), tissue removal (e.g., biopsy), fluid drainage (e.g., the drainage of urine form the bladder through the urethra) and infusion therapy (e.g., fluid or drug delivery, such as delivery of antibiotics, chemotherapy, and/or nourishment). The term “catheter” is used interchangeably with “conduit,” “tube,” “shunt,” “tubing,” or the like.

Catheters that may be coated with or otherwise comprise a composition that comprises a pyrimidine analog according to the present invention on the catheters include, but are not limited to, acorn-tipped catheters, angiography catheters, balloon catheters, balloon-tip catheters, bicoudate catheters, Bozeman-Fritsch catheters, Braasch catheters, Broviac catheters, brush catheters, cardiac catheters, central venous catheters, conical catheters, catheters coudé, catheters à demeure, de Pezzer catheters, double-channel catheters, elbowed catheters, Eustachian catheters, female catheters, Fogarty embolectomy catheters, Foley catheters, Gouley catheters, Hickman catheters, indwelling catheters, intracardiac catheters, Malecot catheters, Nélaton catheters, olive-tipped catheters, pacing catheters, Pezzer catheters, Phillips catheters, pigtail catheters, prostatic catheters, pulmonary artery catheters, Robinson catheters, self-retaining catheters, spiral tip catheters, Swan-Ganz catheters, two-way catheters, vertebrated catheters, whistle-tip catheters, and winged catheters. The above types of catheters are well known in the art and defined in Stedman's Medical Dictionary, 27^{th} Edition, Lippincott Williams & Wilkins, 2000.

Additional representative examples of catheters that may be coated with or otherwise comprise a composition that comprises a pyrimidine analog according to the present invention on the catheters include implantable venous catheters, tunneled venous catheters, coronary catheters useful for angiography, angioplasty, or ultrasound procedures in the heart or in peripheral veins and arteries, chronic infusion lines, hepatic artery infusion catheters, central venous catheters (see, e.g., U.S. Pat. Nos. 3,995,623, 4,072,146 4,096,860, 4,099,528, 4,134,402, 4,180,068, 4,385,631, 4,406,656, 4,568,329, 4,960,409, 5,176,661, 5,916,208), peripheral intravenous catheters, peripherally inserted central venous catheters (PIC lines), flow-directed balloon-tipped pulmonary artery catheters, arterial lines, total parenteral nutrition catheters, devices for continuous subarachnoid infusions, chronic dwelling catheters (e.g., chronic dwelling gastrointestinal catheters and chronic dwelling genitourinary catheters), feeding tubes, peritoneal dialysis catheters, hemodialysis catheters, CNS shunts (e.g., a ventriculopleural shunt, a VA shunt, or a VP shunt), ventricular peritoneal shunts, ventricular atrial shunts, portosystemic shunts, shunts for ascites, and urinary catheters (see, e.g. U.S. Pat. Nos. 2,819,718, 4,227,533, 4,284,459, 4,335,723, 4,701,162, 4,571,241, 4,710,169, and 5,300,022).

Additional exemplary catheters that may be coated with or otherwise comprise a composition that comprises a pyrimidine analog according to the present invention on the catheters include SKATER® drainage catheters for percutaneous fluid collection drainage procedures, such as SKATER® biliary catheters, SKATER® nephrostomy catheter, SKATER® single step catheters; GOLDEN-RULE™ scaling catheters for delivering radiopaque media to selected sites in the vascular system and anatomical measurements in conjunction with routine diagnostic procedures; HEMOSTREAM™ independent triple-lumen dialysis catheters, and HSG catheters for use in the injection of contrast material in the examination of the uterus and fallopian tubes. These exemplary catheters are available from Angiotech.

Further exemplary catheters that may be coated with or otherwise comprise a composition that comprises a pyrimidine analog according to the present invention on the catheters include those discussed in the Methods of Using Anti-Infective Devices section below.

The catheters may have one lumen or multiple lumens, depending on the application. In certain embodiments, the catheters may be double-lumen catheters (e.g., hemodialysis catheters) or triple-lumen catheters (e.g., central venous catheters). In other embodiments, the catheters may have 4 or 5 lumens.

In certain embodiments, the catheter does not include an expandable portion such as a balloon. In other embodiments, the catheter is not a transient delivery vehicle that is intended to be removed shortly after to delivery of a drug or balloon or the like (e.g., within an hour or less after insertion).

In certain embodiments, the catheter further comprises a cuff that locates at the junction where the catheter exits the skin. In certain embodiments, the catheter further comprises a catheter hub. In certain embodiments, the catheter may be positioned in the body via a trocar. In certain embodiments, the catheter is to be placed under the skin and referred to as a “tunneled catheter.”

In certain embodiments, the catheter is a chronic indwelling catheter intended to be inserted and stay inside a patient for an extended period of time, such as at least for 1, 2, 3, 4, 5, or 6 days, 1, 2, 3, or 4 weeks, or 1, 2, 3, 4, 5, 6, 7, 8, 9, 10, 11, or 12 months.

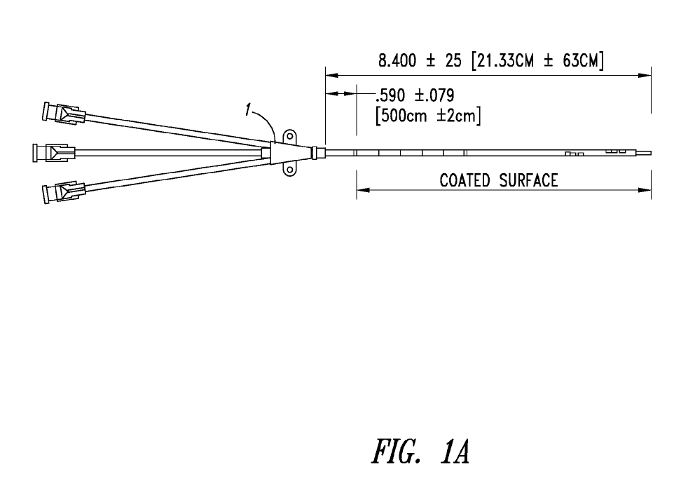

In certain embodiments, an anti-infective central venous catheter is provided. In an embodiment, the anti-infective central venous catheter is a three lumen (triple lumen) catheter. An exemplary three lumen central venous catheter is a 7-French×20 cm, triple lumen (16/18/18 gauge) ID, 0.092±0.002″ OD, which is shown in FIGS. 1A (side view) and 1B (vertical section view). The lumens of a multi-lumen central venous catheter can serve various uses, such as for fluid delivery (e.g., infusion), delivery of medication (antibiotics, chemotherapeutic agents), TPN parental nutrition, blood sampling or monitoring, and to measure central venous blood pressure. Another exemplary three lumen central venous catheter is a 7-French×15 cm with triple lumen (16/18/18 gauge) ID, 0.092±0.002″ OD.

In certain embodiments, an anti-infective hemodialysis catheter is provided. In an embodiment, the anti-infective hemodialysis catheter is a two lumen catheter. In another embodiment, the anti-infective hemodialysis catheter is a three lumen catheter. The catheter of these embodiments may or may not further comprise a cuff, and may or may not be delivered using a trocar.

A “coating,” as used herein, refers to a composition that (1) adheres to the surface of at least a portion of a catheter (such as the exterior surface (i.e., non-luminal surface), the interior surface (i.e., luminal surface), or both surfaces, of a portion of a catheter, and (2) comprises at least one component different from the material(s) that form the catheter.

In certain embodiments, the coating is a layer on a catheter that is of substantially uniform thickness. A layer is “of substantially uniform thickness” if the thickness at any position of the layer is between 50% and 150% of the average thickness of the layer. In certain embodiments, the thickness at any position of the layer is between 70% and 130%, such as between 80% and 120% or between 90% and 100%

In certain other embodiments, the coating adheres to multiple non-continuous areas of the surface of a catheter. Such a coating is referred to as “spot coating.”

In certain other embodiments, the catheter contains a plurality of reservoirs, and the composition that comprises at least one component different from the material(s) that form the catheter adheres to the surface of the plurality of reservoirs. Such a coating is referred to as “well coating” or “pit coating.” The reservoirs may be on the exterior surface of the catheter, the interior surface of the catheter or on both surfaces. The reservoirs may be formed from divets or voids in the catheter surface or from micropores or channels in the catheter body.

In certain embodiments, a coating partially covers the exterior surface of the portion of the catheter that will be in contact with a patient when the catheter is inserted or implanted into the patient. In certain other embodiments, a coating completely covers the exterior surface of portion of the catheter that will be in contact with a patient when the catheter is inserted or implanted into the patient.

In certain embodiments, a catheter is only coated by a pyrimidine analog-containing polymeric coating on its exterior (non-luminal) surface (either partially or completely of the portion of the catheter that will be in contact with a patient when the catheter is inserted or implanted into the patient). In certain other embodiments, a catheter is only coated by a pyrimidine analog-containing polymeric coating on its interior (luminal) surface (either partially or completely of the portion of the catheter that will be in contact with a patient when the catheter is inserted or implanted into the patient). In yet other embodiments, a catheter is coated by a pyrimidine analog-containing polymeric coating on both its exterior and interior surfaces (either partially or completely of the portion of the catheter that will be in contact with a patient when the catheter is inserted or implanted into the patient).

For instance, in certain embodiments, 7-French 15 cm or 20 cm three lumen central venous catheter as described above may be coated on its exterior surface only from a nominal distance (e.g., 0.1 cm) from the hub to the distal tip.

In certain embodiments where the catheter (e.g., a hemodialysis catheter) further comprises a cuff that will locate at the junction where the catheter exits the skin, the cuff may or may not be applied or incorporated (e.g., coated) with a pyrimidine analog-containing polymeric composition (i.e., a composition that comprises a polyurethane, cellulose or a cellulose-derived polymer and a pyrimidine analog) provided herein. In certain embodiments where the catheter (e.g., a hemodialysis catheter) further comprises a hub, the hub may or may not be applied or incorporated (e.g., coated) with a pyrimidine analog-containing polymeric composition provided herein. In certain embodiments where the catheter is positioned in the body via a trocar, the trocar may or may not be coated with a pyrimidine analog-containing polymeric composition provided herein.

Any of the compositions (e.g., coating compositions) described herein may be used in combination with any of the catheters described herein to provide the anti-infective devices according to the present invention.

In certain embodiments, the polyurethane in the composition (e.g., in form of a coating) on the catheter is a poly(carbonate urethane), poly(ester urethane), or poly(ether urethane).

In certain embodiments, the cellulose-derived polymer is nitrocellulose, cellulose acetate butyrate, or cellulose acetate propionate.

The anti-infective catheter provided herein comprises a pyrimidine analog (e.g., a fluoropyrimidine such as 5-FU) in an amount effective in reducing or inhibiting infection associated with the catheter.

An “amount effective in reducing or inhibiting infection” refers to an amount of an anti-infective agent when used in combination with a device (e.g., as a coating of the device) that is sufficient in statistically significantly reducing infection associated with the device when inserted into a patient with the same device but without the anti-infective agent. Such an amount may be determined using methods known in the relevant art, including those described in the examples provided below.

“Infection associated with a catheter” or “catheter-related infection” (CRI) refers to infection directly or indirectly caused by the insertion of a catheter into a patient. It includes infection on or around the catheter and systemic infection resulted from the infection on the catheter.

In certain embodiments, the pyrimidine analog is released from the composition (e.g., in form of a coating) on the anti-infective catheter at an amount effective in reducing or inhibiting infection associated with the catheter for an extended period of time, such as at least for 1, 2, 3, 4, 5, or 6 days, 1, 2, 3, or 4 weeks, 1, 2, 3, 4, 5, 6, 7, 8, 9, 10, 11, or 12 months. In certain embodiments, the release of the pyrimidine analog starts upon the implantation of the anti-infective catheter into a patient. In certain other embodiments, there is a delay before the pyrimidine analog starts to release from the anti-infective catheter.

In certain embodiments, the pyrimidine analog is released from the composition (e.g., in form of a coating) during the entire residence time of the catheter within the patient. For example, for a central venous catheter that may remain implanted for up to about 30 days and for a hemodialysis catheter that may remain implanted for 6 to 12 months, the pyrimidine analog releases from the catheter beginning after implantation up until removal of the catheter from the patient. In other embodiments, the pyrimidine analog is not released (e.g., does not dissociate) from the catheter but is present on the surface of the catheter in an amount effective in reducing or inhibiting infection for an extended period of time, such as at least for 1, 2, 3, 4, 5, or 6 days, 1, 2, 3, or 4 weeks, or 1, 2, 3, 4, 5, or 6 months.

In certain embodiments, the average thickness of the coating ranges form 0.5 μm to 10 μm. In certain embodiments, the average thickness of the coating is about 3-6 μm. In certain embodiments, the average thickness of the coating is about 5 μm.

In certain embodiments, the weight ratio (i.e., w/w) of the polyurethane to the cellulose or cellulose-derived polymer in the composition (e.g., in form of a coating) ranges from 1:2 to 1:4. In certain embodiments, the weight ratio of the polyurethane to the cellulose or cellulose-derived polymer in the composition is about 1:3.

In certain embodiments, the weight ratio of the pyrimidine analog (e.g., 5-FU) to the sum of the polyurethane (e.g., poly(carbonate urethane)) and the cellulose or cellulose-derived polymer (e.g., nitrocellulose) in the composition (e.g., in form of a coating) may range from 2% to 40%, such as 5% to 25%, 10% to 20%, or 15% to 19%. In certain embodiments, the weight ratio of the pyrimidine analog to the sum of the polyurethane and the cellulose or cellulose-derived polymer in the composition is about 15% or about 20%. In certain embodiments, the weight ratio of the pyrimidine analog to the sum of the polyurethane and the cellulose or cellulose-derived polymer in the composition is below 20%.

The amount of pyrimidine analog is chosen to achieve the desired level of infection control with negligible systemic exposure. In other words, the amount of pyrimidine analog must be high enough to prevent bacterial infection, such as bacterial growth, in or around the catheter, but low enough not to damage cells in the vicinity or in contact with the catheter, or cause systemic adverse effects on the host. For example, in certain embodiments, when a vascular catheter that comprises a pyrimidine analog is implanted into a blood vessel, the plasma concentration of the pyrimidine analog is less than 500 ng/ml, 100 ng/ml, 50 ng/ml, 10 ng/ml, 5 ng/ml, or 1 ng/ml. In certain embodiments, when a vascular catheter that comprises a pyrimidine analog is implanted into a blood vessel, the pyrimidine analog does not cross the blood vessel wall and infiltrate to the surrounding tissue at a detectable concentration (e.g., 1 ng/ml or higher).

In certain embodiments, the pyrimidine analog (e.g., 5-FU) is present at 0.1 μg to 1 mg per cm², such as at 0.1 μg to 1 μg per cm², 1 μg to 10 μg per cm², 10 μg to 100 μg per cm² (e.g., at about 20, 30, 40, 50, 60, 70, 80, or 90 μg per cm²), 100 μg to 1 mg per cm², 0.1 μg to 10 μg per cm², 10 μg to 1 mg per cm², 1 μg to 100 μg per cm², of the surface area of the anti-infective catheter to which a composition that comprises the pyrimidine analog, a polyurethane, and cellulose or a cellulose-derived polymer is applied or incorporated (e.g., the surface area of the anti-infective coated with the composition). In certain embodiments, inhibition of infection (e.g., bacterial colonization) of certain types of catheters (e.g., vascular access catheters) may be achieved by incorporation of a fluoropyrimidine (e.g., 5-FU) in the amount of about 40-100 μg per cm² of coated surface area of the anti-infective catheter.

In certain embodiments, the pyrimidine analog (e.g., 5-FU) is present, in terms of weight per linear cm of device, at 0.1 μg to 1 mg per linear cm of catheter length to which a composition that comprises the pyrimidine analog, a polyurethane, and cellulose or a cellulose-derived polymer is applied or incorporated (e.g., the surface area of the anti-infective coated with the composition), such as at 0.1 μg to 1 μg per cm, 1 μg to 10 μg per cm, 10 μg to 100 μg per cm (e.g., about 20, 30, 40, 50, 60, 70, 80, or 90 μg per cm), 100 μg to 1 mg per cm, 0.1 μg to 10 μg per cm, 10 μg to 1 mg per cm, 1 μg to 100 μg per cm, of catheter length of the anti-infective catheter to which the pyrimidine analog-containing polymeric composition is applied or incorporated. In certain embodiments, inhibition of infection (e.g., bacterial colonization) of certain types of catheters (e.g., vascular access catheters) may be achieved by incorporation of a fluoropyrimidine (e.g., 5-FU) in an amount of about 10 μg to 25 μg, about 25 μg to about 75 μg, about 75 μg to about 100 μg, about 10 μg to about 40 μg, about 40 μg to about 60 μg, about 60 μg to about 100 μg, about 10 μg to 45 μg, about 45 μg to about 55 μg, or about 55 μg to about 100 μg, per linear cm of catheter length to which the pyrimidine analog-containing polymeric composition is applied or incorporated. In certain embodiments, the pyrimidine analog (e.g., 5-FU) is present, in terms of weight per linear cm of device (HemoStream chronic dialysis catheter), at 0.1 μg to 1 mg per linear cm of catheter length to which a composition that comprises the pyrimidine analog, a polyurethane, and cellulose or a cellulose-derived polymer is applied or incorporated (e.g., the surface area of the anti-infective coated with the composition), such as at 0.1 μg to 1 μg per cm, 1 μg to 10 μg per cm, 10 μg to 100 μg per cm (e.g., about 20, 30, 40, 50, 60, 70, 80, or 90 μg per cm), 100 μg to 1 mg per cm, 0.1 μg to 10 μg per cm, 10 μg to 1 mg per cm, 1 μg to 100 μg per cm, of catheter length of the anti-infective catheter to which the pyrimidine analog-containing polymeric composition is applied or incorporated. In certain embodiments, inhibition of infection (e.g., bacterial colonization) of certain types of catheters (e.g., hemodialysis catheters) may be achieved by incorporation of a fluoropyrimidine (e.g., 5-FU) in an amount of about 10 μg to 50 μg, about 50 μg to about 150 μg, about 150 μg to about 200 μg, about 10 μg to about 75 μg, about 75 μg to about 125 μg, about 125 μg to about 200 μg, about 10 μg to 100 μg, about 100 μg to about 120 μg, or about 120 μg to about 200 μg, per linear cm of catheter length to which the pyrimidine analog-containing polymeric composition is applied or incorporated.

In certain embodiments, the anti-infective catheter comprises 1 μg to 250 mg, such as 1 μg to 10 μg, 10 μg to 100 μg, 100 μg to 1 mg, 1 mg to 10 mg, 10 mg to 100 mg, 100 mg to 250 mg, 1 μg to 100 μg, 100 μg to 10 mg, or mg to 250 mg, of a pyrimidine analog (e.g., 5-FU). In certain embodiments, the anti-infective catheter comprises about 0.2, 0.4, 0.6, 0.8, 1, 2, 3, 4, 5, 6, 7, 8, 9, or 10 mg of a pyrimidine analog (e.g., 5-FU). In certain embodiments, anti-infective catheters (e.g., a vascular access catheter such as a CVC) are provided that comprise a total dose of about 0.1 mg to about 0.5 mg, about 0.5 mg to about 1.5 mg, about 1.5 mg to about 10 mg, about 0.1 mg to about 0.75 mg, or about 0.75 mg to 1.5 mg, of a fluoropyrimidine (e.g., 5-FU). In certain embodiments, anti-infective catheters (e.g., a hemodialysis catheter) are provided that comprise a total dose of about 0.1 mg to about 1.0 mg, about 1.0 mg to about 5.0 mg, about 5.0 mg to about 10 mg, about 0.1 mg to about 1.5 mg, or about 1.5 mg to 4.0 mg, of a fluoropyrimidine (e.g., 5-FU).

In certain embodiments, the anti-infective catheter (e.g., a urinary catheter such as Foley) comprises 1 μg to 250 mg, such as 1 μg to 10 μg, 10 μg to 100 μg, 100 μg to 1 mg, 1 mg to 10 mg, 10 mg to 100 mg, 100 mg to 250 mg, 1 μg to 100 μg, 100 μg to 10 mg, or 10 mg to 250 mg, of pyrimidine analogs (e.g., 5-FU plus floxuridine).

In certain embodiments, the anti-infective catheter comprises 1 μg to 250 mg, such as 1 μg to 10 μg, 10 μg to 100 μg, 100 μg to 1 mg, 1 mg to 10 mg, 10 mg to 100 mg, 100 mg to 250 mg, 1 μg to 100 μg, 100 μg to 10 mg, or mg to 250 mg, of a pyrimidine analog (e.g., 5-FU). In certain embodiments, the anti-infective catheter comprises about 0.2, 0.4, 0.6, 0.8, 1, 2, 3, 4, 5, 6, 7, 8, 9, or 10 mg of a pyrimidine analog (e.g., 5-FU). In certain embodiments, anti-infective catheters (e.g., a vascular access catheter such as a CVC) are provided that comprise a total dose of about 0.1 mg to about 0.5 mg, about 0.5 mg to about 1.5 mg, about 1.5 mg to about 10 mg, about 0.1 mg to about 0.75 mg, or about 0.75 mg to 1.5 mg, of a fluoropyrimidine (e.g., 5-FU).

Any pyrimidine analog described above may be used (e.g., for coating on a catheter) to provide the anti-infective device according to the present invention. In certain embodiments, the pyrimidine analog is a fluoropyrimidine such as 5-fluorouracil or floxuridine.

In certain embodiments, the composition (e.g., in form of a coating) may further comprise one or more secondary anti-infective agents, one or more other active agents (e.g., antithrombotic agents), or combinations thereof. Any of the secondary anti-infective agents or other active agents described above may be used in combination of a pyrimidine analog in a coating on a catheter according to the present invention.

In certain embodiments, a catheter may have a composition that comprises a polyurethane, cellulose or a cellulose-derived polymer, and a pyrimidine analog on a portion of its surface (e.g., in form of a coating), and have a composition that comprises another active agent (e.g. an antithromobotic agent) on a different portion of its surface (e.g., in form of a coating). For example, a catheter (e.g., a hemodialysis catheter) may be coated with a composition that comprises a polyurethane, cellulose or a cellulose-derived polymer, and a pyrimidine analog on a proximal portion of the catheter and with an antithromobotic agent-containing composition on its distal portion (i.e., the portion of catheter that would be inserted in the body and of the catheter. A “proximal portion” of the catheter refers to a portion of catheter that is closer to the junction where the catheter exits the skin than to the tip of the catheter. A proximal portion of the catheter may or may not include the junction where the catheter exits the skin. A “distal portion” of the catheter refers to a portion of catheter that would be inserted in the body and is closer to the tip of the catheter than to the junction where the catheter exits the skin. A distal portion of the catheter may or may not include the tip of the catheter.

In certain embodiments, the anti-infective device of the present invention comprises a catheter that is composed at least partially of polyurethane. A “catheter that is composed at least partially of polyurethane,” as used herein, refers to a catheter at least a section of its shaft (a) of which is made of a composition that comprises polyurethane, and (b) in which polyurethane is not present only in a composition that further comprises cellulose or a cellulose-derived polymer and a pyrimidine analog (e.g., in the form of a coating) on the catheter. In other words, such a catheter has at least a section of its shaft that is formed form a polyurethane material or a blend or copolymer of polyurethane and another polymer. In certain embodiments, polyurethane contributes to at least 60%, 70%, 80%, 90%, 95%, 98% or 99% of the weight of at least a section of the catheter. In certain embodiments, polyurethane contributes to at least 60%, 70%, 80%, 90%, 95%, 98% or 99% of the weight of the full length of the catheter.

In certain embodiments, the catheter is composed of polyurethane that is different from the polyurethane in the coating of the catheter. In certain embodiments, the catheter is composed of polyurethane that is the same as the polyurethane in the coating of the catheter.

Polyurethanes useful in the production of catheters are well known in the art. They may be aliphatic or aromatic. In certain embodiments, polyurethanes that form catheter shafts are thermoplastic. For example, in certain embodiments, a catheter can be composed of an aliphatic, thermoplastic polyurethane including poly(ester urethane) such as TECOFLEX, TECOTHANE, TECOLAST, AND TECHOPHILIC available from Lubrizol Advanced Materials, Inc., aliphatic, thermoplastic polyurethane elastomer such as PELLETHANE available from Dow, or thermoplastic poly(carbonate urethane) such as CARBOTHANE available from Lubrizol. Additional exemplary polyurethanes useful in producing catheters may be MICRO-RENATHANE® and RENAPULSE™ from Braintree Scientific. Typically, polyurethanes that form catheter shaft may range in hardness measured in terms of durometer ranging from 72A to 90D (e.g., for a CVC catheter, the range may e 60A to 84D).

In certain embodiments, a catheter (e.g., a CVC catheter or a hemodialysis catheter) composed at least partially of polyurethane may include up to about 20% barium sulfate, bismuth salts, and/or tungsten to make them radiopaque.

In certain embodiments where the catheter is composed of at least partially of a polyurethane, the pyrimidine analog is also incorporated (e.g., penetrated) into the polyurethane of which the catheter is composed of. The incorporation may occur during the process of applying or incorporating a composition that comprises a polyurethane, a cellulose or cellulose-derived polymer, and a pyrimidine analog onto a catheter or a portion thereof, such as during the process of coating a catheter or a portion thereof with the composition. For example, when a catheter is coated with a composition that comprises a swelling agent, the swelling agent induces swelling of the polyurethane from which the catheter is made, which in turn may cause the pyrimidine analog also present in the composition to penetrate or embed into the polyurethane from which the catheter is made. In certain embodiments, such penetration or embedment of the pyrimidine analog in the polyurethane that forms the catheter allows sustained release of the pyrimidine analog for a relatively long period of time (e.g., for at least 6, 7, 8, 9, 10, 11, or 12 months). In certain embodiments, such penetration of the pyrimidine analog in the polyurethane that forms the catheter allows the pyrimidine analog if applied to the exterior surface of the catheter to be eluted inside the lumen of the catheter.

In certain embodiments, the anti-infective device of the present invention comprises a catheter that has a surface that is made from a polyurethane or a blend or copolymer of polyurethane and another polymer, whereas the underlying substrate is made from material that does not comprise polyurethane. Such a catheter is referred to as “polyurethane-clad catheter.”

In certain embodiments, the catheter may be made of polymers other than polyurethane. Exemplary polymers include silicone such as RENASIL™ from Briantree Scientific.

In certain embodiments, an anti-infective device is provided that comprises a catheter (e.g., a central venous catheter or more specifically, a triple lumen central venous catheter), and a composition (e.g., in the form of coating) on the catheter, wherein (1) the coating comprises poly(carbonate urethane), nitrocellulose, and 5-fluorouracil, (2) the weight ratio of poly(carbonate urethane) to nitrocellulose in the coating ranges from 1:2 to 1:4 (e.g., about 1:3), and (3) 5-fluorouracil is present at 10 μg to 100 μg per linear cm (e.g., at about 50, 60, or 70 μg per linear cm) of the catheter surface area to which the composition is applied or incorporated (e.g., coated catheter surface area). In certain embodiments, the catheter is only coated on its non-luminal surface or a portion thereof. In certain embodiments, the coating on the non-luminal surface or a portion thereof is about 3-7 μm (e.g., about 5 μm) thick. In certain embodiments, the total amount of 5-FU in the catheter is from about 0.2 mg to about 2 mg, such as from 0.5 mg to about 1.5 mg, or about 1 mg. In certain embodiments, the weight ratio of 5-FU to the sum of poly(carbonate urethane) and nitrocellulose is below 20%.

In certain embodiments, inhibition of infection (e.g., bacterial colonization) of certain types of catheters (e.g., vascular access catheters) may be achieved by incorporation of a fluoropyrimidine (e.g., 5-FU) in an amount of about 25 μg to about 75 μg per linear cm of the catheter length to which a pyrimidine-containing polymeric composition is applied or incorporated (e.g., coated catheter length). The anti-infective surface of the catheter (e.g., CVC's) may contain fluoropyrimidine (e.g., 5-FU) in an amount of about 40 μg to about 60 μg per linear cm or about 45 μg/linear cm to about 55 μg/linear cm.

In certain embodiments, inhibition of infection (e.g., bacterial colonization) of certain types of catheters (e.g., hemodialysis catheters) may be achieved by incorporation of a fluoropyrimidine (e.g., 5-FU) in an amount of about 50 μg to about 150 μg per linear cm of the catheter length to which a pyrimidine-containing polymeric composition is applied or incorporated (e.g., coated catheter length). The anti-infective surface of the catheter (e.g., HemoStream chronic dialysis catheters) may contain fluoropyrimidine (e.g., 5-FU) in an amount of about 100 μg to about 120 μg per linear cm or about 105 μg/linear cm to about 115 μg/linear cm.

5-FU is given intravenously (IV) for cancer therapy due to its inefficient absorption by ingestion. The doses used vary but a typical regimen is a dose of 500 mg/m² administered daily for 5 days, which is repeated in monthly cycles (Calabresi and Chabner, Chemotheapy of neoplastic disease. In: Gilman et al. (Eds), The Pharmacologic Basis of Therapeutics, 8^{th} Ed. New York: Pergamon Press, p. 1227-30, 1990). Another regimen delivers as much as 5 grams over a 12-day period (Physician's Desk Reference (PDR), Fluorouracil for Injection, 1998). When the dose is given IV, plasma concentrations reach 0.1-1.0 mM (13-130 μg/ml) with a rapid infusion and levels of about 10 μM with a continuous infusion.

Published literature is available reporting the genotoxicity and carcinogenicity potential of 5-FU; the LD₅₀ in mammalian species is between 94-880 mg/kg (PDR 1998). In contrast, in certain embodiments, the central venous catheter provided herein contains only about 1 mg of 5-FU, which is released gradually over several weeks. The total 5-FU content of such a catheter is approximately 800-fold less than a maximum daily intravenous dosage or 5000-fold less than a typical 12-day treatment (PDR 1998). Non-clinical blood analysis has shown no systemically detectable levels of 5-FU (assay sensitivity of 1 ng/ml) at any time point after implantation of the (up to 21 days) in goats as shown in the example section.

### Methods for Making Anti-Infective Devices

In one aspect, a method for making an anti-infective catheter is provided. Such a method comprises applying or incorporating a composition that comprises a polyurethane, cellulose or a cellulose-derived polymer, and a pyrimidine analog on to a catheter or a portion thereof, such as coating a catheter or a portion thereof with a coating composition provided herein.

The pyrimidine analog-containing polymeric composition provided herein may be applied by various techniques known in the art, such as sputter-coating, impregnating, dipping, pouring, pumping, spraying, brushing, and wiping. For instance, simple procedures, such as dipping or spraying, followed by air-drying can be used to apply a pyrimidine analog-containing polymeric composition (e.g., in form of a coating solution) described herein to a catheter. In certain embodiments, solvents in the composition may be evaporated by subjecting the catheter onto which the composition has been applied (e.g., the coated catheter) to elevated temperatures, typically from 50° C. to 120° C., such as about 80° C., for a period of time (e.g., about 20 minutes). Detailed description of certain exemplary methods is provided in the example section.

In certain embodiments, a catheter is applied or incorporated (e.g., coated) with an anti-infective composition on its non-luminal surface (or a portion thereof) only. In certain other embodiments, a catheter is applied or incorporated (e.g., coated) with an anti-infective composition on its luminal surface or a portion thereof. In certain yet other embodiments, a catheter is applied or incorporated (e.g., coated) with an anti-infective composition on all or a portion of both its non-luminal surface (or a portion thereof) and its luminal surface (or a portion thereof). In certain embodiments, a catheter is applied or incorporated (e.g., coated) with an anti-infective composition on its non-luminal surface, its luminal surface, or both over the length intended to be inserted into a patient.

Pyrimidine analogs and other active agents (if present in the coating compositions) should preferably not degrade during storage, prior to, or after insertion inside the body. In addition, in certain embodiments, the composition should preferably coat or cover the desired areas of the catheter smoothly and evenly, with a uniform distribution of pyrimidine analogs and other active agents (if present). Within preferred embodiments, the composition should provide a uniform, predictable, prolonged release of the pyrimidine analogs and other active agents (if present) once it has been deployed such as to inhibit infection associated with implantation of the catheter. In certain embodiments, inhibition of infection (e.g., bacterial colonization of the catheter) may be achieved without release (e.g., dissociation) of the pyrimidine analog from the catheter. For vascular catheters (e.g., vascular access catheters), in addition to the above properties, the composition should not render the catheter thrombogenic (causing blood clots to form), or cause significant turbulence in blood flow (more than the catheter itself would be expected to cause if it was uncoated).

If the catheter is composed of materials that do not allow direct application or incorporation (e.g., coating) of the anti-infective composition, one can treat the surface of the device with a plasma polymerization method or other ionizing treatment to promote interaction between the catheter surface and the composition (e.g., in form of a coating) and adhesion of the composition (e.g., in form of a coating) to the catheter surface. Examples of such methods include parylene coating of devices, and the use of various monomers such hydrocyclosiloxane monomers, acrylic acid, acrylate monomers, methacrylic acid or methacrylate monomers. One can then apply or incorporate (e.g., coat the resulting catheter) with the anti-infective coating composition provided herein.

Similarly, in certain embodiments, a catheter may be first coated with a cross-linkable polymer to form a primer layer. Such a primer layer is intended to facilitate the adhesion of subsequent application or incorporation of the anti-infective composition provided herein (e.g., coating using the anti-infective coating compositions). Exemplary polymers for making the primer layers and methods for making such primer layers are described in U.S. Patent Application Publication No. 2004/0117007, relevant sections of which are incorporated by reference.

In certain embodiments, a catheter may be further coated with one or more intermediate layers to enhance the flexibility and/or elasticity of the coated catheter before being coated with the anti-infective coating compositions provided herein. Exemplary polymers for making the intermediate layers and methods for making such intermediate layers are also described in U.S. Patent Application Publication No. 2004/0117007, relevant sections of which are incorporated by reference.

In certain embodiments, a catheter may further comprise one or more layers on top of the anti-infective coating compositions. Such layers may be useful for enhancing various desirable properties of the resulting catheter, such as increased flexibility (e.g., layers comprising glycerol or triethyl citrate), improved lubricity (e.g., layers comprising PVP or hyaluronic acid) and biocompatibility or hemocompatability (e.g., layers comprising heparin). In certain embodiments, such layers may contain one or more secondary active agents described above.

The amount of a pyrimidine analog in the composition (e.g., in form of a coating) on an anti-infective catheter may range from 0.1 mg to 100 mg, although lower or higher loadings may be used depending on various factors, including the particular pyrimidine analog, the desired dosage level, the anti-infective composition, the type of catheter, the diameter and length of the catheter, the number of layers, and the thickness of the composition on the catheter (e.g., coating thickness). These factors are adjusted to provide a durable coating that controllably releases the desired amount of a pyrimidine analog over an extended period (e.g., up to about a month).

In certain embodiments, 30% to 70% of the pyrimidine analog is released during the first 10 days after the anti-infective catheter is implanted into a patient, and the remainder is released gradually over 20 or more days.

In certain embodiments, 20% to 70% (e.g., about 40% to about 60%) of the pyrimidine analog (e.g., 5-FU) is released from the anti-infective catheter at day 7 after implanted into a patient, 50% to 90% (e.g., about 60% to about 90%) released at day 14, and 70% to 95% (e.g., about 80% to about 95%) at day 21.

In certain embodiments, the release rate of the pyrimidine analog from the anti-infective catheter is substantially constant for at least 5, 10, 15, 20, 25, or 30 days. The release rate is substantially constant for a period of time when at a given time point within the period of time, the release rate is within the range of 75% to 125% of the average release rate during this period of time.

In certain embodiments, the pyrimidine analog is a fluoropyrimidine such as 5-FU. In certain embodiments, the anti-infective catheter is a CVC catheter comprising about 1 mg 5-FU (or about 50 μg/linear cm), which is released over 28 days. The total 5-FU content of the CVC (1 mg) is significantly less than is seen in other clinical applications (e.g., cancer treatment). This dose of 5-FU is 800-fold less than a maximum daily intravenous dosage and 5.000-fold less than a typical 12-day treatment (PDR, Carac (Fluorouracil) Cream, 0.5%, 2005).

The anti-infective catheters can be packaged and sterilized. Ethylene oxide may be useful for sterilization of catheters prepared as described herein.

### Kits Comprising Anti-Infective Devices

The catheters described herein may be packaged together with additional components in a kit. In one aspect, a kit is provided for inserting an anti-infective catheter that comprises multiple items used for preventing or reducing infection associated with the catheter and facilitating the insertion. In certain embodiments, in addition to an anti-infective catheter, the kit may comprise a skin anti-infective agent. In certain embodiments, in addition to an anti-infective catheter and optionally a skin anti-infective agent, the kit may comprise a local anesthetic.

For example, a central venous catheter kit may contain one or more the following components: a fluoropyrimidine coated central venous catheter (e.g., a triple-lumen indwelling 5-fluorouracil coated catheter with slide clamps and injection caps), a guidewire (e.g., straight and “J” double flexible tip), a vessel dilator, an introducer needle (e.g., one 18 GA introducer needle), one or more injection needles (e.g., one 22GA×11/2″ injection needle and one 25GA×1″ injection needle), an additional catheter (e.g., one 18GA×21/2″ catheter over 20GA needle), one or more syringes (e.g., two 5 ml syringes and one 3 ml syringe), a container containing a local anesthetic (e.g., one 5 ml ampoule 1% lidocaine), suture (e.g., one 3-0 silk suture with straight needle), gauze pads (e.g., two 2″×2″ gauze pads, five 4″×4″ gauze pads), a safety scalpel (e.g., disposal safety scalpel), one sharps needle holder cup, one 24″×36″ drape with 4″ fenestration, one CSR wrap, and one ChloroPrep.

For example, a HemoStream chronic dialysis catheter kit may contain one or more the following components: a fluoropyrimidine coated HemoStream chronic dialysis catheter (e.g., a 15.5F, multi-lumen, radiopaque, 5-fluorouracil coated polyurethane catheter with a polyester cuff and two female Luer locking adapters), a guidewire, a flexible stiffener, a tunneling device, a vessel dilator, adhesive dressing, safety scalpel (e.g., disposal safety scalpel), male luer lock injection caps, safety foam, and an introducer needle.

### Methods for Using Anti-Infective Devices

In one aspect, a method for reducing or inhibiting infection associated with a catheter is provided. Such a method comprises introducing into a patient an anti-infective catheter as provided herein.

As used herein, “reducing or inhibiting infection associated with a catheter” refers to reduction of infection associated with a catheter that comprises a pyrimidine analog in a statistically significant manner compared to a catheter that is otherwise the same but does not comprises the pyrimidine analog.

In certain embodiments, the method provided herein may be used to reduce or inhibit bacterial colonization associated with the catheter. Catheter colonization may be assessed using the roll plate method as described by Maki et al. (NEJM 296(3): 1305-1309, 1977). This method is a commonly used semi-quantitative method to assess catheter colonization in clinical trials. Other assessments to be performed, including the diagnostic criteria for a diagnosis of catheter related bloodstream infection (CRBSI) taken from infection guidelines, previous research on CVC-related infection, and current evidence-based recommendations for catheter infection-related diagnosis (Maki et al. NEJM 296(3): 1305-9, 1977; Mermel et al., Clin Infect Dis 32(9): 1249-72, 2001; Rijinders et al., Catheter Colonization and BSI CID 35: 1053-8, 2002; Burke, Nursing Times 96(29): 38-9, 2000; Maddox et al., Am J Hosp Pharm 34: 29-34, 1977; Raad, Ann Intern Med: 140: 18-25, 2004).

In certain embodiments, the method provided herein may be used to reduce or inhibit local infection associated with a catheter. “Local infection associated with a catheter” refers to infection (e.g., bacterial infection) on or around the catheter (e.g., colonization of the catheter surface with bacteria).

In certain embodiments, the method provided herein may be used to reduce or inhibit bloodstream infection associated with a catheter. “Bloodstream infection associated with a catheter” refers to infection in the bloodstream from infective microorganisms disseminated away from a catheter.

Several clinical applications of anti-infective catheters provided herein are discussed in more detail below.

A. Infections Associated with Vascular Catheters

In certain embodiments, a method for reducing or inhibiting infection associated with a vascular catheter is provided. Such a method comprises introducing into a patient an anti-infective vascular catheter provided herein.

“Vascular catheter” refers to any catheter that resides in a blood vessel (e.g., vein or artery). Typically, vascular catheters reside in the blood vessel for 30 days or less. The vascular catheter may be a vascular access catheter such as a central venous catheter (including long term tunneled central venous catheters, peripherally insertable central venous catheters, and short term central venous catheters), a peripheral venous catheter, or an infusion catheter (i.e., a vascular catheter for infusion of nutrition, medication, and the like). In one embodiment, the vascular catheter is a non-expandable vascular catheter (e.g., a catheter that does not include an expandable balloon portion).

More than 30 million patients receive infusion therapy annually in the United States. In fact, 30% of all hospitalized patients have at least one vascular catheter in place during their stay in hospital. A variety of medical devices are used for infusion therapy including, but not restricted to, peripheral intravenous catheters, central venous catheters, total parenteral nutrition catheters, peripherally inserted central venous catheters (PIC lines), totally implanted intravascular access devices, flow-directed balloon-tipped pulmonary artery catheters (also known in the art as “Swan-Ganz catheters”), arterial lines, and long-term central venous access catheters (Hickman lines, Broviac catheters).

Unfortunately, vascular catheters such as vascular access catheters are prone to infection by a variety of bacteria and are a common cause of bloodstream infection. Of the 100,000 bloodstream infections in U.S. hospitals each year, many are related to the presence of an intravascular device. For example, 55,000 cases of bloodstream infections are caused by central venous catheters, while a significant percentage of the remaining cases are related to peripheral intravenous catheters and arterial lines.

Bacteremia related to the presence of intravascular devices is not a trivial clinical concern: 50% of all patients developing this type of infection will die as a result (over 23,000 deaths per year) and in those who survive, their hospitalization will be prolonged by an average of 24 days. Complications related to bloodstream infections include cellulites, the formation of abscesses, septic thrombophlebitis, and infective endocarditis. Therefore, there is a tremendous clinical need to reduce the morbidity and mortality associated with intravascular catheter infections.

The most common point of entry for the infection-causing bacteria is tracking along the device from the insertion site in the skin. Skin flora spread along the outside of the device to ultimately gain access to the bloodstream. Other possible sources of infection include a contaminated infusate, contamination of the catheter hub-infusion tubing junction, and hospital personnel. The incidence of infection increases the longer the catheter remains in place and any device remaining in situ for more than 72 hours is particularly susceptible. The most common infectious agents include common skin flora such as coagulase-negative staphylococci (S. epidermidis, S. saprophyticus) and Staphylococcus aureus (particularly MRSA—methicillin-resistant S. aureus) which account for ⅔ of all infections. Coagulase-negative staphylococci (CNS) is the most commonly isolated organism from the blood of hospitalized patients. CNS infections tend to be indolent; often occurring after a long latent period between contamination (i.e. exposure of the medical device to CNS bacteria from the skin during implantation) and the onset of clinical illness. Unfortunately, most clinically significant CNS infections are caused by bacterial strains that are resistant to multiple antibiotics, making them particularly difficult to treat. Other organisms known to cause vascular access catheter-related infections include Enterococci (e.g. E. coli, VRE—vancomycin-resistant enterococcci), Gram-negative aerobic bacilli, Pseudomonas aeruginosa, Klebsiella spp., Serratia marcescens, Burkholderia cepacia, Citrobacter freundii, Corynebacteria spp. and Candida species.

Most cases of vascular access catheter-related infection require removal of the catheter and treatment with systemic antibiotics (although few antibiotics are effective), with vancomycin being the drug of choice. As mentioned previously, mortality associated with vascular access catheter-related infection is high, while the morbidity and cost associated with treating survivors is also extremely significant.

It is therefore extremely important to develop vascular access catheters capable of reducing the incidence of bloodstream infections. Since it is impossible to predict in advance which catheters will become infected, any catheter expected to be in place longer than a couple of days would benefit from a therapeutic coating capable of reducing the incidence of bacterial colonization of the device. An ideal therapeutic coating would have one or more of the following characteristics: (a) the ability to kill, prevent, or inhibit colonization of a wide array of potential infectious agents including most or all of the species listed above; (b) the ability to kill, prevent, or inhibit colonization of bacteria (such as CNS and VRE) that are resistant to multiple antibiotics; (c) utilize a therapeutic agent unlikely to be used in the treatment of a bloodstream infection should one develop (i.e., one would not want to coat the device with a broad-acting antibiotic, for if a strain of bacteria resistant to the antibiotic were to develop on the device, it would jeopardize systemic treatment of the patient since the infecting agent would be resistant to a potentially useful therapeutic).

The anti-infective vascular catheters provided herein have the above-described desirable characteristics and may be used to reduce or inhibit infections associated with vascular catheters.

Central Venous Catheters

In certain embodiments, a method for reducing or inhibiting infection associated with a central venous catheter is provided. Such a method comprises introducing into a patient an anti-infective central venous catheter provided herein.

As used herein, the term “central venous catheters” (CVC) refers to any catheter or line that is used for hemodynamic monitoring or for delivering fluids, blood products, drugs, and nutrition to, as well as blood withdrawal from, the large (central) veins of the body (e.g., jugular, pulmonary, femoral, iliac, inferior vena cava, superior vena cava, axillary, etc.).

There are many types of central venous catheters (CVC) that vary by insertion technique, size, tip style, catheter material, and number of lumens.

There are non-tunneled percutaneously placed catheters as well as tunneled catheters. Non-tunneled CVCs are placed directly into one of the large central veins with direct access. For example, the HOHN CVC(C. R. Bard, Inc.) is a silicone, open-ended, non-tunneled catheter. The HOHN CVC may have a single or dual lumen. The dual lumen version is for multi-purpose access when two separate fluid pathways are required.

Tunneled CVCs are typically designed for long-term vascular access and for patients that lack adequate peripheral venous access. The tunneled catheter is the best choice when access to the vein is needed for long period of time and when the catheter line will be used many times each day. They are used to tunnel subcutaneously from one of the large central veins to the desired exit site and can have single, dual or triple lumens. Some may be bifurcated to aid in functionality. Tunneled CVCs are often composed of processed silicone or polyurethane. Examples of tunneled CVCs made of silicone with an open-end include, but are not limited to, the HICKMAN, LEONARD and BROVIAC CVCs (C.R. Bard, Inc., Murray Hill, N.J.). The GROSHONG CVC (C.R. Bard, Inc.) which is also a tunneled silicone CVC has a closed rounded tip style. Unlike, open-ended catheters (such as the HICKMAN, LEONARD and BROVIAC lines), the closed end has a valve or valves that allow liquids to flow in or out, but remains closed when not in use to restrict back flow and air embolisms.

Another type of tunneled CVC is the polyurethane, open-ended “power” CVCs made by C.R. Bard, Inc. For example, the POWERLINE CVC is a kink-resistant, reverse-tapered design which has an exclusive bifurcated design. The POWERLINE, POWERHOHN and POWERHICKMAN (C.R. Bard, Inc.) may be used for either long or short term indications where power injection (e.g., power injection of contrast media) is needed.

Some tunneled CVCs are very specialized in their indication of use. For example, the DU PEN Epidural Catheter (C.R. Bard, Inc.) which is a silicone based, open-ended catheter is intended for long-term access to the epidural space for the delivery of morphine to relieve pain associated with cancer.

Other types of central venous catheters include total parenteral nutrition catheters, peripherally inserted central venous catheters, flow-directed balloon-tipped pulmonary artery catheters, long-term central venous access catheters (such as Hickman lines and Broviac catheters). Representative examples of such catheters are described in U.S. Pat. Nos. 3,995,623, 4,072,146 4,096,860, 4,099,528, 4,134,402, 4,180,068, 4,385,631, 4,406,656, 4,568,329, 4,960,409, 5,176,661, 5,916,208. CVCs are widely used in intensive care units (ICU). Like all indwelling devices and implanted foreign bodies, they can increase subject susceptibility to infection.

CVCs can provide a suitable surface for the colonization of microorganisms. Bacteria that are present on the skin, around the catheter hubs, or surrounding the CVC insertion site can become established on the catheter surface. When bacteria that colonize on and around the catheter propagate along the catheter surface and into the intracutaneous tract, they can disseminate away from the catheter and seed into the bloodstream. This may result in systemic bloodstream infections, which can lead to significant increases in morbidity and mortality.

Although many infectious agents can colonize and infect a catheter, skin microorganisms are the most common causes of catheter-related infection. Staphylococci (S. aureus, S. epidermidis, and S. pyogenes), Enterococci (E. coli), Gram Negative Aerobic Bacilli, and Pseudomonas aeruginosa are all common causes of CRI.

Microorganisms commonly present on the skin and those associated with catheter-related infection (CRI) produce proteins that enhance their adherence properties. The production of these proteins promotes the formation of biofilms, which influences microbial resistance to host defense mechanisms. Biofilms can be defined as a highly consolidated structure composed of bacteria reversibly attached to themselves or a substrate, embedded in a matrix of polymeric substances.

Biofilm formation begins with the attachment of bacteria to a surface of the catheter, followed by cell proliferation and intracellular adhesion. A CVC first becomes coated with plasma and connective tissue proteins, such as fibronectin, fibrinogen, vitronectin, thombospondin, lamin, collagen and von Willebrand factor. These proteins then act as receptors for colonizing bacteria. Following adherence to the catheter surface, bacteria multiply and accumulate in multilayered clusters followed by differentiation into exopolysaccharide-encased mature biofilms. Within biofilms, bacteria acquire or develop different characteristics. Following adherence to the catheter surface, bacteria multiply and accumulate in multilayered clusters followed by differentiation into exopolysaccharide-encased muture biofilms. Thus the biofilm shields bacteria against immune response mechanisms and systemic antibiotics. Bacteria in biofilms are protected from host defenses and antibacterial treatments due to a number of biofilm properties. This decreased susceptibility to antimicrobial agents requires that novel strategies be developed to prevent CRIs.

The most frequent life-threatening complication of CVC use is septicemia. Other severe complications of central venous catheter infection include infective endocarditis and suppurative phlebitis of the great veins. If the device becomes infected, it must be replaced at a new site (over-the-wire exchange is not acceptable) which puts the patient at further risk to develop mechanical complications of insertion such as bleeding, pneumothorax and hemothorax. In addition, systemic antibiotic therapy is also required.

A total of 250,000 cases of CVC-related infections are estimated annually across all facilities in the United States, many of them fatal. The cost associated with central venous catheter-related infections is estimated at US $25,000 to US $56,000 per infected subject independent of the individual subject's outcome. A meta-analysis of the cost-effectiveness of antiseptic-impregnated central venous catheters estimated that subjects surviving bloodstream infection had an excess ICU stay of 6.5 days and an average additional charge of US $28,690. Clinical costs could be reduced with adequate infection prevention strategies, including devices designed to resist colonization.

An effective therapy would reduce the incidence of device infection, reduce the incidence of bloodstream infection, reduce the mortality rate, reduce the incidence of complications (such as endocarditis or suppurative phlebitis), prolong the effectiveness of the central venous catheter, and/or reduce the need to replace the catheter. This would result in lower mortality and morbidity for patients with central venous catheters in place.

Some other means of preventing microbial infections have been implemented including adding cuffs to the ends of the catheter. For example, Dacron cuffs about 2 cm above the exit site may act as a barrier to ascending microorganisms and act to prevent catheter dislodgment. Other examples of catheter cuffs include the SURECUFF Tissue Ingrowth Cuff (means to fix the catheter in a subcutaneous tunnel) or VITACUFF Antimicrobial Cuff (designed to protect against infections related to vascular access catheters). Cuffs may be used as a means to incorporate an antimicrobial agent into its materials. For example, the VITACUFF is composed of two concentric layers of materials (silicone and collagen matrix which are collectively known as VITAGUARD) to decrease the incidence of infection at the outer, tissue-interfacing surface of the VITACUFF device. By adding additional antimicrobial agents to the cuff, more effective antimicrobial properties may be achieved.

Antibiotic-coated catheters have been developed to prevent bacterial infections, but these catheters may become colonized by bacteria that are resistant to the antibiotic coating. Antibiotic resistance creates additional complications, as these infections cannot be treated systemically with the antibiotic(s) used in the coating. Antibacterial resistance is a concern that has reduced the utilization of antibiotic-coated CVCs. Widespread acceptance and usage of antibiotic-coated catheters may be limited because of the risk of developing antibiotic resistant organisms that would require newer and/or stronger antibiotics. Additional concerns regarding the use of antibiotic-coated catheters include the additional time that must be spent preparing the coated catheter for insertion and the lack of efficacy against yeasts of the anti-infective agents that are in common use.

The anti-infective central venous catheters provided herein may be used to reduce or inhibit infections associated with central venous catheters, including bacterial colonization, local infection, and infection in bloodstream associated with catheters. The anti-infective central venous catheters provided herein also may inhibit the formation of biofilm on the surface of the catheter. Such catheters comprise pyrimidine analogs (e.g., 5-fluorouracil) that have anti-infective activities against a broad spectrum of microorganisms (e.g., gram positive bacteria). In addition, the polymeric coating on the catheters allows the pyrimidine analogs to be released at effective concentrations for a sustained period of time.

Peripheral Venous Catheters

In certain embodiments, a method for reducing or inhibiting infection associated with a peripheral venous catheter is provided. Such a method comprises introducing into a patient an anti-infective peripheral venous catheter provided herein.

As used herein, the term “peripheral venous catheters” refers to any catheter or line (e.g., peripherally inserted central catheters (PICC) used to deliver fluids to the smaller (peripheral) superficial veins of the body (e.g., veins in the arm or leg). Peripheral venous catheters include radial and femoral access catheters.

Peripherally inserted central catheter (PICC or PIC line) is a form of intravenous access whereby they can be used for extended periods of time (e.g., long chemotherapy regimens, extended antibiotic therapy or total parenteral nutrition). PICCs typically provide central intravenous access for several weeks, but may remain in place for several months. PICCs are usually inserted in a peripheral vein, such as the cephalic vein, basilica vein, or brachial vein and then advanced through increasingly larger veins toward the heart until the tip rests in the distal superior vena cava.

Certain types of PICCs have multiple lumens such as the POLY PER-Q-CATH Triple-Lumen PICC (C.R. Bard) and the TWINCATH Multiple Lumen Peripheral Catheter made by Arrow International, Inc. (Reading, Pa.).

Certain types of PICCs have been approved for use in power injection, such as the polyurethane PICCs made by C.R. Bard, Inc. The POWERPICC Catheter and the POWERPICC SOLO Catheter come in single, dual or triple lumens. They are used for injection of contrast media into the bloodstream. Other power injection catheters include the XCELA Power Injectable PICC (Boston Scientific) and the PRO-PICC CT (Medical Components, Inc., Harleysville, Pa.). Arrow International also makes a Pressure Injectable PICC.

Some PICCs have greater radiopacity. For example, the POLY RADPICC Catheters made by C.R. Bard are specifically designed with greater radiopacity. These polyurethane-based catheters have a kink-resistant hub enhancing strength and comfort. The RADPICC catheters also made by C.R. Bard are silicone based which are available in either single or dual lumens. The VASCU-PICC II which has greater x-ray and fluoroscopic visibility is made by Medical Components. Another PICC that has greater imaging capabilities is the MORPHEUS CT PICC made by Angiodynamics Inc. (Queensbury, N.Y.).

PICCs may be open-ended or may be valved. Examples of open-ended PICCs include, but are not limited to, the polyurethane ARROW PICC (Arrow International), the polyurethane POLY PER-Q-CATH PICC and the POWERPICC Catheters (C.R. Bard) as well as the silicone PER-Q-CATH PICC (C.R. Bard). Smiths Medical (Herts, UK) makes open-ended PICCs such as the DELTEC CLINICATH and POLYFLOW PICCs.

Examples of valved PICCs include, but are not limited to, the silicone-based GROSHONG PICC lines and the polyurethane-based POWERPICC SOLO Catheter from C.R. Bard. Boston Scientific (Natick, Mass.) makes the VAXCEL PICC with PASV Valve technology.

Other peripherally inserted catheters are midline catheters. Midline catheters are inserted peripherally but unlike the PICC that ends at the heart or the largest central vein, the midline catheter tip does not extend to the heart. Typically, the midline catheter tip ends at an upstream vein. Midline catheters are also typically not used as long as PICCs. Examples of midline catheters include those made by C.R. Bard such as the silicone open-ended midlne catheters (e.g., PER-Q-CATH Plus Midline Catheter) and the silicone valved midline catheters (e.g., GROSHONG Midline Catheter). Arrow International makes the polyurethane open-ended ARROW Midline Catheter.

Peripheral venous catheters have a much lower rate of infection than do central venous catheters, particularly if they are in place for less than 72 hours. One exception is peripheral catheters inserted into the femoral vein (so called “femoral lines”) which have a significantly higher rate of infection. The organisms that cause infections in a peripheral venous catheter are identical to those described above (for central venous catheters).

The anti-infective peripheral venous catheters provided herein may be used to reduce or inhibit infections associated with peripheral venous catheters, including bacterial colonization, local infection, and infection in bloodstream associated with catheters. The anti-infective peripheral venous catheters provided herein also may inhibit the formation of biofilm on the surface of the catheter. Such catheters comprise pyrimidine analogs (e.g., 5-fluorouracil) that have anti-infective activities against a broad spectrum of microorganisms (e.g., gram positive bacteria). In addition, the polymeric coating on the catheters allows the pyrimidine analogs to be released at effective concentrations for a sustained period of time.

Arterial Lines

In certain embodiments, a method for reducing or inhibiting infection associated with an arterial line is provided. Such a method comprises introducing into a patient an anti-infective arterial line provided herein.

Arterial lines are used to draw arterial blood gasses, obtain accurate blood pressure readings and to deliver fluids. They are placed in a peripheral artery (typically the radial artery of the wrist) and often remain in place for several days. Arterial line catheters are typically those catheters that are used for peripheral lines. Arterial lines are often composed of a transducer setup (such as the DELTRAN pressure transducer from Utah Medical Products, Inc., Midvale, Utah) at the open end of the arterial catheter. This maintains a pressure to control the forward flow into the artery to ensure the arterial blood pressure of the patient does not result in the patient's blood climbing up the catheter line.

Arterial lines have a very high rate of infection (12-20% of arterial lines become infected) and the causative organisms are identical to those described above (for central venous catheters).

The anti-infective arterial lines provided herein may be used to reduce or inhibit infections associated with arterial lines, including bacterial colonization, local infection, and infection in bloodstream associated with catheters. The anti-infective arterial lines provided herein also may inhibit the formation of biofilm on the surface of the catheter. Such catheters comprise pyrimidine analogs (e.g., 5-fluorouracil) that have anti-infective activities against a broad spectrum of microorganisms (e.g., gram positive bacteria). In addition, the polymeric coating on the catheters allows the pyrimidine analogs to be released at effective concentrations for a sustained period of time.

Port-Catheters

Port-catheters provide implantable accessibility for repeat access to the vascular system or to the peritoneal cavity. Ports have two main components consisting of an injection port with a self-sealing septum and a catheter. The port reservoir is implanted subcutaneously and is tunneled via central catheter to the large central vein in the chest. Port access is performed by percutaneous needle insertion using non-coring needles.

Arterial ports are implantable vascular access devices that provide repeated access to the vascular system for the delivery of medications, intravenous fluids, parenteral nutrition solutions, blood products, imaging solutions and for the withdrawal of blood samples.

Peritoneal ports with peritoneal catheters are a totally implantable access device designed to provide repeated access to the peritoneal cavity for the delivery of medications and other fluids.

Ports may be used with either open-ended catheters or valved catheters. For example, implanted ports, such as the BARDPORT, SLIMPORT and X-PORT (C.R. Bard), may be used with open-ended radiopaque silicone or CHRONOFLEX polyurethane catheters. When security against blood reflux and air embolism in the port/catheter system is required, valved catheters, such as the GROSHONG catheters, are used. Ports typically used with GROSHONG catheters are the BARDPORT and X-PORT products. Other valved implantable ports include the PASV Valved VAXCEL Implantable Port from Boston Scientific.

Other ports can be used for power injection of contrast media. For example, the POWERPORT (C.R. Bard) implanted port may be used with the POWERLOC Safety Infusion Set to deliver power injection of contrast media.

Ports may have either a single lumen or a dual lumen to facilitate multiple-infusion therapy. Most of the ports have single lumens, however, some dual lumen ports include the SLIMPORT Dual-Lumen ROSENBLATT Implanted Port and the M.R.I. Dual-Lumen Implanted Port made by C.R. Bard.

Ports may also have low, intermediate or full size profiles. For example, C.R. Bard makes low profile ports, such as the M.R.I. ULTRA SLIMPORT and the SLIMPORT Dual-Lumen ROSENBLATT Implanted Port. Intermediate profile ports made by C.R. Bard include the X-PORT (duo and inline) Dual-Lumen Implanted Ports, and full profile ports made by C.R. Bard include the Titanium DOME Implanted Port and the M.R.I. Implanted Port.

The anti-infective port-catheters provided herein may be used to reduce or inhibit infections associated with port-catheters, including bacterial colonization, local infection, and infection in bloodstream associated with the port-catheters. The anti-infective port-catheters provided herein also may inhibit the formation of biofilm on the surface of the catheters. Such catheters comprise pyrimidine analogs (e.g., 5-fluorouracil) that have anti-infective activities against a broad spectrum of microorganisms (e.g., gram positive bacteria). In addition, the polymeric coating on the catheters allows the pyrimidine analogs to be released at effective concentrations for a sustained period of time.

B. Infections Associated With Tympanostomy Tubes

In certain embodiments, a method for reducing or inhibiting infection associated with a tympanostomy tube is provided. Such a method comprises introducing into a patient an anti-infective tympanostomy tube provided herein.

Acute otitis media is the most common bacterial infection, the most frequent indication for surgical therapy, the leading cause of hearing loss and a common cause of impaired language development in children. The cost of treating this condition in children under the age of five is estimated at $5 billion annually in the United States alone. In fact, 85% of all children will have at least one episode of otitis media and 600,000 will require surgical therapy annually. The prevalence of otitis media is increasing and for severe cases surgical therapy is more cost effective than conservative management.

Acute otitis media (bacterial infection of the middle ear) is characterized by Eustachian tube dysfunction leading to failure of the middle ear clearance mechanism. The most common causes of otitis media are Streptococcus pneumoniae (30%), Haemophilus influenza (20%), Branhamella catarrhalis (12%), Streptococcus pyogenes (3%), and Staphylococcus aureus (1.5%). The end result is the accumulation of bacteria, white blood cells and fluid which, in the absence of an ability to drain through the Eustachian tube, results in increased pressure in the middle ear. For many cases antibiotic therapy is sufficient treatment and the condition resolves. However, for a significant number of patients the condition becomes frequently recurrent or does not resolve completely. In recurrent otitis media or chronic otitis media with effusion, there is a continuous build-up of fluid and bacteria that creates a pressure gradient across the tympanic membrane causing pain and impaired hearing. Fenestration of the tympanic membrane (typically with placement of a tympanostomy tube) relieves the pressure gradient and facilitates drainage of the middle ear (through the outer ear instead of through the Eustachian tube—a form of “Eustachian tube bypass”).

Surgical placement of tympanostomy tubes is the most widely used treatment for chronic otitis media because, although not curative, it improves hearing (which in turn improves language development) and reduces the incidence of acute otitis media. Tympanostomy tube placement is one of the most common surgical procedures in the United States with 1.3 million surgical placements per year. Nearly all younger children and a large percentage of older children require general anaesthesia for placement. Since general anaesthesia has a higher incidence of significant side effects in children (and represents the single greatest risk and cost associated with the procedure), it is desirable to limit the number of anaesthetics that the child is exposed to. Common complications of tympanostomy tube insertion include chronic otorrhea (often due to infection by S. pneumoniae, H. influenza, Pseudomonas aerugenosa, S. aureus, or Candida), foreign body reaction with the formation of granulation tissue and infection, plugging (usually obstructed by granulation tissue, bacteria and/or clot), tympanic membrane perforation, myringosclerosis, tympanic membrane atrophy (retraction, atelectasis), and cholesteatoma.

An effective tympanostomy tube coating would allow easy insertion, remain in place for as long as is required, be easily removed in the office without anaesthesia, resist infection and prevent the formation of granulation tissue in the tube (which can not only lead to obstruction, but also “tack down” the tube such that surgical removal of the tube under anaesthetic becomes necessary). An effective tympanostomy tube would also reduce the incidence of complications such as chronic otorrhea (often due to infection by S. pneumoniae, H. influenza, Pseudomonas aerugenosa, S. aureus, or Candida); maintain patency (prevent obstruction by granulation tissue, bacteria and/or clot); and/or reduce tympanic membrane perforation, myringosclerosis, tympanic membrane atrophy and cholesteatoma. Therefore, development of a tube which does not become obstructed by granulation tissue, does not scar in place and is less prone to infection (thereby reducing the need to remove/replace the tube) would be a significant medical advancement.

The anti-infective tympanostomy tubes provided herein have the above-described desirable characteristics and may be used to reduce or inhibit infections associated with tympanostomy tubes.

C. Infections Associated with Urological Catheters

Implanted urological devices or implants (e.g., urological catheters) are used in the urinary tract with greater frequency than in any other body system and have some of the highest rates of infection. In fact, the great majority of urinary devices become infected if they remain in place for a prolonged period of time and are the most common cause of nosocomial infection.

Urinary (Foley) Catheters

In certain embodiments, a method for reducing or inhibiting infections associated with a urinary catheter is provided. Such a method comprises introducing into a patient an anti-infective urinary catheter provided herein.

Four-to-five million bladder catheters are inserted into hospitalized patients every year in the United States. The duration of catheterization is the important risk factor for patients developing a clinically significant infection—the rate of infection increases 5-10% per day that the patient is catheterized. Although simple cystitis can be treated with a short course of antibiotics (with or without removal of the catheter), serious complications are frequent and can be extremely serious. The infection can ascend to the kidneys causing acute pyelonephritis which can result in scarring and long term kidney damage. Perhaps of greatest concern is the 1-2% risk of developing gram negative sepsis (the risk is 3-times higher in catheterized patients and accounts for 30% of all cases) which can be extremely difficult to treat and can result in septic shock and death (up to 50% of patients). Therefore, there exists a significant medical need to produce improved urinary catheters capable of reducing the incidence of urinary tract infection (particular infection resulting from contamination by gram negative bacteria) in catheterized patients.

The most common cause of infection is bacteria typically found in the bowel or perineum that are able to track up the catheter to gain access to the normally sterile bladder. Bacteria can be carried into the bladder as the catheter is inserted, gain entry via the sheath of exudates that surrounds the catheter, and/or travel intraluminally inside the catheter tubing. Several species of bacteria are able to adhere to the catheter and form a biofilm that provides a protected site for growth. With short-term catheterization, single organism infections are most common and are typically due to Escherichia coli, Enterococci, Pseudomonas aeruginosa, Klebsiella, Proteus, Enterobacter, Staphylococcus epidermidis, Staphylococcus aureus and Staphylococcus saprophyticus. Patients who are catheterized for long periods of time are prone to polymicrobial infections caused by all of the organisms previously mentioned as well as Providencia stuartii, Morganella morganii and Candida. Antibiotic use either systemically or locally has been largely proven to be ineffective as it tends to result only in the selection of drug-resistant bacteria.

An effective urinary catheter coating would allow easy insertion into the bladder, resist infection and prevent the formation of biofilm in the catheter. An effective coating would prevent or reduce the incidence of urinary tract infection, pyelonephritis, and/or sepsis.

The anti-infective urinary catheters provided herein have the above-described desirable characteristics and may be used to reduce or inhibit infections associated with urinary catheters.

D. Infections Associated With Endotracheal and Tracheostomy Tubes

In certain embodiments, a method for reducing or inhibiting infections associated with an endothacheal or tracheostomy tube is provided. Such a method comprises introducing into a patient an anti-infective endotracheal or trachostomy tube provided herein.

Endotracheal tubes and tracheostomy tubes are used to maintain the airway when ventilatory assistance is required. Endotracheal tubes tend to be used to establish an airway in the acute setting, while tracheostomy tubes are used when prolonged ventilation is required or when there is a fixed obstruction in the upper airway. In hospitalized patients, nosocomial pneumonia occurs 300,000 times per year and is the second most common cause of hospital-acquired infection (after urinary tract infection) and the most common infection in ICU patients. In the intensive care unit, nosocomial pneumonia is a frequent cause death with fatality rates over 50%. Survivors spend on average 2 weeks longer in hospital and the annual cost of treatment is close to $2 billion.

Bacterial pneumonia is the most common cause of excess morbidity and mortality in patients who require intubation. In patients who are intubated electively (i.e. for elective surgery), less than 1% will develop a nosocomial pneumonia. However, patients who are severely ill with ARDS (Adult Respiratory Distress Syndrome) have a greater than 50% chance of developing a nosocomial pneumonia. It is thought that new organisms colonize the oropharynx in intubated patients, are swallowed to contaminate the stomach, are aspirated to inoculate the lower airway and eventually contaminate the endotracheal tube. Bacteria adhere to the tube, form a biolayer and multiply serving as a source for bacteria that can aerosolize and be carried distally into the lungs. Chronic tracheostomy tubes also frequently become colonized with pathogenic bacteria known to cause pneumonia. The most common causes of pneumonia in ventilated patients are Staphylococcus aureus (17%), Pseudomonas aeruginosa (18%), Klebsiella pneumoniae (9%), Enterobacter (9%) and Haemophilus influenza (5%). Treatment requires aggressive therapy with antibiotics.

An effective endotracheal tube or tracheostomy tube coating would resist infection and prevent the formation of biofilm in the tube. An effective coating would prevent or reduce the incidence of pneumonia, sepsis and death.

The anti-infective endothracheal or tracheostomy tubes provided herein have the above-described desirable characteristics and may be used to reduce or inhibit infections associated with endothracheal or tracheostomy tubes.

E. Infections Associated with Dialysis Catheters

In certain embodiments, a method for reducing or inhibiting infections associated with a dialysis catheter is provided. Such a method comprises introducing into a patient an anti-infective dialysis catheter provided herein.

In 1997, there were over 300,000 patients in the United States with end-stage renal disease. The typical form of treatment is dialysis in the form of either hemodialysis (63%) or peritoneal dialysis (9%). A full renal transplantion occurs in the remaining cases.

In the case of hemodialysis, reliable access is required to the vascular system typically as a surgically created arteriovenous fistula (AVF; 18%), via a synthetic bridge graft (usually a PTFE arteriovenous interposition graft in the forearm or leg; 50%) or a dialysis catheter (32%). In hemodialysis, the patient's blood is pumped through the blood compartment of a dialyzer machine, exposing it to a semipermeable membrane. The cleansed blood is then returned via the circuit back to the body. Ultrafiltration occurs by increasing the hydrostatic pressure across the dialyzer membrane.

In the case of peritoneal dialysis, regular exchange of dialysate through the peritoneum is required via a double-cuffed and tunnelled peritoneal dialysis catheter. In peritoneal dialysis, a sterile solution containing minerals and glucose is run through a tube into the peritoneal cavity, the abdominal body cavity around the intestine, where the peritoneal membrane acts as a semipermeable membrane. The dialysate is left there for a period of time to absorb waste products, and then it is drained out through the catheter and discarded.

Regardless of the form of dialysis employed, infection is the second leading cause of death in renal failure patients (15.5% of all deaths) after heart disease. A significant number of those infections are secondary to the dialysis procedure itself.

Hemodialysis Catheters

In certain embodiments, a method for reducing or inhibiting infections associated with a hemodialysis catheter is provided. Such a method comprises introducing into a patient an anti-infective hemodialysis catheter provided herein.

A hemodialysis catheter is a venous catheter used for hemodialysis (i.e., dialysis of the blood). It is a type of central venous catheter and may be inserted into the subclavian, internal jugular, or femoral veins. It contains two lumens: one for withdrawing blood from the patient and carries it to dialysis machine, the other for returns blood to the patient from the dialysis machine. They typically are tunneled catheters and may be cuffed or non-cuffed. Hemodialysis catheters may be used for a short period (e.g., up to 30 days), an intermediate period (e.g., 1 to 3 months), or a long period (e.g., 6-12 months). An exemplary hemodialysis catheter that may be used for a long period is HEMOSTREAM chronic dialysis catheter from Angiotech.

Longterm vascular access catheters, such as the HICKMAN Hemodialysis/Apheresis CVC made by C.R. Bard are designed for hemodialysis, hemoperfusion and apheresis as well as the administration of intravenous fluids, blood products, drugs, parenteral nutrition solutions and blood withdrawal. Other catheters used for long-term hemodialysis made by C.R. Bard include the HEMOSTAR Catheter lines and the HEMOSPLIT Catheter lines made of CARBOTHANE radiopaque polyurethane. The SOFT-CELL Dual Lumen Catheter (C.R. Bard) is made from polyurethane in both straight and pre-curved designs which can be used in both long-term and short-term vascular access for hemodialysis, hemoperfusion or apheresis therapy.

Short-term hemodialysis catheters, such as the NIAGARA Catheter lines and BREVIA Short-Term Dialysis Catheter by C.R. Bard, are made of thermosensitive BODYSOFT polyurethane and are used for attaining temporary vascular access for less than 30 days.

Common problems associated with hemodialysis catheters are infection and clotting. The anti-infective hemodialysis catheters provided herein may be used to reduce or inhibit infections associated with hemodialysis catheters. In addition, as described above, in certain embodiments, the hemodialysis catheter may further comprise an antithromotic agent in an amount effective in reducing or inhibiting clotting associate with the catheter. For example, the antithromotic agent may be in the composition that comprises a polyurethane, cellulose or a cellulose-derived polymer, and a pyrimidine analog, such as in form of a coating. In other embodiments, the antithromotic agent may be present on the surface (e.g., exterior surface) of a distal section of the catheter shaft while the anti-infective composition may be present on the surface (e.g., exterior surface) of a proximal section of the catheter shaft.

Peritoneal Dialysis Catheters

In certain embodiments, a method for reducing or inhibiting infections associated with a peritoneal dialysis catheter is provided. Such a method comprises introducing into a patient an anti-infective peritoneal dialysis catheter provided herein.

Peritoneal dialysis catheters are typically double-cuffed and tunneled catheters that provide access to the peritoneum. The most common peritoneal dialysis catheter designs are the TENCKHOFF Catheter, the SWAN NECK Missouri Catheter and SWAN NECK CURL CATH Missouri Peritoneal Catheters, and the Toronto Western catheter. In peritoneal dialysis, the peritoneum acts as a semipermeable membrane across which solutes can be exchanged down a concentration gradient.

Peritoneal dialysis infections are typically classified as either peritonitis or exit-site/tunnel infections (i.e. catheter infections). Exit-site/tunnel infections are characterized by redness, induration or purulent discharge from the exit site or subcutaneous portions of the catheter. Peritonitis is more a severe infection that causes abdominal pain, nausea, fever and systemic evidence of infection. Unfortunately, the peritoneal dialysis catheter likely plays a role in both types of infection. In exit-site/tunnel infections, the catheter itself becomes infected. In peritonitis, the infection is frequently the result of bacteria tracking from the skin through the catheter lumen or migrating on the outer surface (pericatheter route) of the catheter into the peritoneum. Peritoneal catheter-related infections are typically caused by Staphylococcus aureus, Coagulase Negative Staphylococci, Escherichia coli, Viridans group streptococci, Enterobacteriacae, Corynebacterium, Branhamella, Actinobacter, Serratia, Proteus, Pseudomonas aeruginosa and Fungi.

Treatment of peritonitis involves rapid in-and-out exchanges of dialysate, systemic antibiotics (intravenous and/or intraperitoneal administration) and often requires removal of the catheter. Complications include hospitalization, the need to switch to another form of dialysis (30%) and mortality (2%; higher if the infection is due to Enterococci, S. aureus or polymicrobial).

The anti-infective peritoneal dialysis catheters provided herein may be used to reduce or inhibit infections associated with peritoneal dialysis catheters.

F. Infections Associated with Other Catheters

catheters other than those specifically described above are also commonly used in the practice of medicine and surgery for a wide variety of purposes. These include drainage tubes (such as the ASPIRA Pleural Drainage Catheter from C.R. Bard), biliary T-tubes such as biliary and nephrostomy drainage catheters, such as, for example, the SKATER Nephrostomy Drainage Catheter available from Angiotech. Further examples of catheters include chest tubes, nasogastric tubes (such as the BARD Jejunal Feeding/Gastric Decompression Tube from C.R. Bard), implantable ports, and percutaneous feeding tubes (such as the BARD Button Replacement Gastrostomy Devices, the BARD PEG Feeding Devices, the DUAL PORT WIZARD Low-Profile Gastrostomy Device, FASTRAC Gastric Access Port, the GAUDERER GENIE System, the PONSKY Non-Balloon Replacement Gastrostomy Tubes, and the BARD Tri-Funnel Replacement Gastrostomy Tube from C.R. Bard). The insertion of such catheters into the body causes the body at risk for developing an infection—particularly in the period immediately following implantation.

In certain embodiments, a method for reducing or inhibiting infections associated with such other catheters is provided. This method comprises introducing into a patient an anti-infective catheter provided herein.

G. Infections of Central Nervous System (CNS) Shunts

In certain embodiments, a method for reducing or inhibiting infection associated with a CNS shunt is provided. Such a method comprises introducing into a patient an anti-infective CNS shunt provided herein.

Hydrocephalus, or accumulation of cerebrospinal fluid (CSF) in the brain, is a frequently encountered neurosurgical condition arising from congenital malformations, infection, hemmorrhage, or malignancy. The incompressible fluid exerts pressure on the brain leading to brain damage or even death if untreated. CNS shunts are conduits placed in the ventricles of the brain to divert the flow of CSF from the brain to other body compartments and relieve the fluid pressure. Ventricular CSF is diverted via a prosthetic shunt to a number of drainage locations including the pleura (ventriculopleural shunt), jugular vein, vena cava (VA shunt), gallbladder and peritoneum (VP shunt; most common).

Unfortunately, CSF shunts are relatively prone to developing infection, although the incidence has declined from 25% twenty years ago to 10% at present as a result of improved surgical technique. Approximately 25% of all shunt complications are due to the development of infection of the shunt and these can lead to significant clinical problems such as ventriculitis, ventricular compartmentalization, meningitis, subdural empyema, nephritis (with VA shunts), seizures, cortical mantle thinning, mental retardation or death. Most infections present with fever, nausea, vomiting, malaise, or signs of increased intracranial pressure such as headache or altered consciousness. The most common organisms causing CNS shunt infections are Coagulase Negative Staphylococci (67%; Staphylococcus epidermidis is the most frequently isolated organism), Staphylococcus aureus (10-20%), viridans streptococci, Streptococcus pyogenes, Enterococcus, Corynebacterium, Escherichia coli, Klebsiella, Proteus and Pseudomonas aeruginosa. It is thought that the majority of infections are due to inoculation of the organism during surgery, or during manipulation of the shunt in the postoperative period. As a result, most infections present clinically in the first few weeks following surgery.

Since many of the infections are caused by S. epidermidis, it is not uncommon to find that the catheter becomes coated with a bacterial-produced “slime” that protects the organism from the immune system and makes eradication of the infection difficult. Therefore, the treatments of most infections require shunt removal (and often placement of a temporary external ventricular shunt to relieve hydrocephalus) in addition to systemic and/or intraventricular antibiotic therapy. Poor therapeutic results tend to occur if the shunt is left in place during treatment. Antibiotic therapy is complicated by the fact that many antibiotics do not cross the blood-brain barrier effectively.

The anti-infective CNS shunts provided herein may be used to reduce or inhibit infections associated with CNS shunts, which in turn reduces the incidence of complications such as ventriculitis, ventricular compartmentalization, meningitis, subdural empyema, nephritis (with VA shunts), seizures, cortical mantle thinning, mental retardation or death and the number of CNS shunts requiring replacement.

The following examples are offered by way of illustration, and not by way of limitation.

### EXAMPLES

### Example 1

### Preparation of Coated Central Venous Catheters

CVC's were cleaned from their proximal ends of the body to the distal tips by wiping with VWR SPEC-WIPE® 7 Wiper that was wetted with 75/25 IPA/MEK. The catheters were allowed to dry for a minimum of 60 minutes at ambient temperature.

The catheters were then loaded onto the angle brackets that were used as fixtures for coating. The coating cup was placed on the catheter, and the angle bracket was loaded onto the coating machine. A coating solution prepared in accordance with the invention was added to the coating cups and the catheters were coated. During the process the inner lumens of the catheters were air purged to ensure that the lumen and ports are free from coating solution occlusion.

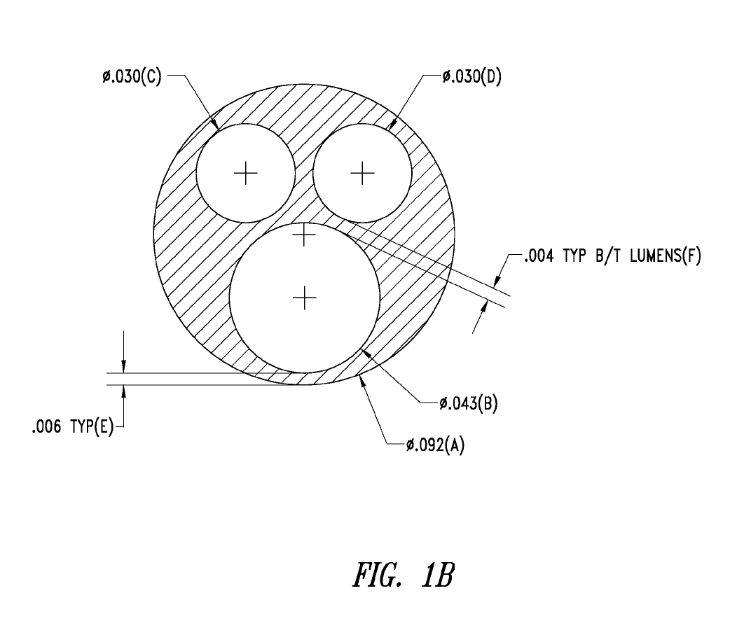

The coated catheters were removed from the coating machine and dried at 85±5° C. for 20 minutes in a vented oven to remove residual solvents to acceptable levels. The coated catheters were removed from the oven and cooled. The coated catheters were visually inspected under 10× magnification for particles in the coating, damage of the catheter surface, imperfections, and occlusions. FIGS. 2A and 2B show uncoated CVC and 5-FU coated CVC, respectively.

As shown in FIG. 2B, the resulting catheter was uniformly coated on its exterior surface. In addition, the coating did not block the outlet ports and had good adhesion to the catheter under both wet and dry conditions.

The coated catheters were sterilized using 10% ethylene oxide (EtO)/90% HFCF gas.

The total amount of drug on the coated catheters was measured and the values were expressed as total amount per catheter (μg) and amount per unit catheter length (μg/cm). 5-FU was exhaustively extracted from the coated portion of the catheter in methanol with sonication and the extracts were then analyzed by high performance liquid chromatography (HPLC). An average drug loading of 969±23 μg of 5-FU/coated catheter was determined from the analysis of four separate CVC lots.

### Example 2

### Drug Elution from Coated Catheters

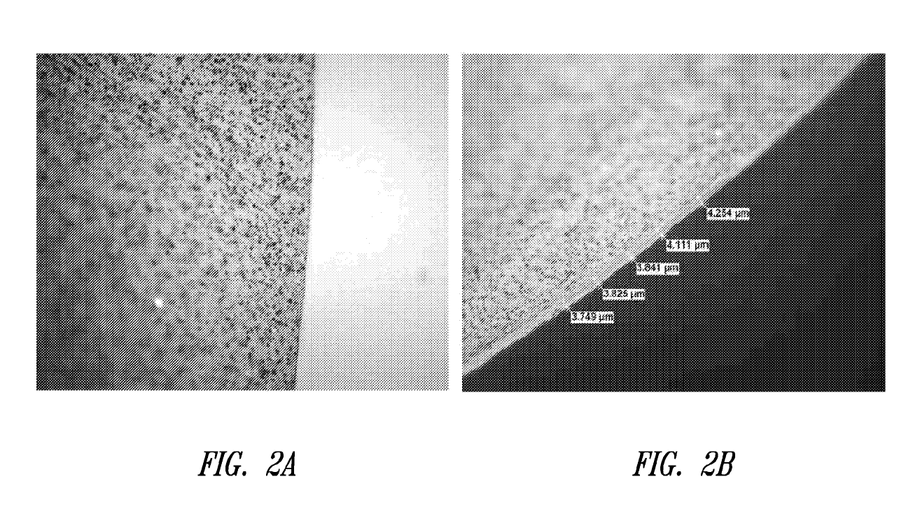

The in vitro elution profile of 5-FU from the CVC coating prepared as described in Example 1 was measured. The elution was performed by immersing 4-cm sections of coated catheter samples in 15 mL of phosphate buffered saline, pH 7.4 (PBS) at 37° C. The samples were placed in a rotating apparatus to provide agitation. The elution medium was sampled at selected time points and analyzed by HPLC. As shown in FIG. 3, there was a gradual elution of 5-FU from the catheter coating, with approximately 50% of drug released at day 7 and 90% release at day 28.

### Example 3

### Stability of Coated Catheters

Stability studies using coated catheters prepared according to Example 1 were performed to establish a shelf life/expiration date for these catheters. Testing evaluation for the drug component includes drug identity, drug loading and in vitro elution. Evaluation of the coating polymer includes visual inspection, dry adhesion and wet abrasion/wet peel testing.

The catheters were tested for stability using both real time (25° C./60% RH) and accelerated conditions (40° C./75% RH). Based on the analysis of the data, with a 95% confidence, at 24 months at 25° C. and 60% RH, (1) the total content of 5-FU of the catheter would not be expected to drop to less than 92.92% of the initial value, (2) drug purity is expected to remain above 95.25%, and (3) the defect rate in coating dry adhesion and wet peel/wet abrasion test is expected to be below 5%.

### Example 4

### Minimal Inhibitory Concentration and Zone-of-Inhibition

Minimal inhibitory concentration (MIC) and zone-of-inhibition (ZOI) testing was performed on bacterial pathogens associated with catheter-related infections including those exhibiting key resistant phenotypes. The Gram-positive organisms tested were S. epidermidis, methicillin resistant S. epidermidis (MRSE), S. aureus, methicillin resistant S. aureus (MRSA), E. faecalis and vancomycin resistant E. faecalis, the Gram-negative organisms tested were P. aeruginosa, E. coli and K. pneumoniae .

Antimicrobial activity of the Angiotech CVC was demonstrated by ZOI. Organisms were inoculated into 2 mL of liquid agar, which was poured on top of solidified agar. Test articles (0.5 cm sections) were inserted vertically into the agar after the plates had solidified. ZOI results (diameter in mm) were recorded at 24 hr. Large zones (>30 mm) were evident with the Gram-positive bacteria (both resistant and susceptible) with less activity towards the Gram-negative isolates (see, Table below entitled “MIC and ZOI Summary”).

For MIC testing, all isolates were tested against 5-FU by broth microdilution following CLSI methodology (M7-A7). A similar profile to the ZOI resulted from the MIC testing. 5-FU was highly potent against the Gram-positive organisms with MIC₅₀ values between 0.015-0.12 μg/ml. Higher MIC₅₀ values resulted with the Gram-negative isolates tested with values ranging from 16-128 μg/ml (see, Table below entitled “MIC and ZOI Summary”).

### MIC and ZOI Summary

| | | 5-Fluorouracil | | | |
|---|---|---|---|---|---|
| | | | | Catheter | |
| | | | | segment | Levofloxacin |
| | | MIC₅₀ | MIC₉₀ | Average ZOI | MIC₉₀ |
| Organism | N | μg/ml | μg/ml | (mm) | μg/ml |
| S. epidermidis | | | | | |
| all | 100 | 0.06 | 0.25 | 31 | >128 |
| *Oxacillin-S | 22 | 0.06 | 0.12 | 35 | 128 |
| *Oxacillin-R | 78 | 0.06 | 0.50 | 30 | >128 |
| S. aureus | | | | | |
| all | 101 | 0.12 | 0.25 | 34 | 32 |
| *Oxacillin-S | 61 | 0.12 | 0.25 | 34 | 16 |
| *Oxacillin-R | 40 | 0.12 | 0.12 | 34 | 32 |
| E. faecalis | | | | | |
| all | 101 | 0.015 | 0.06 | 35 | 64 |
| Vancomycin-S | 80 | 0.015 | 0.06 | 34 | 64 |
| Vancomycin-R | 21 | 0.015 | 0.06 | 37 | 64 |
| P. aeruginosa | 100 | 16 | 64 | 4 | 32 |
| E. coli | 102 | 32 | 64 | 16 | 16 |
| K. pneumoniae | 104 | 128 | >512 | 14 | 0.12 |

*The accepted marker for MRSA is resistance to oxacillin by broth microdilution

### Example 5

### Preparation of Coated HemoStream Catheters

HemoStream catheters were cleaned from their proximal ends of the body to the distal tips by wiping with an AlphaWipe Cleanroom Wiper that was wetted with IPA. The catheters were dried for a minimum of 60 minutes under vacuum with an oven temperature of 80° C. The catheters were then held in a clean, sealed storage container until coating.

On the day of coating the catheters were loaded onto the racks used as fixtures for coating. The coating cup was placed on the catheter, and the rack was loaded onto the coating machine. A coating solution prepared in accordance with the invention was added to the coating cups and the catheters were coated.

The rack of coated catheters was removed from the coating machine and dried under vacuum at 80±3° C. for 20 minutes to remove residual solvents to acceptable levels. The coated catheters were removed from the oven and cooled. The coated catheters were visually inspected under 4× magnification for particles in the coating, damage of the catheter surface, imperfections, and occlusions.

The resulting catheter was uniformly coated on its exterior surface, the coating did not block the outlet ports and had good adhesion to the catheter under both wet and dry conditions.

The coated catheters were sterilized using 100% ethylene oxide (EtO) gas.

The total amount of drug on the coated catheters was measured and the values were expressed as total amount per catheter (μg). 5-FU was exhaustively extracted from the coated portion of the catheter in methanol with sonication and the extracts were then analyzed by high performance liquid chromatography (HPLC). The total 5-FU content was within ±5% of the values listed for the 5 lengths of coated HemoStream catheters in the table below.

| Catheter Length (cm) | 5-FU Content (μg) |
|---|---|
| 24 | 1968 |
| 28 | 2402 |
| 32 | 2837 |
| 36 | 3272 |
| 40 | 3707 |

### Example 6

### Drug Elution from Coated Catheters

The in vitro elution profile of 5-FU from the coated HemoStream catheter prepared as described in Example 1 was measured. The elution was performed by immersing 4-cm sections of coated catheter samples in 15 mL of phosphate buffered saline, pH 7.4 (PBS) at 37° C. The samples were placed in a rotating apparatus to provide agitation. The elution medium was sampled at selected time points and analyzed by HPLC. As shown in FIG. 3, there was a gradual elution of 5-FU from the catheter coating, with approximately 58% of drug released at day 7 and 95% released at day 28.

### Example 7

### Stability of Coated Catheters

Stability studies using coated extrusions (catheter body with no hub, extension tubing, or tip) prepared according to Example 1 were performed to establish a shelf life/expiration date for these catheters. Testing evaluation for the drug component includes drug identity, drug loading and in vitro elution. Evaluation of the coating polymer includes visual inspection, dry adhesion and wet abrasion/wet peel testing.

The catheters were tested for stability using both real time (25° C./60% RH) and accelerated conditions (40° C./75% RH). Based on the analysis of the data there is no statistical difference in 5-FU total content through 6 months of real time storage or 12 months of real-time equivalent (accelerated conditions) storage. No trend is evident for the observed variance in the in vitro elution (see Figure X). No changes have been observed in the visual appearance of the coating or in its dry adhesion or wet abrasion/wet peel properties through 6 months of real time storage or 12 months of real-time equivalent (accelerated conditions) storage.

### Example 8

### Biocompatibility Studies—Coated HemoStream

Cytotoxicity Study Using the MEM Elution Method

The purpose of this study was to determine whether leachables extracted from the test material would cause cytotoxicity.

An in vitro biocompatibility study, based on the requirements of the International Organization for Standardization 10933: Biological Evaluation of Medical Devices, Part 5: Tests for Cytotoxicity: in vitro Methods guidelines, was conducted on the test article, non drug loaded MEDI-COAT coated HemoStream catheter to determine the potential for cytotoxicity. A single extract of the test article was prepared using single strength Minimum Essential Medium supplemented with 5% serum and 2% antibiotics (1×MEM). This test extract was placed onto three separate monolayers of L-929 mouse fibroblast cells propagated in 5% carbon dioxide.

Three separate monolayers were prepared for the reagent control, negative control and for the positive control. All monolayers incubated at 37° C. in the presence of 5% carbon dioxide for 48 hours. The monolayer in the test, reagent control, negative control and positive control wells was examined microscopically at 48 hours to determine any change in cell morphology.

Under the conditions of this study, the 1×MEM test extract showed no evidence of causing cell lysis or toxicity. The 1×MEM test extract met the requirements of the test since the grade was less than a grade 2 (mild reactivity). The reagent control, negative control, and positive control performed as anticipated.

ASTM Partial Thromboplastin Time, Non-Drug Coated.

The purpose of this study was to determine the potential of the test article to cause an effect on the coagulation cascade via the intrinsic coagulation pathway. This in vitro study measured the time citrated human plasma exposed to the test article would take to form a clot when exposed to a suspension of phospholipid particles and calcium chloride. This study is based on the requirements of ASTM F 2382: Standard Test Method for Assessment of Intravascular Medical Device Materials on Partial Thromboplastin Time (PTT).

An in vitro blood compatibility test was conducted on the test article, non drug loaded MEDI-COAT coated catheter to determine the potential of the test article to cause an effect on the coagulation cascade via the intrinsic coagulation pathway.

The test article was incubated in freshly frozen, citrated human plasma at 37° C. with agitation at 60 rpm for 15 minutes. The citrated human plasma in a polypropylene tube was similarly incubated to serve as the negative control. Glass beads were used as the positive control and natural rubber was used as a biomaterial reference control. Both positive and biomaterial reference controls were similarly incubated in the citrated plasma as the test article. After incubation, the partial thromboplastin time was determined for the test and control samples using a coagulation analyzer.

Under the conditions of this study, the plasma exposed to the test article had an overall average clotting time of 353.2 seconds and was 79% of the negative control. The test article would be considered a minimal activator. The test article met the requirements of the test. The positive and biomaterial reference controls performed as anticipated.

ASTM Partial Thromboplastin Time, 5-FU Coated

The purpose of this study was to determine the potential of the test article to cause an effect on the coagulation cascade via the intrinsic coagulation pathway. This in vitro study measured the time citrated human plasma exposed to the test article would take to form a clot when exposed to a suspension of phospholipid particles and calcium chloride. This study is based on the requirements of ASTM F 2382: Standard Test Method for Assessment of Intravascular Medical Device Materials on Partial Thromboplastin Time (PTT).

An in vitro blood compatibility test was conducted on the test article, 5-FU Coated HemoStream Catheter to determine the potential of the test article to cause an effect on the coagulation cascade via the intrinsic coagulation pathway.

The test article was incubated in freshly-frozen, citrated human plasma at 37° C. with agitation at 60 rpm for 15 minutes. The citrated human plasma in a polypropylene tube was similarly incubated to serve as the negative control. Glass beads were used as the positive control and natural rubber was used as the biomaterial reference control. Both positive and biomaterial reference controls were similarly incubated in the citrated plasma as the test article. After incubation, the partial thromboplastin time was determined for the tests and control samples using a coagulation analyzer.

Under the conditions of this study, the plasma exposed to the test article had an overall average clotting time of 419.3 seconds and was 89% of the negative control. The test article would be considered a minimal activator. The test article met the requirements of the test. The positive and biomaterial reference controls performed as anticipated

SC5b-9 Complement Activation Assay, Non-Drug Coated

The purpose of this study was to determine the complement-activation potential of a biomaterial or a medical device using an in vitro test system. The activation of complement system can be clinically significant. The study was conducted in vitro by incubating the test article in normal human serum and detecting the presence of SC5b-9 in the exposed serum by an enzyme immunoassay method. The SC5b-9 complex is the soluble, non-lytic form of the Terminal Complement (TCC) that is only formed when there is an activation of the complement system. This study is based on the requirements of ISO 10993-4 (2002) Biological Evaluation of Medical Devices—Part 4: Selection of tests for interactions with blood and Amendment 1 (2006) of ISO 10993-4.

The test article, non drug loaded MEDI-COAT coated catheter was evaluated for the potential to activate the complement system. While all biomaterials activate complement to some extent, criteria for acceptable levels have not yet been established. The clinical significance of the results should be evaluated with respect to the use of the medical device and its likely potential for activation of the complement system in clinical use. The assay employed an enzyme immunoassay kit with monoclonal antibodies specific for SC5b-9 fragments to detect activation of the complement system. The concentration of SC5b-9 was determined following incubation of the test article with normal human serum (NHS). The SC5b-9 concentration from the test article extract was compared statistically with that of the activated NHS and negative control using t-tests. A p-value <0.05 was considered statistically significant. A series of controls were run concurrently to ensure quality control.

Under the conditions of this assay, the concentration of SC5b-9 in the test article extract was 4,616±378.6 ng/ml (mean±S.D.). The concentration of SC5b-9 in the test article extract was not significantly higher than the activated NHS and was not significantly higher than the negative control. As a result, the test article was not considered to be an activator of the complement system. The standards and controls performed as anticipated.

SC5b-9 Complement Activation Assay, 5-FU Coated

The purpose of this study was to determine the complement-activation potential of a biomaterial or a medical device using an in vitro test system. The activation of complement system can be clinically significant. The study was conducted in vitro by incubating the test article in normal human serum and detecting the presence of SC5b-9 in the exposed serum by an enzyme immunoassay method. The SC5b-9 complex is the soluble, non-lytic form of the Terminal Complement (TCC) that is only formed when there is an activation of the complement system. This study is based on the requirements of ISO 10993-4 (2002) Biological Evaluation of Medical Devices—Part 4: Selection of tests for interactions with blood and Amendment 1 (2006) of ISO 10993-4.

The test article, 5-FU Coated HemoStream Catheter was evaluated for the potential to activate the complement system. While all biomaterials activate complement to some extent, criteria for acceptable levels have not yet been established. The clinical significance of the results should be evaluated with respect to the use of the medical device and its likely potential for activation of the complement system in clinical use. The assay employed an enzyme immunoassay kit with monoclonal antibodies specific for SC5b-9 fragments to detect activation of the complement system. The concentration of SC5b-9 was determined following incubation of the test article with normal human serum (NHS). The SC5b-9 concentration from the test article extract was compared statistically with that of the activated NHS and negative control using t-tests. A p value <0.05 was considered statistically significant. A series of controls were run concurrently to ensure quality control.

Under the conditions of this assay, the concentration of SC5b-9 in the test article extract was 4,956±150.8 ng/ml (mean±S.D.). The concentration of SC5b-9 in the test article extract was not significantly higher than the activated NHS and was not significantly higher than the negative control. As a result, the test article was not considered to be an activator of the complement system. The standards and controls performed as anticipated.

C3a Complement Activation Assay, Non-Drug Coated

The purpose of this study was to determine the extent to which complement is activated by the test article. The Complement Activation Assay utilized an Enzyme Immunoassay (EIA) kit, distributed by Quidel, San Diego, Calif., that employed monoclonal antibodies to measure C3a in human serum samples. In the complement system, C3a is a low molecular weight activation protein fragment that follows the enzymatic cleavage of C3. C3 is the most abundant complement protein in human blood and it is the pivotal protein associated with the major biological effects of the complement system. When the complement system is activated, C3 is cleaved and C3a is formed. The test article, non drug loaded MEDI-COAT coated catheter was evaluated for the potential to activate the complement system. The assay employed an enzyme immunoassay kit with monoclonal antibodies specific for C3a fragments to detect activation of the complement system. The concentration of C3a was determined following incubation of the test article with normal human serum (NHS). The C3a concentration from the test article extract was compared statistically with that of the activated NHS and negative control using t-tests. A p-value <0.05 was considered statistically significant. A series of controls were run concurrently to ensure quality control.

Under the conditions of this assay, the C3a concentration of the test article extract was 9,622±653.7 ng/ml (mean±S.D.). The concentration of C3a in test article extract was not significantly higher than the activated NHS and was significantly higher than the negative control. As a result, the test article was not considered to be an activator of the complement system. The standards and controls performed as anticipated.

C3a Complement Activation Assay, 5-FU Coated

The purpose of this study was to determine the extent to which complement is activated by the test article. The Complement Activation Assay utilized an Enyme Immunoassay (EIA) kit, distributed by Quidel, San Diego, Calif., that employed monoclonal antibodies to measure C3a in human serum samples. In the complement system, C3a is a low molecular weight activation protein fragment that follows the enzymatic cleavage of C3. C3 is the most abundant complement protein in human blood and it is the pivotal protein associated with the major biological effects of the complement system. When the complement system is activated, C3 is cleaved and C3a is formed.

The test article, 5-FU Coated HemoStream Catheter was evaluated for the potential to activate the complement system. The assay employed an enzyme immunoassay kit with monoclonal antibodies specific for C3a fragments to detect activation of the complement system. The concentration of C3a was determined following incubation of the test article with normal human serum (NHS). The C3a concentration from the test article extract was compared statistically with that of the activated NHS and negative control using t-tests. A p value <0.05 was considered statistically significant. A series of controls were run concurrently to ensure quality control.

Under the conditions of this assay, the C3a concentration of the test article extract was 17,972±6,749 ng/ml (mean±S.D.). The concentration of C3a in test article extract was not significantly higher than the activated NHS and was significantly higher than the negative control. As a result, the test article was not considered to be an activator of the complement system. The standards and controls performed as anticipated.

USP Pyrogen Study, Material Mediated

This purpose of this study was to determine if a test solution (TS) induces a pyrogenic response following intravenous injection in rabbits. The test article was extracted in sterile, nonpyrogenic 0.9% sodium chloride solution (SNPS). This study was conducted based on the methods described in USP 30 NF 25, General Chapter <151> PYROGEN TEST. The USP method is recommended by ISO 10993-11 (2006) Biological Evaluation of Medical Devices—Part 11: Tests for Systemic Toxicity.

The test article, non drug loaded MEDI-COAT coated catheter was extracted in sterile, nonpyrogenic 0.9% sodium chloride solution. The extract was evaluated in the rabbit for material mediated pyrogenicity. The procedure is recommended in ISO 10993-11 (2006) Biological Evaluation of Medical Devices—Part 11: Tests for Systemic Toxicity.

A single dose of 10 ml/kg was intravenously injected via the marginal ear vein into each of three rabbits. Rectal temperatures were measured and recorded prior to injection and at 30 minute intervals between 1 and 3 hours after injection.

Under conditions of this study, the total rise of rabbit temperatures during the 3 hour observation period was within acceptable USP limits. The test article was judged as nonpyrogenic.

Genotoxicity: Bacterial Reverse Mutation Study—Sodium Chloride Extract

The purpose of this study was to evaluate whether an extract of the test material would cause mutagenic changes in a tryptophan-dependent strain of Escherichia coli (E. coli) or in one or more strains of histidine-dependent Salmonelle typhimurium (S. typhimurium) in the presence or absence of S9 metabolic activation. This study was based on OECD Test No. 471 and the requirements of ISO 10993-3.

A S. typhimurium and E. coli reverse mutation standard plate incorporation study was conducted to evaluate whether a 0.9% sodium chloride (SC) extract of non drug loaded MEDI-COAT coated catheter would cause mutagenic changes in the average number of revertants for histidine-dependent S. typhimurium strains TA98, TA100, TA1535, and TA1537, and in trytophan-dependent E. coli strain WP2uvrA in the presence and absence of S9 metabolic activation.

Separate tubes containing 2 ml of molton top agar supplemented with histidine-biotin solution for the S. typimurium strains and with trytophan for the E. coli strain were inoculated with 0.1 ml of culture for each of five tester strains, and 0.1 ml of the SC extract. A 0.5 ml aliquot of sterile water for injection (SWI) or S9 homogenate, simulating metabolic activation, was added when necessary. The mixture was poured across triplicate Minimal E plates. Parallel testing was also conducted with a corresponding negative control and five positive controls. The mean number of revertants of the triplicate test plates was compared to the mean number of revertants of the triplicate negative control plates for each of the five tester strains employed. The means obtained for the positive controls were used as points of reference.

Under the conditions of this assay, the SC test article extract was considered to be nonmutagenic to S. typhimurium tester strains TA98, TA100, TA1535, and TA1537 and to E. coli strain WP2uvrA.

Genotoxicity: Bacterial Reverse Mutation Study-EtOH Extract

The purpose of this study was to evaluate whether an extract of the test material would cause mutagenic changes in a tryptophan-dependent strain of Escherichia coli (E. coli) or in one or more strains of histidine-dependent Salmonelle typhimurium (S. typhimurium) in the presence or absence of S9 metabolic activation. This study was based on OECD Test No. 471 and the requirements of ISO 10993-3.

A S. typhimurium and E. coli reverse mutation standard plate incorporation study was conducted to evaluate whether an ethanol (EtOH) extract of non drug loaded MEDI-COAT coated catheter would cause mutagenic changes in the average number of revertants for histidine-dependent S. typhimurium strains TA98, TA100, TA1535, and TA1537, and in trytophan-dependent E. coli strain WP2uvrA in the presence and absence of S9 metabolic activation.

Separate tubes containing 2 ml of molton top agar supplemented with histidine-biotin solution for the S. typimurium strains and with trytophan for the E. coli strain were inoculated with 0.1 ml of culture for each of five tester strains, and 0.1 ml of the 95% EtOH extract. A 0.5 ml aliquot of sterile water for injection (SWI) or S9 homogenate, simulating metabolic activation, was added when necessary. The mixture was poured across triplicate Minimal E plates. Parallel testing was also conducted with a corresponding negative control and five positive controls. The mean number of revertants of the triplicate test plates was compared to the mean number of revertants of the triplicate negative control plates for each of the five tester strains employed. The means obtained for the positive controls were used as points of reference.

Under the conditions of this assay, the 95% ethanol test article extract was considered to be nonmutagenic to S. typhimurium tester strains TA98, TA100, TA1535, and TA1537 and to E. coli strain WP2uvrA. The negative and positive controls performed as anticipated.

ISO Maximization Sensitization Study—Extract

The purpose of this study was to identify the potential for dermal sensitization. The Magnusson and Kligman method has been effective in identifying a variety of allergens. This study will be based on the International Organization for Standardization 10993: Biological Evaluation of Medical Devices, Part 10: Tests for Irritation and Delayed-Type Hypersensitivity.

A guinea pig maximization test of non-drug loaded MEDI-COAT coated catheter was conducted to evaluate the potential for delayed dermal contact sensitization.

The test article was extracted in 0.9% sodium chloride USP (SC) and sesame oil, NF (SO). Each extract was intradermally injected and occlusively patched to ten test guinea pigs (per extract) in an attempt to induce sensitization. The vehicle was similarly injected and occlusively patched to five control guinea pigs (per vehicle). Following a recovery period, the test and control animals received a challenge patch of the appropriate test article extract and the reagent control. All sites were scored at 24 and 48 hours after patch removal.

Under conditions of this study, the SC and SO test article extracts showed no evidence of causing delayed dermal contact sensitization in the guinea pig.

### Example 9

### Minimal Bactericidal Concentration

Minimal bactericidal concentrations (MBCs) were determined for bacterial isolates associated with catheter-related infections (Attachment 18.18). Broth microdilution MBCs were determined by first performing the standard broth microdilution technique to establish the 5-FU MIC for each organism (CLSI M7-A7). Dilutions having visible growth were sampled to determine the MBC as defined as the concentration at which a ≧99.9% reduction in the colony forming units relative to the starting inoculum concentration was achieved. When the MBC:MIC ratio for 5-FU was the agent was deemed bactericidal.

The MBC results were:

S. epidermidis—MIC for 10 strains ranged from 0.03-0.25 μg/ml, MBC range was 0.03-0.25 μg/ml; bactericidal for 6 of the 11 strains

S. aureus—MIC for 11 strains ranged from 0.03-0.25 μg/ml, MBC ranged form 0.12-32 μg/ml; bactericidal for 4 of the 11 strains

E. faecalis—MIC for 10 strains ranged from 0.008-0.12 μg/ml, MBC range was 0.008-0.25 μg/ml; bactericidal for 8 of the 10 strains

P. aeruginosa—MIC for 10 strains ranged from 0.25->512 μg/ml, all MBCs were >512 μg/ml; no bactericidal activity

E. coli—MIC for 10 strains ranged from 0.25-64 μg/ml, MBC range was 0.25->512 μg/ml; bactericidal for 1 of the 10 strains

K. pneumoniae—MIC for 10 strains ranged from 16->512 μg/ml, all MBCs were >512 μg/ml; no bactericidal activity

The bactericidal testing against S. epidermidis and S. aureus included methicillin-resistant strains. The MIC values for the methicillin resistant strains were similar to the MIC values obtained in Example 4 with averaged MICS of 0.08 μg/ml (N=8) and 0.12 (N=5) for methicillin resistant S. epidermidis and S. aureus, respectively.

### Example 10

### Minimal Inhibitory Concentration and Minimal Bactericidal Concentration

Minimal inhibitory concentration (MIC) and minimal bacterial concentration (MBC) for 5-FU and floxuridine were performed on suggested ATCC control strains of bacteria recommended in the CLSI methodology (M7-A7). The Gram-positive organisms tested were S. epidermidis ATCC 12228, S. aureus ATCC 25923, and E. faecalis ATCC 29212. The Gram-negative strains tested were P. aeruginosa ATCC 27853, K. pneumonia ATCC 700603 and E. coli ATCC 25922.

### MIC and MBC Summary

| | 5-FU MIC | 5-FU MBC | Flox MIC | Flox MBC |
|---|---|---|---|---|
| Bacteria | (ug/ml) | (ug/ml) | (ug/ml) | (ug/ml) |
| S. epidermidis | 0.14 | 0.41 | <0.05 | <0.05 |
| S. aureus | 1.23 | 1.23 | <0.05 | 0.14 |
| E. faecalis | 3.7 | 3.7 | 3.7 | 11.11 |
| P. aeruginosa | >100 | >100 | >100 | >100 |
| K. pneumoniae | 100 | >100 | 1.23 | 3.7 |

### Example 11

### Zone-of-Inhibition

Zone-of-inhibition (ZOI) for 5-FU and floxuridine were performed on suggested ATCC control strains of bacteria recommended in the CLSI methodology (M2-A9). The Gram-positive organisms tested were S. epidermidis ATCC 12228, S. aureus ATCC 25923, and E. faecalis ATCC 29212. The Gram-negative strains tested were P. aeruginosa ATCC 27853, K. pneumonia ATCC 700603 and E. coli ATCC 25922. The appropriate amount of drug was added to a 6-mm filter paper disk that was placed onto the agar that was inoculated with the bacteria. ZOI results (diameter in mm) were recorded at 18 hours.

### ZOI of Various Amounts of 5-FU and Floxuridine

### Example 12

### Zone-of-Inhibition

Zone-of-inhibition (ZOI) for various amounts of 5-FU and 20 μg floxuridine alone or together were tested on suggested ATCC control strains of bacteria recommended in the CLSI methodology (M2-A9). The Gram-positive organisms tested were S. epidermidis ATCC 12228, S. aureus ATCC 25923, and E. faecalis ATCC 29212. The Gram-negative strains tested were P. aeruginosa ATCC 27853, K. pneumonia ATCC 700603 and E. coli ATCC 25922. The appropriate amount of drug was added to a 6-mm filter paper disk that was placed onto the agar that was inoculated with the bacteria. ZOI results (diameter in mm) were recorded at 18 hours.

### ZOI of Floxuridine and 5-FU Alone or in Combination Against Gram-Positive Organisms

### ZOI of Floxuridine and 5-FU Alone or in Combination Against Gram-Negative Organisms

### Example 13

### Zone-of-Inhibition

Zone-of-inhibition (ZOI) for 5-FU and floxuridine, alone or in combination, were tested against three different ATCC strains for each bacteria species following the CLSI methodology (M2-A9). The Gram-positive strains tested were S. epidermidis ATCC 12228, 14990, 35547; S. aureus ATCC 25923, 10537, 13301 and E. faecalis ATCC 29212, 19433, 33186. The Gram-negative strains tested were P. aeruginosa ATCC 27853, 27315, 25619; K. pneumonia ATCC 700603, 13883, 27736 and E. coli ATCC 25922, 11303, 11775. The appropriate amount of drug was added to a 6-mm filter paper disk that was placed onto the agar that was inoculated with the bacteria. ZOI results (diameter in mm) were recorded at 18 hours.

### ZOI for 5-FU and Floxuridine Against 3 Strains of Gram-Positive Bacteria

### ZOI for 5-Fu and floxuridine against 3 strains of gram-negative bacteria

### ZOI for 5-FU and Floxuridine Against 3 Strains of Gram-Negative Bacteria

### Example 14

### 28-Day Elution Study with Zone-of-Inhibition Assay

This Zone-of-Inhibition assay demonstrated the ability of the CVC's coated with 5-FU to inhibit bacterial growth after prolonged elution in calf serum. The CVC's containing two different doses of 5-FU in the catheter coating were tested: One was coated with a 5-FU containing coating composition according to the present invention (5-FU CVC), the other coated with another 5-FU containing coating composition according to the present invention (CVC with a lower dose of 5-FU). The latter contained 40% less 5-FU compared to the former.

Test catheters (0.5 cm sections of 5-FU CVC, CVC with a lower dose of 5-FU, and Arrow CVC) were eluted in 0.5 mL of calf serum at 37° C. for up to 28 days (with serum changed at each time point) and were tested at 0, and 1-28 days by ZOI analysis. Arrow CVC is a commercially available Arrow-Howes Multi-Lumen CVC [product # AK-25703, ARROWGARD BLUE® CVC]. A gentamicin disk was used as the positive control and the uncoated CVC was used as the negative control.

The samples were challenged with clinical isolates of 3 common species of bacteria associated with catheter colonization (S. aureus, S. epidermidis and K. pneumoniae). Organisms were inoculated into 2 mL of liquid agar, which was poured on top of solidified agar. Test articles (0.5 cm sections) were inserted vertically into the agar after the plates had solidified. ZOI results were recorded at 24 hr. Average zone sizes were calculated for each organism strain. The 5-FU CVC, CVCC with a lower dose of 5-FU, and Arrow CVC were tested in triplicate at each time point on 2 plates per organism (n=6). Each plate also contained one negative and one positive control sample.

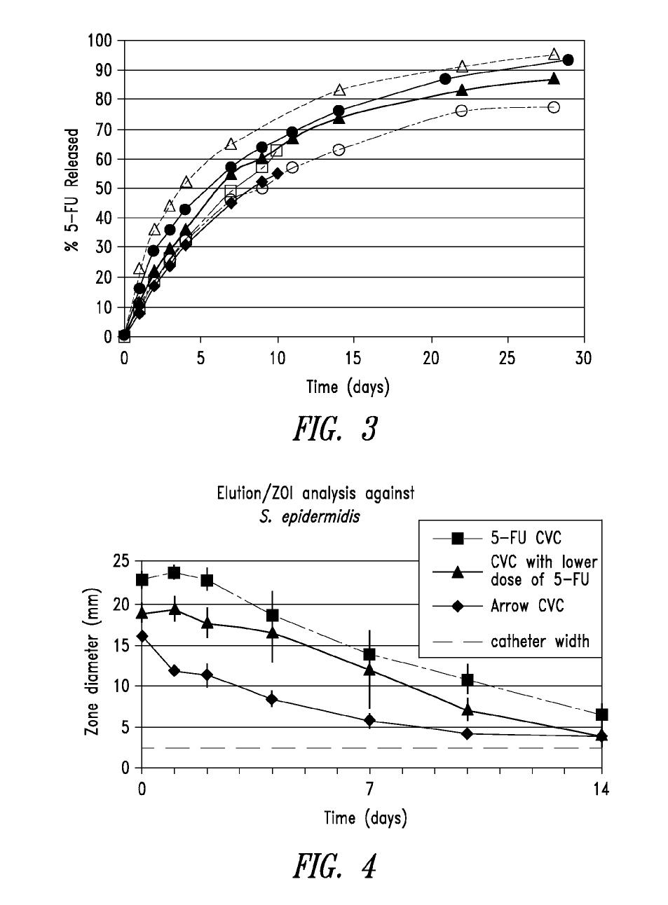

The results demonstrated that CVC's coated with 5-FU had sustained antimicrobial activity on the surface of the catheter for up to 14 days of elution against S. epidermidis and K. pneumoniae and up to 10 days for S. aureus. Both 5-FU CVC and CVC with a lower dose of 5-FU had greater antimicrobial activity at each time point against S. epidermidis and S. aureus than did the Arrow CVC. Activity against the K. pneumoniae was similar to the Arrow CVC but was not as great as seen against S. epidermidis. FIG. 4 graphs surface antimicrobial activity of 5-FU CVC and CVC with a lower dose of 5-FU against S. epidermidis over time compared to the Arrow CVC.

### Example 15

### Multi-Organism Zone-of-Inhibition Screening

The antimicrobial activity of the 5-FU CVC against Methicillin Resistant S. aureus was demonstrated by the Zone-of-Inhibition (ZOI) Assay. The 5-FU CVC was compared with the commercially available Arrow CVC. Gentamicin (10 μg) or penicillin (10 units) disks were used as positive controls and CVC was used as the negative control. The samples were challenged with 3 species of Gram-positive bacteria, 4 species of Gram-negative bacteria and 1 type of yeast. The organisms used to challenge the samples were the following ATCC strains: S. aureus, Methicillin Resistant Staphylococcus aureus (MRSA), S. epidermidis, K. pneumoniae, and Vancomycin Resistant Pediococcus (VRP), E. coli, P. aeruginosa and C. albicans.

Organisms were inoculated into 2 mL of liquid agar, which was poured on top of solidified agar. One plate was made per organism. Test articles were inserted into the agar when the plates were solidified and dry. ZOI results were recorded at 24 hr. Three 0.5-cm sections of the 5-FU CVC were tested on each plate. Each plate also contained one negative and one positive control sample and 1 Arrow CVC sample.

The 5-FU CVC demonstrated antimicrobial activity against all 3 Gram-positive organisms (see, Table below in this example). These organisms (S. aureus, MRSA and S. epidermidis) have a high incidence of catheter-related infections. The triplicate average ZOI and the individual ZOI for each 5-FU CVC were larger than the ZOI measured for the Arrow CVC. The 5-FU CVC had no effect on 3 of the 4 Gram-negative bacteria, and had a limited effect on P. aeruginosa, which was demonstrated by a change in the color of the bacteria surrounding the catheter section. The 5-FU CVC was not effective against the yeast, C. albicans. The uncoated control CVC produced no ZOI for any organism.

Zone-of-Inhibition for 5-FU CVC and Arrow CVCs∇

| | | 5-FU CVC | | | | Antibiotic | |
|---|---|---|---|---|---|---|---|
| | | Average | | Arrow CVC | CVC | Control• | |
| Organism | Classification | ZOI (mm) | SD | ZOI (mm) | ZOI (mm) | G | P |
| S. aureus | Gram + | 19.6 | 0.9 | 7.5 | 0 | | 41.3 |
| MRSA | Gram + | 21.2 | 0.7 | 8.6 | 0 | 7.1 | |
| S. epidermidis | Gram + | 37.1 | 0.5 | 11.3 | 0 | | 0 |
| VRP | Gram − | 0 | — | 9.1 | 0 | | 0 |
| K. pneumoniae | Gram − | 0 | — | 4.5 | 0 | 9.5 | |
| E. coli | Gram − | 0 | — | 7.4 | 0 | 10.5 | |
| P. aeruginosa | Gram − | 8.7* | 2.0 | 5.5 | 0 | 12.5 | |
| C. albicans | Yeast | 0 | — | 7.4 | 0 | | 0 |

∇The ZOI includes the diameter of the catheter section
•Gentamicin (G) or Penicillin (P) disks are 6 mm in diameter
*Pale-lightening of lawn growth, not a true zone

### Example 16

### Goat Intravenous Implant Model Safety Study

A large animal model was utilized to mimic the clinical end use of the 5-FU CVC. Drug loaded catheters (5-FU CVC) and uncoated control catheters were inserted into the jugular veins of goats following clinical protocols for CVC insertion and left in place for either 14 or 21 days (N=8 per group). At each final endpoint, both macroscopic and microscopic evaluations were performed at the catheter/host tissue interfaces and vessel contact points. Histopathology showed no significant reaction to the 5-FU CVC or to the control catheters.

Blood samples were taken to measure plasma drug levels before the implant procedure (Day 0) and on Days 1, 3, 7, 14, (and 21 second group only). Plasma samples obtained from goats that had received the 5-FU CVC were analyzed for 5-FU. An analytical method was validated for the quantification of 5-FU in goat plasma. The 5-FU was extracted from plasma with liquid chromatography and was measured by tandem mass spectrometry (API 3000) using APCI ionization. A quantification range of 1.00 to 500 ng/mL was used. An internal standard (5-FU-¹⁵N₂) was added to all samples, excluding blanks. No detectable level of 5-FU was present in any of the blood samples (test sensitivity, 1 ng/mL).

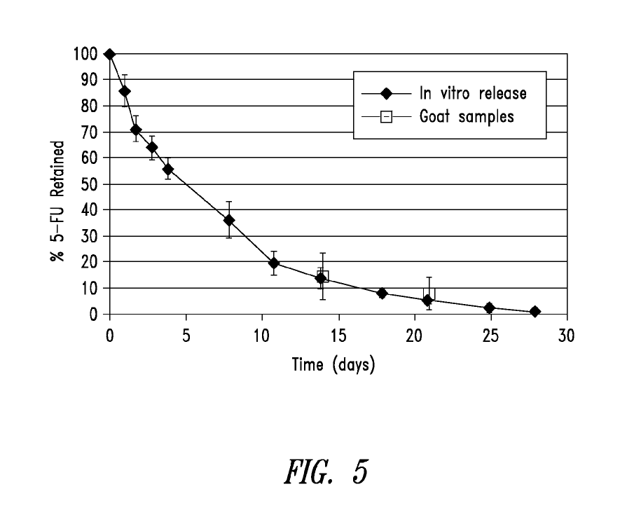

Each of the explanted catheters at days 14 and 21 were analyzed after extraction in methanol by HPLC for the amount of 5-FU remaining on the catheter. The in vitro elution of was performed by immersing 4-cm sections of coated catheter samples in 15 mL of phosphate buffered saline, pH 7.4 (PBS) at 37° C. The samples were placed in a rotating apparatus to provide agitation. The elution medium was sampled at selected time points and analyzed by HPLC. The estimated amount retained on the in vitro catheter samples were calculated by subtracting the released amount of drug from the measured total content amount determined for the same catheter lot. The average retained amounts after 14 and 21-day in vivo implantation were 14.4% and 7.8% of the original loaded amount, respectively, which were similar to the amounts estimated from the in vitro elution data (FIG. 5).

The in vivo and in vitro studies have demonstrate that the 5-FU CVC is non-toxic to contact tissues and that systemic levels of 5-FU are not detectable during implantation. Analysis of the residual 5-FU remaining on the explanted 5-FU CVC revealed that the measured amount was similar to the predicted amount based on the in vitro elution kinetics.

### Example 17

### Cytotoxicity—MEM Elution Test

This study was conducted to determine the biological reactivity (cytotoxicity) of mammalian cells (L929 mouse fibroblasts) to extracts of uncoated CVC and non-drug coated CVC (CVC coated with a composition that comprises polyurethane and nitrocellulose, but does not comprise any anti-infective agent). Positive control (natural rubber) and negative control (negative control plastic) articles were extracted in the same manner. Extractions were performed per Biological Evaluation of Medical Devices-Part 12, Sample Preparation and Reference Materials, ISO 10993-12 (2002). The extraction ratio of extract solution to test article was 0.2 g in 1.0 mL. The extract vehicle, Minimum Essential Medium supplemented with 10% fetal bovine serum (complete MEM), was incubated with test and control articles at 37±1° C. for 24±2 hours.

A volume of 3 ml of extract was used to replace the maintenance medium of the L929 cell monolayer. All extracts were tested in triplicate. Cultures were incubated in presence of extracts at 37±1° C. for 48 hr. Observations for cellular reaction were made at 24 and 48 hr. The cell monolayer reactivity for cellular degeneration & malformation was graded 0 to 4 (none to severe). Grades of 0, 1, and 2 meet the requirements of the test; Grades of 3 and 4 fail.

No biological reactivity (Grade 0) was observed in cultured mouse fibroblasts following 24 or 48 hours of exposure to the test article extracts. The observed cellular response obtained from the positive control (Grade 4) and the negative control (Grade 0) confirmed the suitability of the test system. The test articles, uncoated CVC and non-drug coated CVC, meet the requirements of the MEM Elution Test and are considered non-cytotoxic.

### Example 18

### Sensitization—Kligman Maximization Test

This test was designed to evaluate in guinea pigs the dermal sensitizing potential (potential to sensitize the skin and to produce erythema and edema) of NaCl and CSO extracts of uncoated CVC and non-drug coated CVC. Extractions were performed per Biological Evaluation of Medical Devices-Part 12, Sample Preparation and Reference Materials, ISO 10993-12 (2002). The extraction ratio of extract solution to test article was 0.2 g in 1.0 mL. The extract vehicles, 0.9% USP Sodium Chloride for Injection (NaCl) and Cottonseed Oil (CSO), were incubated with test and control articles at 37±1° C. for 72±2 hours.

For the induction phase, on Day 0, 10 guinea pigs in the experimental groups received 3 pairs of 0.1-mL intradermal injections for each extract vehicle (NaCl and CSO): 1) a 1:1 mixture of Fruend's Complete Adjuvant (FCA) and extract vehicle, 2) a 1:1 mixture of FCA and test article extract, and 3) an extract vehicle. For the negative control groups, 5 guinea pigs likewise received 3 pairs of 0.1-mL intradermal injections for each extract vehicle (NaCl and CSO), but without the test article extracts. Six days later, the second induction was preceded by massaging a suspension of 10% sodium dodecyl sulfate (SDS) in petrolatum into the skin over the previous injection sites. Twenty-four hours after application, on Day 7, test article extracts were topically applied to the previous injection sites of test animals using a patch (filter paper saturated with extract). The negative control animals were similarly induced with the vehicle extracts. Each patch was secured over the injection sites for 48 hours before being removed. A dermal challenge application with test article extract was performed on Day 23. Saturated filter paper was applied on a previously unexposed area of skin and secured for 24 hr. Negative controls (NaCl and CSO) were used in the same manner for both test articles. Immediately after patch removal, the skin was cleaned and shaved and skin reactions were evaluated at 24, 48, and 72 hr post challenge (Days 25, 26, and 27). The skin reaction for erythema and edema was graded 0 to 3 (no visible change to intense erythema and swelling). A skin reaction of for erythema and edema at any time was considered a positive response. The sensitization rate was graded from I (0-8%, weak) to V (80-10%, extreme allergenic potential).

The test articles, uncoated CVC and non-drug coated CVC, elicited no reaction (Grade 0 for erythema and edema) and had a 0% sensitization rate with a dermal challenge following the induction phase. As defined by the scoring system of Kligman, no reaction is a Grade I reaction and the test articles, non-drug coated CVC and 5-FU CVC, are classified as having weak allergenic potential. Grade I (weak allergenic potential) is not considered significant according to Magnusson and Kligman (1969, 1970). Negative control animals likewise showed no signs of sensitization. Based on this study, 5-FU CVC and non-drug coated CVC are considered weakly sensitizing.

### Example 19

### Irritation and Intracutaenous Reactivity—Intracutaneous Injection Test

This test was used to determine the potential irritant effects in New Zealand White rabbits of intracutaneously injected NaCl and CSO extracts of the test articles, uncoated CVC and non-drug coated CVC. Extractions were performed per Biological Evaluation of Medical Devices-Part 12, Sample Preparation and Reference Materials, ISO 10993-12 (2002). The extraction ratio of extract solution to test article was 0.2 g in 1.0 mL. The extract vehicles, 0.9% USP Sodium Chloride for Injection (NaCl) and Cottonseed Oil (CSO), were incubated with test and control articles at 37±1° C. for 72±2 hours.

Two rabbits were injected intracutaneously at five sites on each side of the body with one test article extract (NaCl or CSO) at 0.2 mL per site. The negative control (NaCl or CSO) was injected on the same side at five posterior sites. Sites were scored immediately, 24, 48, and 72 hr post injection for erythema and edema. Skin reaction irritation scores (0 to 8) were composed of scores for erythema and eschar formation scores (0 to 4; no erythema to severe erythema, to slight eschar formation) and edema formation scores (0 to 4; no edema to severe edema). Requirements are met if the test article score is different from the negative control by ≦1.0.

The test article sites did not show irritant effects (erythema or edema formation), and there was no difference in biological reaction when compared to the sites injected with either negative control extraction vehicle (NaCl or CSO). The difference in scores between test articles and the negative controls was 0. Based on the protocol criteria, uncoated CVC and non-drug coated CVC are considered negligible irritants.

### Example 20

### Systemic Toxicity—Systemic (Acute) Injection Test

This test was conducted to determine the potential toxicity in Albino Swiss mice of NaCl and CSO extracts of the test articles, uncoated CVC and non-drug coated CVC, following 72 hr of an iv or ip injection, respectively. Extractions were performed per Biological Evaluation of Medical Devices-Part 12, Sample Preparation and Reference Materials, ISO 10993-12 (2002). The extraction ratio of extract solution to test article was 0.2 g in 1.0 mL. The extract vehicles, 0.9% USP Sodium Chloride for Injection (NaCl) and Cottonseed Oil (CSO), were incubated with test and control articles at 37±1° C. for 72±2 hours.

Mice were injected iv with 50 mL/kg NaCl or NaCl test article extract or ip with 50 mL/kg CSO or CSO test article extract and evaluated for clinical signs and toxicity immediately and 4, 24, 48, and 72 hr post injection. Test requirements are met if the test article extract does not have significantly greater clinical signs or toxicity relative to the extraction vehicles (NaCl and CSO). Requirements are met if the test article does not induce a significantly greater biological reaction than the controls.

No toxicity was observed with the NaCl and CSO extracts of the test articles, non-drug coated CVC and uncoated CVC, and they did not induce significantly greater clinical signs or toxicity than the negative controls. The tests articles, non-drug coated CVC and uncoated CVC, are considered non-toxic based on standards set by the study protocol.

### Example 21

### Systemic Toxicity—Rabbit Pyrogen Test (Material Medicated)

This test was conducted to determine the potential of NaCl test article extracts to produce a pyrogenic response following IV injection in New Zealand White rabbits. Extractions were performed per Biological Evaluation of Medical Devices-Part 12, Sample Preparation and Reference Materials, ISO 10993-12 (2002). The extraction ratio of extract solution to test article was 0.2 g in 1.0 mL. The extract vehicle, 0.9% USP Sodium Chloride for Injection (NaCl), was incubated with test and control articles at 37±1° C. for 72±2 hours.

Three rabbits were injected in the marginal ear vein with 10 mL/kg of NaCl or test article extract. Body temperature was measured at 30-min intervals for 3 hr post injection. The requirements of the test are met if no rabbit shows an individual rise in temperature of 0.5° C. or more above the rabbit's baseline during the 3-hr period following injection of test article extract. Test article fails if 0.5° C.

The test articles, non-drug coated CVC and uncoated CVC, did not increase body temperature by 0.5° C. The maximum increases in 3 rabbits for extracts of the CVC were 0.1, 0, 0° C. The maximum increases in 3 rabbits for extracts of the non-drug MEDI-COAT CVC were 0, 0, 0° C. Based on the evaluation criteria of the Pyrogen Test, non-drug coated CVC and uncoated CVC are considered non-pyrogenic.

### Example 22

### Subacute and Subchronic Toxicity—14 Day Repeat Dose Intravenous Toxicity Study

This study was conducted to determine the potential toxicity in Albino Swiss mice of NaCl extracts of the test articles, uncoated CVC and non-drug coated CVC, to following IV injection on each weekday (5 days/week) for 14 days. The extract vehicle, 0.9% USP Sodium Chloride for Injection (NaCl), was incubated with test articles at 37±1° C. for 72±2 hours.

Mice were injected IV with 25 mL/kg NaCl or NaCl test article extract on 5 weekdays per week over a 14-day period. The determination of toxicity was based upon clinical observations, animal/organ weights, hematologic parameters, necropsy observations, and histopathological assessment of selected tissues from animals exposed to the test articles as compared to the control animals exposed to the vehicle. A test article meets the test requirement if it does not have a significantly different effect on organ weights, hematologic parameters, clinical observations, necropsy observations, and histopathological assessment relative to negative control. Hematological parameters were assessed for biological significance by comparison to historical control values. All other quantitative data were assessed using unpaired t or Mann-Whitney test and considered significant only if p≦0.05.

The test articles, non-drug coated CVC and uncoated CVC, did not produce effects significantly greater than the negative and historic controls, and are considered non-toxic based on standards set by the study protocol.

### Example 23

### Genotoxicity—Salmonella Typhimurium and Escherichia coli Reverse Mutation Assay (AMES Assay)

This test was performed to determine the in vitro potential of NaCl and CSO extracts of the test articles, non-drug coated CVC and uncoated CVC, to induce genotoxicity as evaluated in the Salmonella typhimurium (S. typhimurium) and Escherichia coli (E. coli) reverse mutation assay (Ames Assay). Specifically, the potential to induce reverse mutations in histidine (his− to his+) and tryptophan (tryp− to tryp+) genes in S. typhimurium and E. coli respectively was evaluated. This direct plate incorporation assay was conducted with four strains of S. typhimurium (TA 98, 100, 1535, 1537) and one strain of E. coli (WP2) in the presence and absence of an exogenous mammalian activation system. S. typhimurium and E. coli tester strains were incubated at 37±1° C. for 69.5 hr with 0.1 mL test article extract or negative control (NaCl or CSO) in the presence or absence of a mammalian metabolic activation system. The same positive and negative controls were used for both test articles. The test article meets the requirements and is considered not mutagenic if the test article extract does not produce a statistically significant increase in revertant (mutant) colonies over negative control at p≦0.05.

There was no statistically significant difference in the number of revertant colonies between the negative control and either test article extract. All positive controls exhibited a statistically significant increase in the number of revertant colonies compared to the corresponding negative control, validating the functioning of the assay. The test articles, non-drug coated CVC and uncoated CVC, are not mutagenic in the reverse mutations assays utilized.

### Example 24

### Genotoxicity—Mouse Lymphoma Mutageneiss Assay

This test was conducted to determine the potential of the test articles, non-drug coated CVC and uncoated CVC, to induce forward mutation utilizing the mutant mouse lymphoma L5178Y cell line, heterozygous at the thymidine kinase locus (TK+/−). Extractions were performed per Biological Evaluation of Medical Devices-Part 12, Sample Preparation and Reference Materials, ISO 10993-12 (2002). The extraction ratio of extract solution to test article was 0.2 g in 1.0 mL. The extract vehicle, cell culture medium, was incubated with test articles at 37±1° C. for 72±2 hours.

Test article extracts were evaluated for their ability to induce a statistically significant increase in the number of homozygous thymidine kinase mutants (TK−/−) over the background rate in the presence and absence of a metabolic activation system. The same positive and negative controls were used for both test articles. The test article meets the test requirements and is considered not mutagenic if the test article extract does not produce a statistically significant increase in mutant colonies over negative control at p≦.0.05.

Mutant mouse lymphoma L5178Y cell line was incubated at 37±1° C. for 4 hr with 7 mL test article extract or negative control (cell culture medium) in the presence or absence of a mammalian metabolic activation system. Cells were then rinsed to remove test article extract and resuspended for the expression phase. Aliquots were then grown in cloning medium at 37±1° C. for 12 days to quantitate mutation frequency.

The positive controls exhibited a statistically significant increase in the number of mutant colonies compared to the corresponding negative control, validating the functioning of the assay. Based on the criteria of the study protocol, the test articles, non-drug coated CVC and uncoated CVC, are considered non-mutagenic.

### Example 25

### Genotoxicity—Rodent Bone Marrow Micronucleus Assay (38 Animals)

This study was conducted to determine in rodents the mutagenic potential of the test article extract, non-drug coated CVC and uncoated CVC, and/or its metabolites, to induce micronuclei in maturing erythrocytes of mice. Extractions were performed per Biological Evaluation of Medical Devices-Part 12, Sample Preparation and Reference Materials, ISO 10993-12 (2002). The extraction ratio of extract solution to test article was 0.2 g in 1.0 mL. The extract vehicle, 0.9% USP Sodium Chloride for Injection (NaCl), was incubated with test and control articles at 37±1° C. for 72±2 hours.

Ten mice were injected IV with 50 mL/kg NaCl or NaCl test article extract and killed at 24 or 48 hr for evaluation of bone marrow polychromatic erythrocytes (PCE) containing micronuclei. Six mice were used for the positive and negative controls, which were used for both test articles. The bone marrow of mice injected IV with the test article extracts was evaluated for the number of polychromatic erythrocytes (PCE) containing micronuclei. The test article meets the test requirements and is considered not mutagenic if the test article extract does not produce a statistically significant increase in PCE containing micronuclei at p≧0.05.

The NaCl test article extracts did not induce a statistically significant increase in micronucleated cells as compared to the negative control at 24 and 48 hours after dosing. The positive control, Mitomycin C, caused a statistically significant increase in micronucleated cells compared to the negative control, validating the functioning of the assay. Based on the criteria of the study protocol, the test articles, non-drug coated CVC and uncoated CVC, are considered non-mutagenic.

### Example 26

### Short Term Imtramuscular Implantation Test

This test was conducted to determine the in vivo biological reactivity and toxicity of new Zealand White Rabbits to test article and negative control plastic implanted into the paravertebral muscle. Implant samples were prepared according to ISO 10993-6. Where possible the coated side and inner lumen side of catheter shaft and tip were scored separately. 10 mm components of the test articles were implanted in the paravertebral muscle of 3 New Zealand White rabbits for periods of 1, 2, 4 and 6 weeks. The inner and outer surfaces of the white and blue portions of the test article (catheter) were separately evaluated to determine the extent of biologic reaction.

The nominal test article score reflected 13 measures of biologic reaction to the 2 surfaces of the 2 catheter portions. The mean nominal score was normalized to 4 implant sites for 3 rabbits. The toxicity rating was the difference between the mean nominal total scores for the test article and negative control plastic implant site. Scores are: <1=nontoxic; >1 to <2=slightly toxic; >2 to <3=mildly toxic; >3 to <4=moderately toxic; >4=severely toxic.

The test article components were non-toxic for all periods of implantation when compared to negative control article implants. No biologically significant differences were noted between the outer and inner surface of each component. The table below shows the toxicity ratings for the 4 surfaces that were analyzed. Based on the criteria of the study protocol, the test articles, non-drug coated CVC and uncoated CVC, are nontoxic for all periods of implantation.

### Muscle Implantation Summary Scores

(Score=Mean Nominal Test Article Score−Mean Nominal Control Score)

| | | Shaft | | Tip | |
|---|---|---|---|---|---|
| Duration | Test Article | Outer | Inner | Outer | Inner |
| 1 week | Non-drug coated CVC | −0.20 | 0.07 | −0.23 | −0.04 |
| | Uncoated CVC | −0.31 | 0.08 | −0.19 | −0.04 |
| 2 weeks | Non-drug coated CVC | −0.12 | 0.04 | −0.19 | −0.03 |
| | Uncoated CVC | 0.08 | 0.28 | −0.05 | 0.25 |
| 4 weeks | Non-drug coated CVC | −0.23 | 0.32 | −0.19 | 0.21 |
| | Uncoated CVC | −0.13 | 0.24 | −0.08 | 0.12 |
| 6 weeks | Non-drug coated CVC | −0.03 | 0.20 | 0.01 | 0.13 |
| | Uncoated CVC | −0.04 | 0.15 | −0.13 | 0.07 |

### Example 27

### Hemocompatibility—Hemolysis (Rabbit Blood)

This test was conducted to determine the potential for rabbit blood hemolysis in vitro in the presence of NaCl test article extracts of uncoated CVC, non-drug coated CVC, and 5-FU CVC. Extractions were performed per Biological Evaluation of Medical Devices-Part 12, Sample Preparation and Reference Materials, ISO 10993-12 (2002). The extraction ratio of extract solution to test article was 0.2 g in 1.0 mL. The extract vehicle, 0.9% USP Sodium Chloride for Injection (NaCl), was incubated with test and control articles at 37±1° C. for 72±2 hours. 0.2 mL of diluted rabbit blood was added to 10 mL NaCl test article extract and incubated at 37±2° C. for 30 min. The percent hemolysis was calculated relative to the extraction vehicle negative control (NaCl). Negative controls (NaCl, plastic) and positive control (USP water) were the same for all test articles. The test article meets the requirements of the test and is considered not hemolytic if hemolysis is ≦5% relative to the negative control.

The NaCl extract of the test article, non-drug coated CVC, exhibited 0.8% hemolysis. The NaCl extract of the test article, uncoated CVC, exhibited 0.7% hemolysis. The NaCl extract of the test article, 5-FU CVC, exhibited 0.2% hemolysis. The test articles are not hemolytic if hemolysis is ≦5% relative to the negative control. Based on the criteria of the study protocol, all test articles are considered non-hemolytic.

### Example 28

### Hemocompatibility—Lee & White Coagulation Test

This test was conducted to determine potential of NaCl extracts of test articles, uncoated CVC, non-drug coated CVC and 5-FU CVC, to affect in vitro clotting of human blood. Extractions were performed per Biological Evaluation of Medical Devices-Part 12, Sample Preparation and Reference Materials, ISO 10993-12 (2002). The extraction ratio of extract solution to test article was 0.2 g in 1.0 mL. The extract vehicle, 0.9% USP Sodium Chloride for Injection (NaCl), was incubated with test and control articles at 37±1° C. for 72±2 hours. Nine volumes of whole human blood were exposed to 1 volume of NaCl or NaCl test article or negative control plastic extract. Negative controls (NaCl and plastic) were the same for all test articles. The test article fails if coagulation time is significantly different at p≦0.05 from the negative control extract vehicle or the negative control plastic extract or if values fall outside the accepted normal range. The normal coagulation time for human blood in the absence of anticoagulants is 8-15 min.

The coagulation time of whole human blood in the presence of the test article extracts was not significantly different when compared to the negative control (NaCl) or the negative control plastic extract. The clotting times of the test articles and the negative controls were within the normal coagulation time range of 8-15 minutes for human blood (see, the table below). All test articles, non-drug coated CVC, uncoated CVC, and 5-FU CVC, meet the requirements of the Lee and White Coagulation Test based upon the criteria of the protocol.

### Lee & White Coagulation Test Summary

| | Clotting Time | | |
|---|---|---|---|
| | | | Negative |
| | Test Article | Negative | Control Plastic |
| Test Article | Extract | Control (NaCl) | Extract |
| non-drug | 9 min and 10 sec | 9 min and 00 sec | 9 min and 20 sec |
| coated CVC | | | |
| uncoated CVC | 9 min and 20 sec | 9 min and 00 sec | 9 min and 20 sec |
| 5-FU CVC | 9 min and 10 sec | 9 min and 00 sec | 9 min and 20 sec |

### Example 29

### Hemocompatibility—Thrombogenicity Assay in Dogs

This test was conducted to determine the potential of test articles, uncoated CVC, non-drug coated CVC, and 5-FU CVC, to cause thrombosis in dogs. Intact catheters were used as test articles. The length of the negative control plastic was approximately 2 inches in length. Two dogs each had test article and negative control plastic implanted in the right or left jugular vein evaluated for thrombi formation 4±0.5 hr after implantation. Grade 0 to 5 (no significant thrombosis to vessel completely occluded) scored extent of thrombi formation. The test requirements are met if there is no significant increase in thrombosis for the test article compared to the negative plastic control article.

The amount of thrombosis of the test articles, non-drug coated CVC, uncoated CVC, and 5-FU CVC, was not considered significant compared to the negative plastic control. Based on the evaluation criteria of the protocol, the test articles are not thrombogenic (see, the table below).

### Thromboresistance in Dogs

| Article | Grade | Thrombosis/# Site(s) |
|---|---|---|
| Non-drug | 0 | Not significant/all |
| coated CVC | 0 | Not significant/all |
| Negative | 2 | Minimal/multiple locations |
| Control Plastic | 0 | Not significant/all |
| Uncoated CVC | 2 | Minimal/multiple locations |
| | 0 | Not significant/all |
| Negative | 0 | Not significant/all |
| Control Plastic | 1 | Minimal/multiple locations |
| Uncoated CVC | 1 | Minimal/one location |
| | 2 | Minimal/multiple locations |
| Negative | 0 | Not significant/all |
| Control Plastic | 2 | Minimal/multiple locations |

### Example 30

### Clinical Study

A randomized, single-blind, active-control, clinical study was designed to determine the equivalence of 5-FU CVC (containing 1 mg 5-FU released over 28 days) and the antiseptic, chlorhexidine-silver sulfadiazine-impregnated CVC (ARROWGARD BLUE® CVC, Arrow International, Inc., Reading, Pa.) for the prevention of bacterial catheter colonization. 960 adult subjects, who were initially hospitalized in an intensive care setting and who required insertion of a triple-lumen CVC for a period of up to 28 days, were randomized in a 1:1 ratio to receive either the 5-FU CVC (481 patients) or the ARROWGARD BLUE® CVC (479 patients), implanted for a maximum of 28 days. Upon removal of the study catheter, the catheter tips were cultured by roll-plate method. Incidences of catheter-related local infection based on clinical assessments and defined as Grade 2 or higher pain, redness, edema, or pus or purulent drainage at the insertion site were documented. In addition, catheter-related bloodstream infections were tested. A bloodstream infection was considered catheter related if the same pathogen was isolated from a blood sample and catheter tip obtained at the same time. Microorganisms responsible for catheter colonization and bloodstream infection were identified and enumerated using standard microbiological techniques. Incidence rates of bacterial catheter colonization between the two treatments were compared using the Cochran-Mantel-Haenszel X² test controlling for center.

Bacterial colonization was observed in 2.9% (12/419) of catheter tips from the 5-FU CVC treatment group and 5.3% (21/398) from ARROWGARD BLUE® CVC catheter, a difference of 2.4%. The upper limit of a one-tailed 95% confidence interval was a negative 0.14%, which confirms that the difference in rate of colonization is less than the specified margin of inferiority of 9%.

Staphyloccal and Corynebacterium species and two additional organisms designated as “diphtheroid” and “Bacillus” were isolated from 5-FU CVC tips at ≧15 CFU. ARROWGARD BLUE® CVC tips yielded staphylococcal isolates at ≧15 CFU, and the Gram negative species Klebsiella pneumoniae, Proteus mirabilis, Serratia marcescens, and unidentified enterococcus, and Candida tropicalis, which were not found on the 5-FU CVC tips. Also found on the ARROWGARD BLUE® CVC tips were Staphylococcus aureus, methicillin-resistant S. aureus at ≧15 CFU.

The comparability of the two devices was further supported by the low rate of catheter-related bloodstream infection, which occurred in none of the 5-FU CVC group and two in the ARROWGARD BLUE® CVC group. The rates of catheter insertion site infections were low and comparable in the two groups, 1.4% for 5-FU CVC and 0.9% for ARROWGARD BLUE® CVC. No adverse effects have been associated with the clinical use of 5-FU CVC.

Microbial resistance is a concern associated with repeated exposure to anti-microbial agents. Tests showed that 5-FU remained a potent inhibitor of the staphylococcal species detected on the 5-FU CVC tips. The mean 5-FU MIC was 0.12 μg/ml for the 5-FU CVC isolates and 0.08 μg/ml ARROWGARD BLUE® CVC staphylococcal isolates. Historical 5-FU MIC values, obtained for 100 isolates during preclinical testing, were 0.06-0.12 μg/ml against S. epidermidis and S. aureus, in agreement with the results from catheter tip isolates. The MIC values were comparable with ARROWGARD BLUE® CVC bacterial isolates exposed to 5-FU for the first time, isolates from the 5-FU CVC exposed to 5-FU for the second time, and historical MIC values, suggesting no acquired resistance of Gram positive pathogens to 5-FU.

In summary, the 5-FU CVC was safe to use in subjects who required insertion of a triple-lumen CVC for a period of up to 28 days. Furthermore, with bacterial catheter colonization rates of 2.9%, the 5-FU CVC was shown to be clinically equivalent to the current market standard for the prevention of bacterial catheter colonization in patients who receive a CVC in an intensive care setting.

The various embodiments described above can be combined to provide further embodiments. All of the U.S. patents, U.S. patent application publications, U.S. patent applications, foreign patents, foreign patent applications and non-patent publications referred to in this specification, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An anti-infective device comprising:
(i) a catheter; and
(ii) a composition on the catheter, the composition comprising:
(a) a polyurethane,
(b) a cellulose or cellulose-derived polymer, and
(c) a pyrimidine analog,
wherein the weight ratio of the polyurethane to the cellulose or cellulose-derived polymer in the composition ranges from 1:10 to 2:1, and the pyrimidine analog is in an amount effective in reducing or inhibiting infection associated with the catheter.

2. The anti-infective device of claim 1, wherein the composition is on the catheter in form of a coating.

3. The anti-infective device of claim 1, wherein the weight ratio of the polyurethane to the cellulose or cellulose-derived polymer in the composition ranges from 1:2 to 1:4.

4. (canceled)

5. The anti-infective device of claim 1, wherein the pyrimidine analog is released from the composition at an amount effective in reducing or inhibiting infection associated with the catheter for at least 1 week.

6-8. (canceled)

9. The anti-infective device of claim 1, wherein the weight ratio of the pyrimidine analog to the sum of the polyurethane and the cellulose or cellulose-derived polymer in the composition ranges from 2% to 40%.

10-11. (canceled)

12. The anti-infective device of claim 1, wherein the pyrimidine analog is present at 0.1 μg to 1 mg per cm² of the catheter surface area to which the composition is applied or incorporated.

13. (canceled)

14. The anti-infective device of claim 1, wherein the pyrimidine analog is present at 10 μg to 100 μg per cm² of the catheter surface area to which the composition is applied or incorporated.

15. The anti-infective device of claim 1, wherein the pyrimidine analog is present at 0.1 μg to 2 mg per cm of the catheter length to which the composition is applied or incorporated.

16. The anti-infective device of claim 1, wherein the pyrimidine analog is present at 50 μg to 150 mg per cm of the catheter length to which the composition is applied or incorporated.

17. The anti-infective device of claim 1, wherein the pyrimidine analog is present at 10 μg to 100 μg per cm of the catheter length to which the composition is applied or incorporated.

18. (canceled)

19. The anti-infective device of claim 1, comprising 1 μg to 250 mg of the pyrimidine analog.

20-22. (canceled)

23. The anti-infective device of claim 1, wherein the pyrimidine analog is a fluoropyrimidine.

24. The anti-infective device of claim 23, wherein the fluoropyrimidine is selected from the class comprised of 5-fluorouracil and floxuridine.

25. (canceled)

26. The anti-infective device of claim 1, wherein the cellulose-derived polymer is selected from nitrocellulose, cellulose acetate butyrate, and cellulose acetate propionate.

27. (canceled)

28. The anti-infective device of claim 1, wherein the polyurethane is a poly(carbonate urethane), poly(ester urethane), or poly(ether urethane).

29. (canceled)

30. The anti-infective device of claim 1, wherein the composition is only present on the non-luminal surface or a portion thereof.

31. The anti-infective device of claim 2, wherein average thickness of the coating ranges from 1 μm to 10 μm.

32. The anti-infective device of claim 2, wherein average thickness of the coating ranges from 10 μm to 20 μm.

33. (canceled)

34. The anti-infective device of any one of claim 1, wherein the catheter is a vascular catheter, chronic dwelling gastrointestinal catheter, dialysis catheter, or chronic dwelling genitourinary catheter.

35-38. (canceled)

39. The anti-infective device of claim 1, wherein the composition further comprises a second anti-infective agent, an antithrombotic agent, an antiplatelet agent, an anti-inflammatory agent, an immunomodulatory agent, or an anti-fibrotic agent.

40-69. (canceled)

70. An anti-infective composition comprising at least one polymer and a pyrimidine analog, wherein the pyrimidine analog is selected from the class consisting of 5-fluorouracil and floxuridine.

71. The anti-infective composition of claim 70, wherein the pyrimidine analog comprises 2% to 40% by weight of the total composition.

72. The anti-infective composition of either of claim 70, wherein the at least one polymer is a cellulose or cellulose-derived polymer.

73-75. (canceled)
